(19) United States
(12) Patent Application Publication
(10) Pub. No.: US 2018/0075388 A1
(43) Pub. Date: Mar. 15, 2018

(54) SYSTEMS AND METHODS FOR EVALUATING USES OF CAPITAL

(71) Applicant: Joseph E. Rosebrock, Newburgh, IN (US)

(72) Inventor: Joseph E. Rosebrock, Newburgh, IN (US)

(21) Appl. No.: 15/703,672

(22) Filed: Sep. 13, 2017

Related U.S. Application Data
(60) Provisional application No. 62/364,526, filed on Jul. 20, 2016.

(51) Int. Cl. G06Q 10/06; G06Q 10/04; G06Q 40/06

(52) U.S. Cl. CPC G06Q 10/06375; G06Q 40/06; G06Q 10/0635; G06Q 10/04

(57) ABSTRACT

Calculation systems and methods for determining the value of a business or other investment which receives income over time. The systems and methods fully facilitate compelling answers to investment questions. Business professionals find a complete investment picture better foretells an investment's opportunity and allows for smarter decisions to be made

### CROSS-REFERENCE TO RELATED APPLICATION(S)

This application claims the benefit of U.S. Provisional Patent Application No. 62/394,526, filed Sep. 14, 2016, the entire disclosure of which is herein incorporated by reference.

### BACKGROUND

### 1. Field of the Invention

This disclosure is related to the field of strategic decision making between projects of uncertain value. Specifically, systems and methods for determining the prudence of a capital expenditure.

### 2. Description of the Related Art

Everyday virtually every person is required to make decisions that will effect their future. One of the most major of these is how to expend capital or colloquially, how to invest. Individuals, businesses, and governments all have a limited set of resources, and it is important that those resources be utilized in a way that provides for an increase in available resources as time passes.

While this general concept is simple, the implementation of it is not. The decision of if a manufacturing plant should be expanded, or a new one built, if tax money should be spent to build a road versus decreasing the cost of medical care, or if one should purchase a business or buy stocks and bods are extremely complicated. The primary reason for this is because these decisions require an evaluation of the time value of the resource or more accurately the time value of money. It is a well understood concept that having a resource currently provides a value. For example, if one has an apple, they can eat it. However, it is also well known that forgoing that value now can provide additional value in the future. The apple can be planted, an apple tree cultivated, and in a period of years, far more apples will be available. Without the ability to make the comparison of which of these choices provides more value today and over time, decision making becomes very inefficient and that can result in loss of value and ultimately loss of life.

The methodology to determine what to do with the apple can be very complicated. Because of intervening time, and the existence of risk, it is necessary to evaluate and compare the value of the apple now, to the value of the apple tree in the future. To deal with this kind of problem, there are a couple of methods that have traditionally been used. In all the cases, the value of the apple and the apple tree is generally converted into some form of universal “currency”. This allows for each item to be measureable on the same scale. Traditionally, the currency used is an actual currency representing the monetary value of each option. The values are then appropriately discounted to deal with the fact that obtaining value in the future means having to lose value now. The present value of both options is then compared to determine which is the better choice.

The tradeoff of future increased income compared a current value is a well-understood relationship referred to as Net Present Value (NPV) analysis in economics. NPV simply is an indication of how much value money obtained at a later date has today. In its simplest form if one had $100 today, it could be invested at 5% per year interest and the person would have $105 a year from now. Thus, the person would obtain the same NPV from having $105 in a year, or $100 today. Thus, if using the same capital in a selected fashion would generate $125 in a year while forgoing keeping it now, this is likely a smart decision as this is more than the NPV of having the $100 today.

While the above is a very simple example, in most contexts the issue is not simply deciding if a use of capital for a project will produce an increase in value, but determining which use will produce the most value. For example, decisions need to be made on a daily basis if it is better to expand an existing factory, or to build a new one, or to contract out work to a third party. These decisions have concrete impacts on the lives of workers, the lives of people who utilize what the factory produces, and the robustness of a state or country. Use of bad metrics can result in businesses failing or retirement accounts being wiped out.

Traditionally, two metrics are considered to be robust in determining the value of a capital expenditure by providing a valuation of the stream of income (or the change in stream of income) in the future in today's currency. The first is Net Present Value (NPV) analysis, and the second is Internal Rate of Return (IRR) analysis. The two are related to each other. There are other methods of analysis such as the payback method which is based on the amount of time a stream of income takes to recoup the initial expenditure. The payback method can be useful for certain items, but usually is considered inferior.

In NPV analysis, one determines the value of a stream of income (e.g. that the factory will increase the number of product manufactured and sold) over time and places it against the valuation of holding the capital expenditure and investing it in what is considered a “safe” investment with a near guaranteed return. A key to understanding NPV analysis is understanding the assumptions that have to go into it. There are a number of key places where mistakes in estimates can drastically affect the end results. One of these is a misestimate of the discount rate used to discount the value of the future. NPV generally uses a current rate and applies it to future returns. The assumption is, thus, that this rate won't change, which is unlikely in many respects particularly if the time window is long. Because of this, NPV analysis can be very useful for evaluating a stream of income against a fixed expenditure (e.g. purchasing an operating business or buying a machine with a known price tag), but often isn't as useful when two uses of the same capital need to be compared to each other.

IRR analysis attempts to deal with this problem in estimation by using the same formula, but setting the NPV to 0 in all cases. It then determines what the discount rate needs to be to get that value. Thus, IRR compares the discount rates needed to equalize the projects, and compares those to determine which is the more valuable project.

As much as IRR and NPV use is pervasive, and competitive, in analysis, they both have some major shortcomings. One major IRR and NPV shortcoming is conflicting evaluations. The two tools can give conflicting evaluations for the same investment opportunity. Conflicting evaluations and other IRR and NPV shortcomings instead need to be replaced with an overarching investment structure methodology.

Traditionally, one would answer investment question categories with these tools be using them to answer different questions. To answer a comparative return measure investment question one would use the IRR tool; to answer an initial cost investment question one would use the NPV tool; to answer anoperating performance question one would use a modified payment annuity tool; and to answer a sale price salvage question one would use a future value tool. IRR, NPV, PMT (Payment) and FV (Future Value) are prescribed functions defined and illustrated in electronic spreadsheets. IRR and NPV combined with PMT and FV are further referred to collectively herein as the traditional tools and methods of investment analysis.

Traditional tools focus on an investment question's primary flow and do not assert solve/assumption synchronicity except within simple investment questions. A simple investment question entails having equal operating performance for each period. In addition, a traditional tool's simple investment question has secondary flows inappropriately receiving an equity return and not a more appropriate user-defined return.

Absent a synchronized solve/assumption investment structure, a traditional tool's investment answer is flawed within a more realistic investment question. At a minimum, a more realistic investment question should contain a user-defined rate for secondary flows. It is also common to have varying period-to-period operating performances and debt financing in an investment question.

Traditional tools impose an overall singular rate to all investment question components. A synchronized investment structure component can require any of four rates—an equity rate, a debt rate, a combined equity and debt rate or a user-defined rate, depending on the component being considered. The ability to match investment question components with their proper rate is a defining synchronized investment structure trait.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of the above and other problems in the art, provided herein is a new calculation system and method for determining the value of a business or other investment which obtains income over time after an initial capital outlay. The systems and methods fully facilitate compelling answers to investment questions. Business professionals find a complete investment picture better foretells an investment's opportunity and allows for smarter decisions to be made.

In an embodiment, there is provided herein a method for providing a value of an investment, a computer readable medium comprising computer readable instructions for carrying out the method, and a computer system carrying out the method, the method comprising: determining any two values from the group consisting of: the comparative return measure, the point-in-time initial cost, the operating performance of the investment over time; determining one of the values from the group consisting of: the future sale price, and the future salvage value; using the three determined values to solve for the missing value from the group consisting of: the comparative return measure, the point-in-time initial cost, the operating performance of the investment over time; and using the four values to provide a valuation of an investment, where the four values all correctly match each other as both determined and valuation; wherein the comparative return measure is computed

$${\sum }_{0}^{n} \frac{Equity Cash {Flow}_{n}}{{( 1 + i )}^{n}} = 0 ;$$

when wherein the initial cost is computed as

$$\frac{{\sum }_{0}^{n} \frac{After Tax Pre Asset Operating {Performance}_{n}}{{( 1 + i )}^{n}}}{{\sum }_{0}^{n} \frac{FPF Financing {Denominator}_{n}}{{( 1 + i )}^{n}}} ;$$

wherein the pre asset operating performance is computed as

$$\frac{{\sum }_{0}^{n} \frac{FPF Financing Rate * Intitial {Cost}_{n}}{{( 1 + i )}^{n}}}{{\sum }_{0}^{n} \frac{\begin{matrix}After Tax Pre Asset Operating \\ Performance Compound {Factor}_{n}\end{matrix} }{{( 1 + i )}^{n}}} ;$$

wherein the sale price book value is computed as

$$\frac{\frac{{\sum }_{0}^{n} \begin{matrix}FPF Financing Rate * Intitial Cost + \\ After Tax Pre Assest Operating {Performance}_{n}\end{matrix}}{{( 1 + i )}^{n}}}{Present Value After Tax Ending Book Value} * Ending Book Value ;$$

wherein the salvage value is computed as

$$\frac{\frac{{\sum }_{0}^{n} \begin{matrix}FPF Financing Rate * Intitial Cost + \\ After Tax Pre Assest Operating {Performance}_{n}\end{matrix}}{{( 1 + i )}^{n}}}{After Tax {( 1 + i )}^{n}} ;$$

and wherein i is the internal equity return as the comparative return measure and n is the number of periods measured over.

There is also provided herein a method for providing a value of an investment, a computer readable medium comprising computer readable instructions for carrying out the method, and a computer system carrying out the method, the method comprising: determining any three values from the group consisting of: the comparative return measure, the point-in-time initial cost, the operating performance of the investment over time, and the future sale price; using the three determined values to solve for the fourth value; and using the four values to provide a valuation of an investment, where the four values all correctly match each other as both determined and valuation; wherein the comparative return measure is computed when

$${\sum }_{0}^{n} \frac{Equity Cash {Flow}_{n}}{{( 1 + i )}^{n}} = 0 ;$$

wherein the initial cost is computed as

$$\frac{{\sum }_{0}^{n} \frac{After Tax Pre Asset Operating {Performance}_{n}}{{( 1 + i )}^{n}}}{{\sum }_{0}^{n} \frac{FPF Financing {Denominator}_{n}}{{( 1 + i )}^{n}}} ;$$

wherein the pre asset operating performance is computed as

$$\frac{{\sum }_{0}^{n} \frac{FPF Financing Rate * Intitial {Cost}_{n}}{{( 1 + i )}^{n}}}{{\sum }_{0}^{n} \frac{\begin{matrix}After Tax Pre Asset Operating \\ Performance Compound {Factor}_{n}\end{matrix} }{{( 1 + i )}^{n}}} ;$$

wherein the sale price book value is computed as

$$\frac{{{\sum }_{0}}^{n} \frac{\begin{matrix}FPF Financing Rate * Intital Cost + \\ After Tax Pre Asset Operating {Performance}_{n}\end{matrix}}{{( 1 + i )}^{n}}}{Present Value After Tax Ending Book Value} * Ending Book Value ;$$

and wherein i is the internal equity return as the comparative return measure and n is the number of periods measured over.
There is also provided herein a method for providing a value of an investment, a computer readable medium comprising computer readable instructions for carrying out the method, and a computer system carrying out the method, the method comprising: determining any three values from the group consisting of: the comparative return measure, the point-in-time initial cost, the operating performance of the investment over time, and the future salvage value; using the three determined values to solve for the fourth value; and using the four values to provide a valuation of an investment, where the four values all correctly match each other as both determined and valuation; wherein the comparative return measure is computed when

$${\sum }_{0}^{n} \frac{Equity Cash {Flow}_{n}}{{( 1 + i )}^{n}} = 0 ;$$

wherein the initial cost is computed as

$$\frac{{\sum }_{0}^{n} \frac{After Tax Pre Asset Operating {Performance}_{n}}{{( 1 + i )}^{n}}}{{\sum }_{0}^{n} \frac{FPF Financing {Denominator}_{n}}{{( 1 + i )}^{n}}} ;$$

wherein the pre asset operating performance is computed as

$$\frac{{\sum }_{0}^{n} \frac{FPF Financing Rate * Intitial {Cost}_{n}}{{( 1 + i )}^{n}}}{{\sum }_{0}^{n} \frac{\begin{matrix}After Tax Pre Asset Operating \\ Performance Compound {Factor}_{n}\end{matrix} }{{( 1 + i )}^{n}}} ;$$

wherein the salvage value is computed as

$$\frac{\frac{{\sum }_{0}^{n} \begin{matrix}FPF Financing Rate * Intitial Cost + \\ After Tax Pre Assest Operating {Performance}_{n}\end{matrix}}{{( 1 + i )}^{n}}}{After Tax {( 1 + i )}^{n}} ;$$

and wherein i is the internal equity return as the comparative return measure and n is the number of periods measured over.

### BRIEF DESCRIPTION OF THE DRAWINGS

FIGS. 1 through 5 provide embodiments of traditional methods of computing value. FIG. 1 computes IER, FIG. 2 computes initial cost, FIG. 3 computes pre asset operating performance, and FIGS. 4 and 5 show associated financial statements.

FIGS. 6 through 25 provide embodiments of an embodiment of the FPI method utilizing a basic example and a depreciating asset. FIGS. 6-9 compute IER, FIGS. 10-13 compute initial cost, FIGS. 14-17 compute pre asset operating performance, FIGS. 18-21 compute salvage or disposal value, and FIGS. 22-25 show associated financial statements.

FIGS. 26 through 45 provide embodiments of an embodiment of the FPI method utilizing a basic example and a non-depreciating asset. FIGS. 26-29 compute IER, FIGS. 30-33 compute initial cost, FIGS. 34-37 compute pre asset operating performance, FIGS. 38-41 compute asset sale price, and FIGS. 42-45 show associated financial statements.

FIGS. 46 through 74 provide embodiments of an embodiment of the FPI method utilizing a more standard example than prior FIGS. FIGS. 46-51 compute IER, FIGS. 52-57 compute initial cost, FIGS. 58-63 compute pre asset operating performance, FIGS. 64-69 compute asset sale price, and FIGS. 70-74 show associated financial statements.

FIGS. 75 through 87 show embodiments of advanced calculations related to salvage or disposal value.

FIGS. 88 through 95 show embodiments of advanced calculations related to initial cost.

FIGS. 96 through 101 show embodiments of calculating non-varying pre asset operating performance.

FIGS. 102 through 107 show embodiments of calculating varying pre asset operating performance.

### DESCRIPTION OF THE PREFERRED EMBODIMENT

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wrist-wear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth™ and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the ten “network” generally refers to voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “real time” refers to software operating within operational deadlines for a given event to commence or complete, or for a given module, software, or system to respond, and generally invokes that the response or performance time is, in ordinary user perception and considered the technological context, effectively generally cotemporaneous with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second, particularly where network operations are involved.

Throughout this disclosure the following economics, accounting, and valuation terms are generally intended to have the following meanings.

Book Depreciation Method—book depreciation method where an input of 0 prescribes straight line depreciation and an input of 2 prescribes double declining balance.

Change in Other Assets (Liabilities)—a positive Change in Other Assets (Liabilities) assumption represents items paid during the period but appropriately not yet expensed through the income statement or earned revenue not yet received (placing an asset on the balance sheet). Conversely, a negative change in other assets (liabilities) represents materials or services expensed but not yet paid or revenue received but not yet earned (placing a liability on the balance sheet).

Debt Capital Structure Weight—initial cost financing percent supported by debt.

Debt Rate—cost rate assigned to outstanding debt.

Depreciable Asset True/False—a switch to indicate whether the investment asset in question is depreciable.

Discounted Cash Flow (DCF)—an economic concept valuing a future dollar at a discount to a dollar today.

Income Tax Rate—the income tax rate applicable to operating performances

Income Tax Rate (Deferred Tax) FPI period 0—the income tax rate applicable to the investment question period 0. This rate is used in the instance when deferred taxes need recalculated at the beginning of an investment question due to a change income tax rates.

Initial Cost—the initial cost of an investment question's asset. Initial cost is one of the three basic elements in an investment question.

Internal Equity Return (IER)—an investment question's return measure. Internal equity return is one of three basic elements in an investment question.

Interest Tax Deductibility percent—recent national discussion concerning interest expense tax deductibility has created a need to place interest tax deductibility as a variable assumption. All other income statement items (except equity return) within the investment question are assumed to be tax deductible.

Investment Category—the four predominant investment categories are A) what is an investment question's return measure; B) what is an investment question's point-in-time initial cost; C) what is an investment question's operating performance over time and D) what is an investment question's future sale price or salvage, if any.

Life, Asset periods—the number of periods describing an assets useful life.

Life, Asset periods Previous to FPI Beginning period—accounts for when an investment question's asset life exceeds the investment question life. The assumptions is used to position the investment question life relative to the asset life.

O&M Property Tax Rate, Asset—this assumption percentage captures initial cost related income statement items.

Other Assets (Liabilities), Beginning Balance—the beginning balance of other assets (liabilities) for an investment asset whose investment question period starts after the beginning of the asset's life.

Pre Asset Operating Performance—periodic operating performance amounts over the time frame associated with the investment question. Pre asset operating performance is one of the three investment question basis elements.

Pre Asset Operating Performance next period percent—periodic operating performance percentages over the time frame associated with the investment question. The first period is always 100%. Pre Asset Oper Perf next period percent is used exclusively for category C investment questions.

Return Rate Initial Parameter—an initial estimate for pretax capital cost. The return rate initial parameter assumption and is used only in category A investment questions. The assumption gives the option to start the iterative category A process at a rate other than a spreadsheet's 10% default value. The 10% default spreadsheet rate is used when FPI's return rate initial parameter assumption is left blank (recommended).

Sale Price—is either a solved category D amount or a given inputted percent of ending book value. Ending book value at the end of an investment question creates a mutually exclusive situation between sale price gain (loss) and salvage (disposal). Sale price only occurs when investment question ending book value is not zero

Salvage (Disposal) Initial Cost, Asset percent—is a percent of initial cost. Ending book value at the end of an investment question creates a mutually exclusive situation between salvage (disposal) and sale price gain (loss). Salvage (disposal) only occurs when investment question ending book value is zero

Secondary Flow, Beginning Balance—the beginning balance secondary flow assumption is for investment questions where the investment question's initial FPI period starts after the asset's life starts.

Secondary Flow Return Rate aftertax—the percentage return rate applied to outstanding secondary flow balances

Solve/Assumption Synchronicity—is a Discounted Cash Flow benchmark. Solve/Assumption Synchronicity starts with the four predominant investment categories. Demonstrating solve/assumption synchronicity utilizes a single investment assumption set. Solve/assumption synchronicity takes any three investment category combination as assumptions and solves for the remaining fourth category. The rotating investment category answers match the four original assumption amounts.

Tax Depreciation Method—tax depreciation method where an input of 0 prescribes straight line depreciation and an input of 2 prescribes double declining balance.

Tax Life periods—the number of periods representing an asset's tax life.

Traditional IRR and NPV have shortcomings. One shortcoming manifests itself when IRR and NPV results create conflicting and irreconcilable choices; when to rely on what tool is a subjective decision. IRR and NPV's inflexibility to apply individual return rates to an investment question's differing components explains IRR and NPV's conflicting choices. Conflicting and irreconcilable IRR and NPV choices and other IRR and NPV shortcomings make developing an investment decision replacement methodology desirable.

IRR and NPV's irreconcilable choices are traceable to an ignored time-value axiom. Today's sequence of investment decision steps creates the ignored time-value axiom. Table 1 lists the current IRR and NPV sequence of investment decision steps.

TABLE 1
CURRENT INVESTMENT
DECISION SEQUENCE STEPS
Cash Flows:

1. Combine
2. Discount
3. Adjust
4. Decision

An investment opportunity's initial cost is financed with equity and usually debt. Subsequent operating performances repay the original equity and debt financing plus a return. Table 1's first step combines the investment question's cash flows used to repay equity and debt. However, equity and debt financing have different return rates. A desirable pretax equity return is usually more than 1000 basis points greater than a debt return. The time-value axiom IRR and NPV ignore is one cannot combine nominal equity and debt repayment amounts without first recognizing equity and debt's respective time value denominators. At the investment question's outset, a common denominator does not yet exist for equity and debt. Without a necessary common denominator, equity and debt's repayments should not be combined to begin an investment decision.

Today's Table 1 approach to answering investment questions is like adding the fractions ⅖ and 3/7 and saying the total is ⅚ and not the correct 29/35 total. When an investment question's operating performance is relatively flat, the ignored time-value axiom in Table 1 does not create major issues. It is not a major issue in as much as ⅚ (83.3%) does not differ much from 29/35 (82.9%).

However, as investment opportunities rely on deferred up-side operating performance, the ignored time-value axiom causes Table 1 generated decisions to be materially misrepresented. The ignored common denominator axiom makes Table 1 deferred up-side investment conclusions unsupportable.

The following Illustration 1, Scenario A's non-varying operating performances generate no basis point adjustment between the IRR and a 10% pretax capital cost, Line [3]. However, Scenario B's deferred up-side operating performances generate a 1200 basis point adjustment between the IRR and a 10% pretax capital cost, Line [6]. Pretax capital cost is presented as the combined pretax equity and debt financial performance to allow an organization to attract external capital. Pretax capital cost interjects itself throughout an investment question's financial presentation. Pretax capital cost is further discussed in Chapter 6.

Illustration 1 follows the steps laid out in Table 1: Combine cash flows into Lines [3] and [6], deduce a return rate (IRR), adjust basis points and make a decision. Illustration and Table 1's focus is first vertical and then horizontal.

There is a problem, however. Due to the equity and debt common denominator deficient steps in Table 1, a basis point adjustment for every investment opportunity can not be calculated. Instead of Illustration 1, Scenario A's 0 and B's 1200 basis point adjustments an organization will usually have one basis point adjustment for all investment opportunities. If an organization has set a 600 basis point adjustment, Scenario A's 10% would fail the resulting 16% hurdle rate and Scenario B's 22% would pass the same 16% hurdle rate.

TRADITIONAL IRR Illustration 1
TWO OPERATING PERFORMANCE SCENARIOS: Step Sequence Table 1

| Initial | | | | | | | Adjust | Pretax |
|---|---|---|---|---|---|---|---|---|
| Cost | Operating Performance | | | | | | Value | Capital |
| 0 | 1 | 2 | 3 | 4 | 5 | IRR | Point | Cost |

Scenario A - Non-Varying Operating Performance:

| | | | | | | | | | | | |
|---|---|---|---|---|---|---|---|---|---|---|---|
| [1] | Equity | ($100) | $46 | $43 | $40 | $36 | $31 | | | | |
| [2] | Debt | (400) | 86 | 89 | 92 | 96 | 101 | | | | |
| [3] | Cash Flow | ($500) | $132 | $132 | $132 | $132 | $132 | [symbol] | 10% | 0 | 10% |

Scenario B - Varying Operating Performance:

| | | | | | | | | | | | |
|---|---|---|---|---|---|---|---|---|---|---|---|
| [4] | Equity | ($100) | ($486) | ($289) | $508 | $566 | $799 | | | | |
| [5] | Debt | (400) | 86 | 89 | 92 | 96 | 101 | | | | |
| [6] | Cash | ($500) | ($400) | ($200) | $600 | $662 | $900 | [symbol] | 22% | 1200 | 10% |
| | Flow | | | | | | | | | | |

Deducing individual equity and debt return rates appropriately calculates an investment question's pretax capital cost by taking into account differing time value denominators. Rearranging the sequence of steps in Table 1 effectuates an investment question's correct pretax capital cost calculation. See a new sequence of investment decision steps in Table 2.

TABLE 2
NEW INVESTMENT
DECISION SEQUENCE STEPS
Cash Flows:

1. Discount
2. Weigh
3. Combine
4. Decision

Although Illustration 2 employs the same initial cost, debt financing and operating performances as Illustration 1, Illustration 2 follows the investment decision sequence steps in Table 2. After individually deducing equity and debt return rates, Illustration 2 weighs equity and debt. Table 2's last step before making an investment decision is combining the weighted equity and debt components at timeframe zero—an investment question's common denominator. The investment decision step sequence in Table 2 fixes the ignored time-value axiom in Table 1.

Illustration 2 changes the 16% hurdle rate outcomes in Illustration 1. Following the steps in Table 2, Illustration 2 calculates a 10% pretax capital cost for both Non-Varying Scenario A and Varying Scenario B.

FPI METHODOLOGY Illustration 2
TWO OPERATING PERFORMANCE SCENARIOS: Step Sequence Table 2

| Initial | | | | | | | | Pretax |
|---|---|---|---|---|---|---|---|---|
| Cost | Operating Performance | | | | | | | Capital |
| 0 | 1 | 2 | 3 | 4 | 5 | IRR | Weigh | Cost |

Scenario A - Non-Varying Operating Performance:

| | | | | | | | | | | | |
|---|---|---|---|---|---|---|---|---|---|---|---|
| [1] | Equity | ($100) | $46 | $43 | $40 | $36 | $31 | [symbol] | 30% | 20% | 6% |
| [2] | Debt | (400) | 86 | 89 | 92 | 96 | 101 | [symbol] | 5% | 80% | 4% |
| [3] | Cash | ($500) | $132 | $132 | $132 | $132 | $132 | | n/a | | 10% |
| | Flow | | | | | | | | | | |

Scenario B - Varying Operating Performance:

| | | | | | | | | | | | |
|---|---|---|---|---|---|---|---|---|---|---|---|
| [4] | Equity | ($100) | ($486) | ($289) | $508 | $566 | $799 | [symbol] | 30% | 20% | 6% |
| [5] | Debt | (400) | 86 | 89 | 92 | 96 | 101 | [symbol] | 5% | 80% | 4% |
| [6] | Cash | ($500) | ($400) | ($200) | $600 | $662 | $900 | | n/a | | 10% |
| | Flow | | | | | | | | | | |

Illustration 2 demonstrates how Table 2 investment decision sequence steps nullify issues with varying operating performances. Illustration 2 deduces the appropriate equity and debt return rate before weighing and combining them. Illustration and Table 2's focus is first horizontal and then vertical.

Correcting the ignored time-value axiom permits direct linkage between investment decisions and the investment decision's financial presentation. The need for IRR hurdle rates is eliminated. Correcting the ignored time-value axiom also changes NPV's focus from combined cash flow to net income. The NPV net income focus combined with direct linkage to financial statements fully integrates traditional IRR, NPV and ROE measurement disciplines. A multiple period ROE named the Internal Equity Return (IER) unifies these measurement disciplines.

Being able to correct Illustration 1's ignored time-value axiom, identifying individual equity and debt operating performances, appropriately calculating the 10% pretax capital cost and unifying IRR, NPV and ROE are made possible through a new investment decision methodology named Full Picture Investment (FPI).

Although it seems quite simple to change the investment decision sequence steps from Table 1 to Table 2 and fix the ignored time-value axiom, the methodology to implement the changes in Table 2 is very involved.

The valuation systems and methods described herein start with four predominant investment categories: Category A: what is an investment question's comparative return measure. Category B: what is an investment question's point-in-time initial cost. Category C: what is an investment question's operating performance over time. Category D: what is an investment question's future sale price or salvage, if any. The systems and methods user a discounted cash flow benchmark named Solve/Assumption Synchronicity. Demonstrating solve/assumption synchronicity utilizes a single investment assumption set. Solve/assumption synchronicity takes any three category combination from above as assumptions and solves for the remaining fourth category. The rotating investment category answers match the four original assumption amounts.

In it's simplest form, the four categories can be described as a mathematical algorithms which are used to compute expected values. The following provides the four algorithms. Specifically, Category A solves for the Internal Equity Return of the investment. It does so by taking the sum over the selected periods of the Equity Cash flow divided by 1+ the interest rate to the power of the current period. To put this mathematically it is equation 1:

$${\sum }_{0}^{n} \frac{Equity Cash {Flow}_{n}}{{( 1 + i )}^{n}} = 0 \qquad Equation 1$$

Where i is the internal equity return and n is the number of periods measured over. Table A provides for an example of this in use where i=20% and n=5 utilizing the assumptions of Table E

TABLE A

| [1] | ${\sum }_{0}^{n} \frac{Equity Cash {Flow}_{n}}{{( 1 + i )}^{n}} = \$0$ | | | [5] where iteratively solved i equals internal equity return (20%) and n equals a 5 period count | | | | | |
|---|---|---|---|---|---|---|---|---|---|
| [2] | Period | | Σ | 0 | 1 | 2 | 3 | 4 | 5 |
| [3] | Equity Cash Flow | [17] | | (600) | (1,226) | (740) | 1,079 | 1,196 | 2,324 |
| [4] | Time-value Denominator | (1 + [72]) [symbol] [2] | | 1.000 | 1.200 | 1.440 | 1.728 | 2.074 | 2.488 |
| [5] | NPV Equity Cash Flow | [3]/[4] | $0 | (600) | (1,022) | (514) | 625 | 577 | 934 |
| [6] | Net Book Value | [90] | | | 0.915 | 0.830 | 0.745 | 0.660 | 0.575 |
| [7] | Book Depreciation Expense | [92] | | | 0.085 | 0.085 | 0.085 | 0.085 | 0.085 |
| [8] | Deferred Tax Bal Second Rate | [93]*[79] | | | 0.000 | 0.004 | 0.007 | 0.008 | (0.660) |
| [9] | Prev NBV at Second Rate | −[90]*(1 + [79]) | | | (1.054) | (0.964) | (0.875) | (0.785) | (0.027) |
| [10] | Book Exp & O&M | −(1 − [85])*([92] + [80]) | | | (0.081) | (0.087) | (0.087) | (0.093) | 0.044 |
| [11] | Finance extinguishment | Note 1 | | | 0.046 | 0.046 | 0.045 | 0.044 | 0.158 |
| [12] | Initial Equity Financing | [77] − 1 | | (0.200) | | | | | |
| [13] | FPF Financing Rate | SUM([6]:[12]) | | (0.200) | (0.089) | (0.087) | (0.080) | (0.081) | 0.175 |
| [14] | Initial Cost | [73] | | 3,000 | 3,000 | 3,000 | 3,000 | 3,000 | 3,000 |
| [15] | FPF Financing | [13]*[14] | | (600) | (266) | (260) | (241) | (244) | 524 |
| [16] | After Tax Pre Oper Perf | [74]*(1 − [85]) | | | (960) | (480) | 1,320 | 1,440 | 1,800 |
| [17] | Equity Cash Flow | SUM([15]:[16]) | | (600) | (1,226) | (740) | 1,079 | 1,196 | 2,324 |

Note 1:
−[96]*(1 − [77]) + [96]*([79] − [77]*([78]*(−[86]*[85] + 1) + 1) + 1)

Category B solves for the initial cost using Equation 2:

$$Equation 2$$

$$\frac{{\sum }_{0}^{n} \frac{After Tax Pre Asset Operating {Performance}_{n}}{{( 1 + i )}^{n}}}{{\sum }_{0}^{n} \frac{FPF Financing {Denominator}_{n}}{{( 1 + i )}^{n}}} ;$$

Table B continues the example of Table A.

TABLE B

| [18] | ${\sum }_{0}^{n} \frac{After Tax Pre Asset Operating {Performance}_{n}}{\begin{matrix}{( 1 + i )}^{n} \\ divided by\end{matrix}} = 1 , 048$ | | | [23] | | | | | |
|---|---|---|---|---|---|---|---|---|---|
| [19] | ${\sum }_{0}^{n} \frac{FPF Financing {Denominator}_{n}}{\begin{matrix}{( 1 + i )}^{n} \\ equals\end{matrix}} = 0.349$ | | | [33] | | | | | |
| [20] | Initial Cost $3,000 | | | [18/19] | | | | | |
| | | | Σ | 0 | 1 | 2 | 3 | 4 | 5 |
| [21] | After Tax Pre Oper Perform | [74]*(1 − [85]) | | | (960) | (480) | 1,320 | 1,440 | 1,800 |
| [22] | Time-value Denominator | (1 + [72]) [symbol] [2] | | | 1.200 | 1.440 | 1.728 | 2.074 | 2.488 |
| [23] | After Tax Pre Oper Perform | [21]/[22] | 1,048 | | (800) | (333) | 764 | 694 | 723 |
| [24] | Net Book Value | −[90] | | | (0.915) | (0.830) | (0.745) | (0.660) | (0.575) |
| [25] | Book Depreciation Expense | −[92] | | | (0.085) | (0.085) | (0.085) | (0.085) | (0.085) |
| [26] | Deferred Tax Bal Second Rate | −[93]*[79] | | | 0.000 | (0.004) | (0.007) | (0.008) | 0.027 |
| [27] | Prev NBV at Second Rate | [90]*(1 + [79]) | | | 1.054 | 0.964 | 0.875 | 0.785 | 0.660 |
| [28] | Book Exp & O&M | (1 − [85])*([92] + [80]) | | | 0.081 | 0.087 | 0.087 | 0.093 | (0.044) |
| [29] | Finance extinguishment | Note 2 | | | (0.046) | (0.046) | (0.045) | (0.044) | (0.158) |
| [30] | Initial Equity Financing | 1 − [77] | | 0.200 | | | | | |
| [31] | FPF Financing Rate | SUM([24]:[30]) | | 0.200 | 0.089 | 0.087 | 0.080 | 0.081 | (0.175) |
| [32] | Time-value Denominator | (1 + [72]) [symbol] [2] | | 1.000 | 1.200 | 1.440 | 1.728 | 2.074 | 2.488 |
| [33] | NPV FPF Financing Rate | [31]/[32] | 0.349 | 0.200 | 0.074 | 0.060 | 0.046 | 0.039 | (0.070) |

Note 2:
[96]*(1 − [77]) − [96]*([79] − [77]*([78]*(−[86]*[85] + 1) + 1) + 1)

Category C solves the Pre Asset Operating Performance using Equation 3:

$$Equation 3$$

$$\frac{{Σ}_{0}^{n} \frac{FPF Financing Rate * Intital {Cost}_{n}}{{( 1 + i )}^{n}}}{{Σ}_{0}^{n} \frac{\begin{matrix}After Tax Pre Asset Operating \\ Performance Compound {Factor}_{n}\end{matrix}}{{( 1 + i )}^{n}}}$$

Table C continues the example of Tables A and B to continue the illustration.

TABLE C

| [34] | ${\sum }_{0}^{n} \frac{FPF Financing Rate times Initial {Cost}_{n}}{\begin{matrix}{( 1 + i )}^{n} \\ divided by\end{matrix}} = 1 , 048$ | | | [49] | | | | | |
|---|---|---|---|---|---|---|---|---|---|
| [35] | ${\sum }_{0}^{n} \frac{After Tax Pre Asset Oper Perf compound {factor}_{n}}{\begin{matrix}{( 1 + i )}^{n} \\ equals\end{matrix}} = ( 0.655 )$ | | | [52] | | | | | |
| [36] | Pre Asset Operating Performance ($1,600) | | | [34]/[35] | | | | | |
| [37] | | | Σ | 0 | 1 | 2 | 3 | 4 | 5 |
| [38] | Net Book Value | −[90] | | | (0.915) | (0.830) | (0.745) | (0.660) | (0.575) |
| [39] | Book Depreciation Expense | −[92] | | | (0.085) | (0.085) | (0.085) | (0.085) | (0.085) |
| [40] | Deferred Tax Bal Second Rate | −[93]*[79] | | | 0.000 | (0.004) | (0.007) | (0.008) | 0.027 |
| [41] | Prev NBV at Second Rate | [90]*(1 + [79]) | | | 1.054 | 0.964 | 0.875 | 0.785 | 0.660 |
| [42] | Book Exp & O&M | (1 − [85])*([92] + [80]) | | | 0.081 | 0.087 | 0.087 | 0.093 | (0.044) |
| [43] | Finance extinguishment | Note 3 | | | (0.046) | (0.046) | (0.045) | (0.044) | (0.158) |
| [44] | Initial Equity Financing | 1 − [77] | | 0.200 | | | | | |
| [45] | FPF Financing Rate | SUM([38]:[44]) | | 0.200 | 0.089 | 0.087 | 0.080 | 0.081 | (0.175) |
| [46] | Initial Cost | [73] | | 3,000 | 3,000 | 3,000 | 3,000 | 3,000 | 3,000 |
| [47] | FPF Financing | [45]*[46] | | 600 | 266 | 260 | 241 | 244 | (524) |
| [48] | Time-value Denominator | (1 + [72]) [symbol] [2] | | 1.000 | 1.200 | 1.440 | 1.728 | 2.074 | 2.488 |
| [49] | NPV FPF Financing | [47]/[48] | 1,048 | 600 | 222 | 180 | 139 | 118 | (211) |
| [50] | After Tax PaOp compound | [97]*(1 − [85]) | | | 0.600 | 0.300 | (0.825) | (0.900) | (1.125) |
| [51] | Time-value Denominator | (1 + [72]) [symbol] [2] | | | 1.200 | 1.440 | 1.728 | 2.074 | 2.488 |
| [52] | NPV AT PaOp compound | [50]/[51] | (0.655) | | 0.500 | 0.208 | (0.477) | (0.434) | (0.452) |

Note 3:
[96]*(1 − [77]) − [96]*([79] − [77]*([78]*(−[86]*[85] + 1) + 1) + 1)

Finally, Category D solves for the sale price using Equation 4 to determine the sale price book value:

$$Equation 4$$

$$\frac{{Σ}_{0}^{n} \frac{\begin{matrix}FPF Financing Rate * Intital Cost + \\ After Tax Pre Asset Operating {Performance}_{n}\end{matrix}}{{( 1 + i )}^{n}}}{Present Value After Tax Ending Book Value}$$

And Equation 5 to solve for the sale price

### Equation 5

### Equation 4*Ending Book Value

Table D illustrates the completion of the example begun in Tables A, B, and C.

TABLE D

| [53] | ${\sum }_{0}^{n} \frac{FPF Financing Rate times Initial Cost plus {PaOp}_{n}}{\begin{matrix}{( 1 + i )}^{n} \\ divided by\end{matrix}} = 583$ | | | [71] | | | | | |
|---|---|---|---|---|---|---|---|---|---|
| [54] | PV After Tax Ending Bool Value = 416 | | | [73]*[90]*(1 − [85])/(1 + [72]) [symbol] [89] | | | | | |
| [55] | Sale Price Book Value 1.400 | | | [53]/[54] | | | | | |
| [56] | Ending Book Value 1,726 | | | [73]*[90] | | | | | |
| [57] | Sale Price $2,417 | | | [55]*[56] | | | | | |
| | | | Σ | 0 | 1 | 2 | 3 | 4 | 5 |
| [58] | Net Book Value | −[90] | | | (0.915) | (0.830) | (0.745) | (0.660) | (0.575) |
| [59] | Book Depreciation Expense | −[92] | | | (0.085) | (0.085) | (0.085) | (0.085) | (0.085) |
| [60] | Deferred Tax Bal Second Rate | −[93]*[79] | | | 0.000 | (0.004) | (0.007) | (0.008) | (0.009) |
| [61] | Prev NBV at Second Rate | [90]*(1 + [79]) | | | 1.054 | 0.964 | 0.875 | 0.785 | 1.092 |
| [62] | Book Exp & O&M | (1 − [85])*([92] + [80]) | | | 0.081 | 0.087 | 0.087 | 0.093 | 0.043 |
| [63] | Finance extinguishment | Note 4 | | | (0.046) | (0.046) | (0.045) | (0.044) | (0.158) |
| [64] | Initial Equity Financing | 1 − [77] | | 0.200 | | | | | |
| [65] | FPF Financing Rate | SUM([58]:[64]) | | 0.200 | 0.089 | 0.087 | 0.080 | 0.081 | 0.309 |
| [66] | Initial Cost | [73] | | 3,000 | 3,000 | 3,000 | 3,000 | 3,000 | 3,000 |
| [67] | FPF Financing | [66]*[65] | | 600 | 266 | 260 | 241 | 244 | 926 |
| [68] | After Tax Pre Oper Perf | −[74]*(1 − [85]) | | | 960 | 480 | (1,320) | (1,440) | (1,800) |
| [69] | FPF Financing & PaOp | SUM([67]:[68]) | | 600 | 1,226 | 740 | (1,079) | (1,196) | (874) |
| [70] | Time-value Denominator | (1 + [72]) [symbol] [2] | | 1.000 | 1.200 | 1.440 | 1.728 | 2.074 | 2.488 |
| [71] | NPV FPF Financing & PaOp | [69]/[70] | 583 | 600 | 1,022 | 514 | (625) | (577) | (351) |

Note 4:
−(−[96]*(1 − [77]) + [96]*([79] − [77]*([78]*([86]*((1 − [85]) − 1) + 1) + 1) + 1))

TABLE E

| | ASSUMPTIONS | Category | | | | | | |
|---|---|---|---|---|---|---|---|---|
| [72] | Internal Equity Return (IER) | [A] | [G] | 20% | | | | |
| [73] | Initial Cost | [B] | [G] | $3,000 | | | | |
| [74] | Pre Asset Operating Performances | [C] | [G] | (1,600) | (800) | $2,200 | $2,400 | $3,000 |
| [75] | Sale Price Book Value percent | [D] | [G] | 140% | | | | |
| [76] | Salvage (Disposal) Initial Cost percent | | [G] | 6.6% | | | | |
| [77] | Debt Capital Structure Weight | | [G] | 80% | | | | |
| [78] | Debt Rate | | [G] | 4.2% | | | | |
| [79] | Secondary Flow Return Rate aftertax | | [G] | 5.4% | | | | |
| [80] | Asset O&M Property Tax Rate | | [G] | 5.0% | 6.0% | 6.0% | 7.0% | 7.2% |
| [81] | Depreciable Asset TRUE/FALSE | | [G] | TRUE | | | | |
| [82] | Pre Asset Oper Perf next period percent | | [G] | 100% | 50% | −275% | 109% | 125% |
| [83] | Asset Life periods | | [G] | 11 | | | | |
| [84] | Book Depreciation: Straight Line 0; DDB 2 | | [G] | 0 | | | | |
| [85] | Income Tax Rate | | [G] | 40% | | | | |
| [86] | Interest Tax Deductibility percent | | [G] | 90% | | | | |
| [87] | Tax Depreciation Life periods | | [G] | 7 | | | | |
| [88] | Tax Depreciation Method: Straight 0; DDB 2 | | [G] | 2 | | | | |

| | | | |
|---|---|---|---|
| [89] | FPI periods | COUNT([74]:[74]) | 5 |

| | BOOK TAX DEPRECIATION AND FINANCING | 1 | 2 | 3 | 4 | 5 |
|---|---|---|---|---|---|---|
| [90] | Book Value 1 − IF([81], VDB(1, [76], [83], 0, [2], [84]), 0) | 0.915 | 0.830 | 0.745 | 0.660 | 0.575 |
| [91] | Tax Val 1 − IF([81], VDB(1, IF([76]<0, 0, [76]), [87], 0, MIN([87], [2]), [88]), 0) | 0.714 | 0.510 | 0.364 | 0.260 | |
| [92] | Book Expense [90] − [90] | 0.085 | 0.085 | 0.085 | 0.085 | 0.085 |
| [93] | Deferred Tax Balance ([90] − [91]) * [85] | 0.080 | 0.128 | 0.152 | 0.160 | |
| [94] | PretaxCap [72] * (1 − [77])/(1 − [85]) + [77] * [78] * ([86] + (1 − [86])/(1 − [85])) | 0.103 | 0.103 | 0.103 | 0.103 | |
| [95] | Pretax Cap + 1 reverse Compound (1 + [94])\hat{ }([89] − [2]) | 1.629 | 1.477 | 1.340 | 1.216 | |
| [96] | Financing − [96] * ([94] * (([95] − [90]/[96])/([95] − 1) − 1) − 1) | 0.931 | 0.855 | 0.770 | 0.678 | |
| [97] | PreAsset Oper Perf (PaOp) Compound Factor [97] * [82] | 1.000 | 0.500 | (1.375) | (1.500) | (1.875) |

It should be recognized that the FPI methodology contemplated herein can and generally will be implemented on a computer or similar device and will be designed to operate in real-time or near real-time to provide for valuable analysis. Methods of analysis which are too slow in calculation to provide sufficiently quick evaluation are unsuitable for most investment questions. In order to provide the FPI methodology, it may, therefore, be encapsulated in a series of computer readable instructions (e.g. such as software or hardware) for instructing a computer to carry out the steps and calculations of the method. In an embodiment, the method may be implemented by a function in spreadsheet or other accounting software such as, but not limited to Microsoft Excel™.

The present disclosure also contemplates a computer system, including a single computer and a network of client and servers, that carry out the method. The computer system may then return value to a human user to be acted upon, or the computer system may automatically act upon the calculation such as by making investments without human intervention.

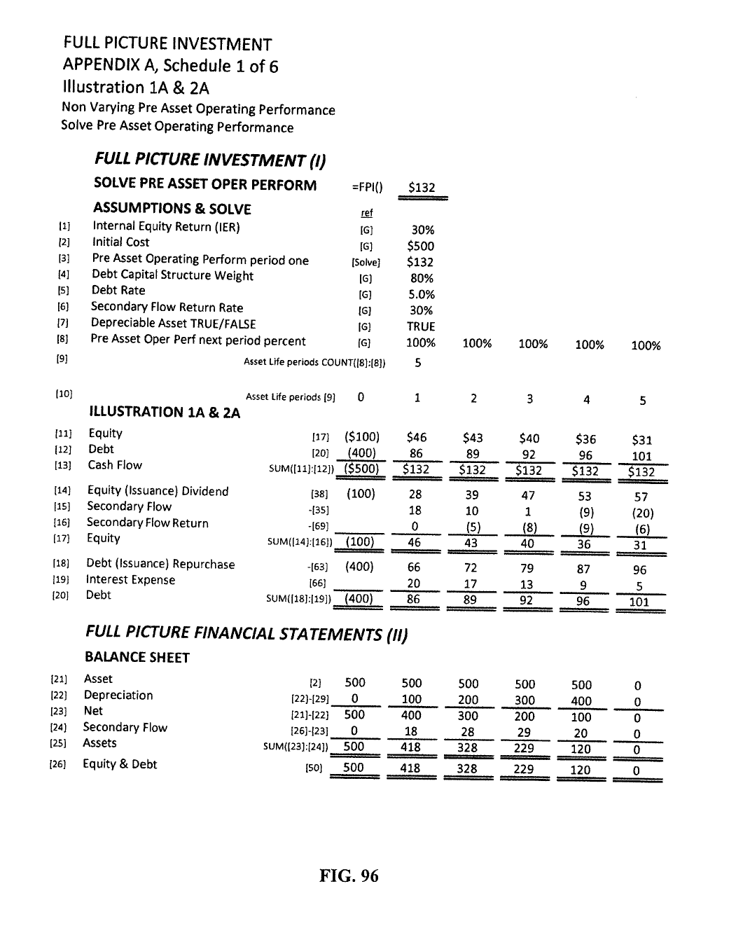

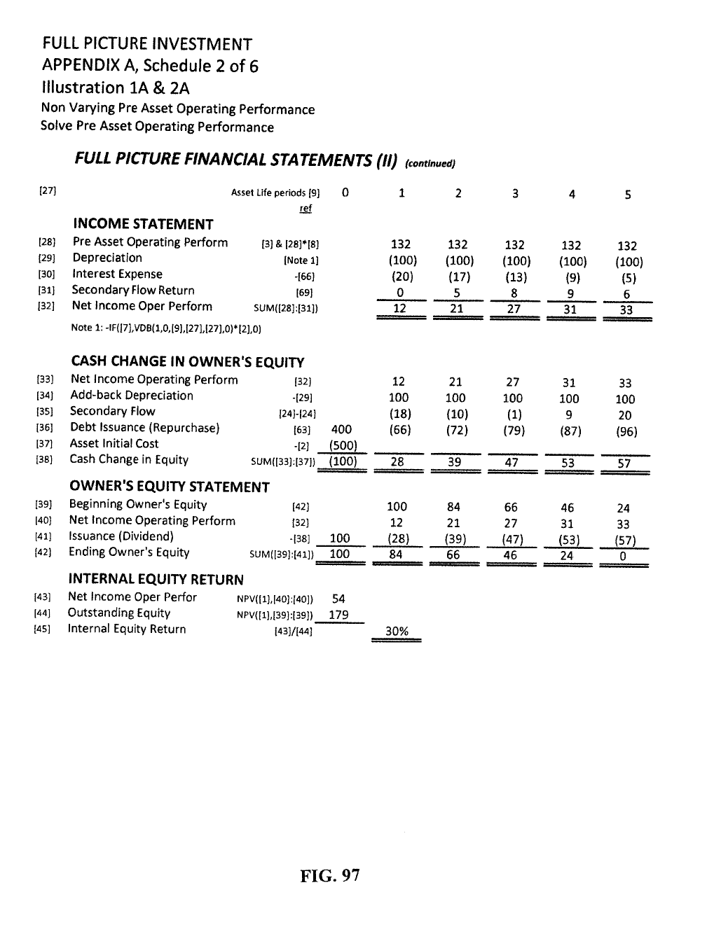

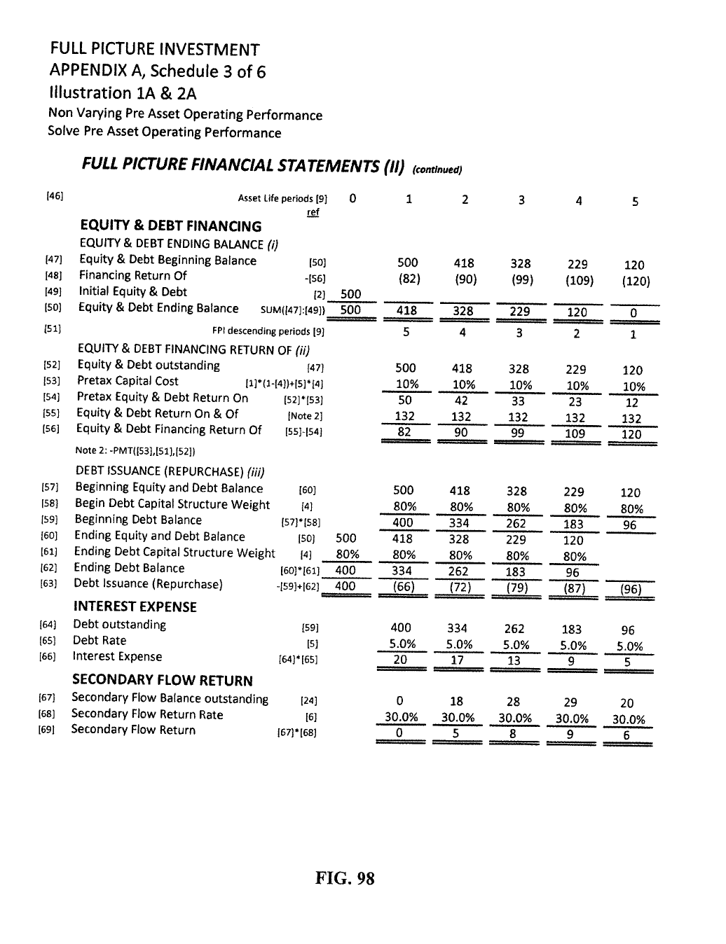

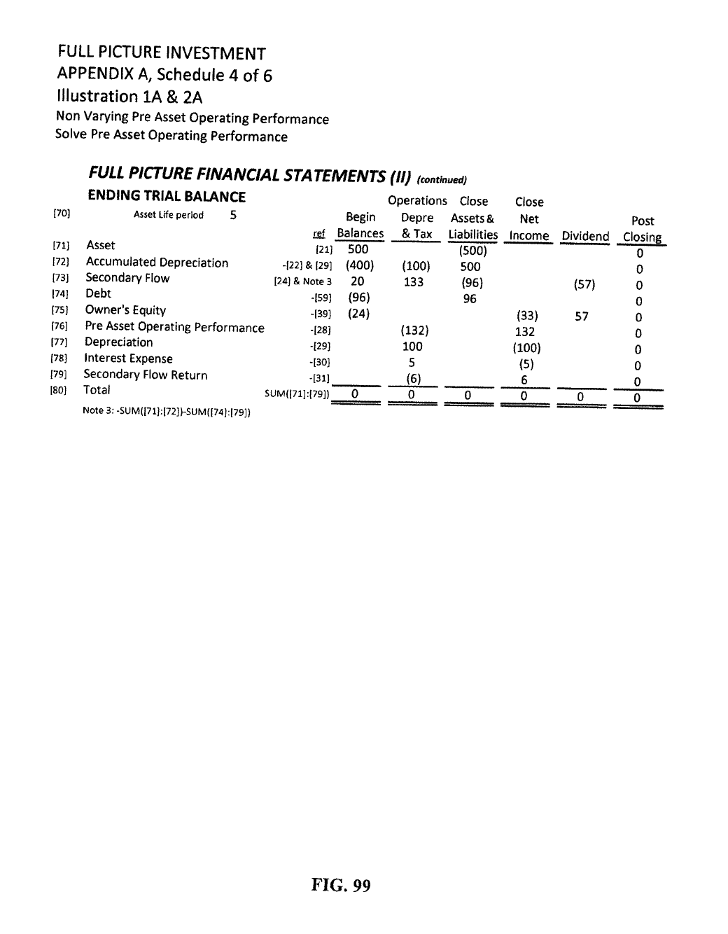

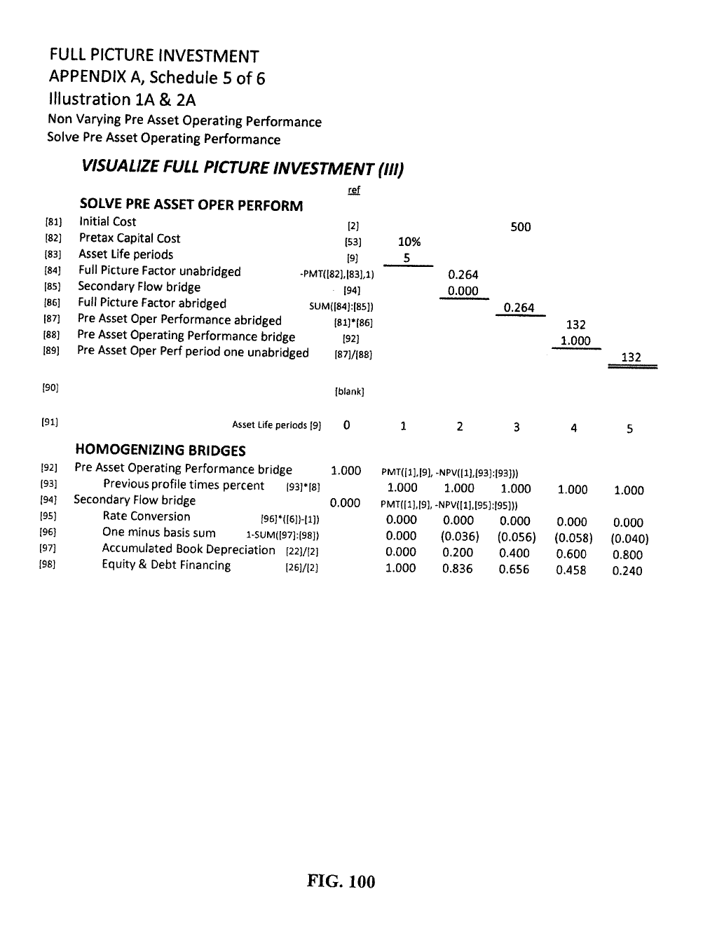

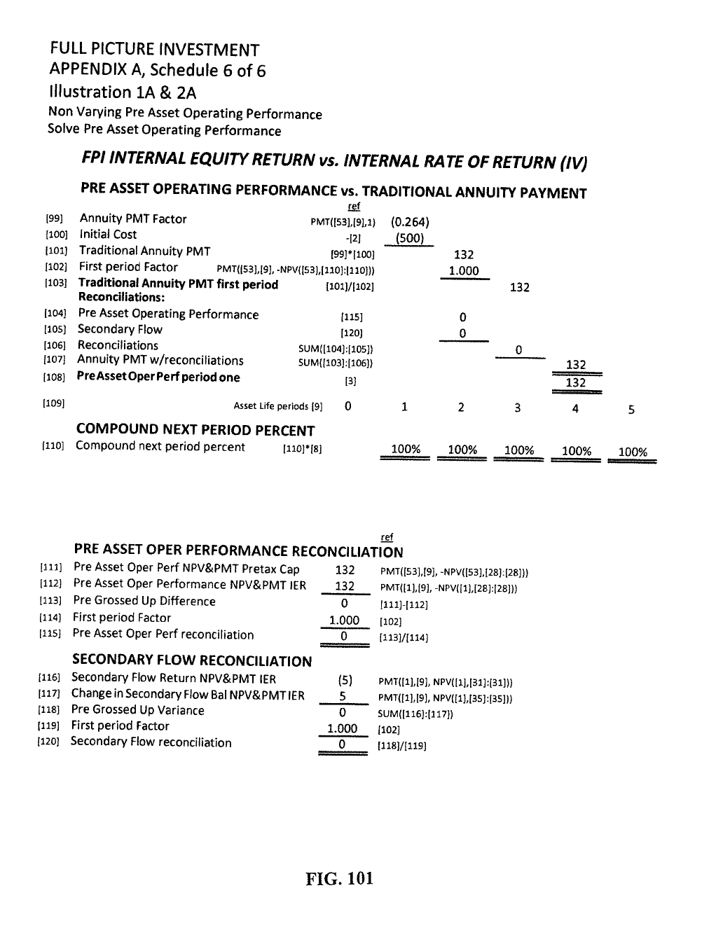

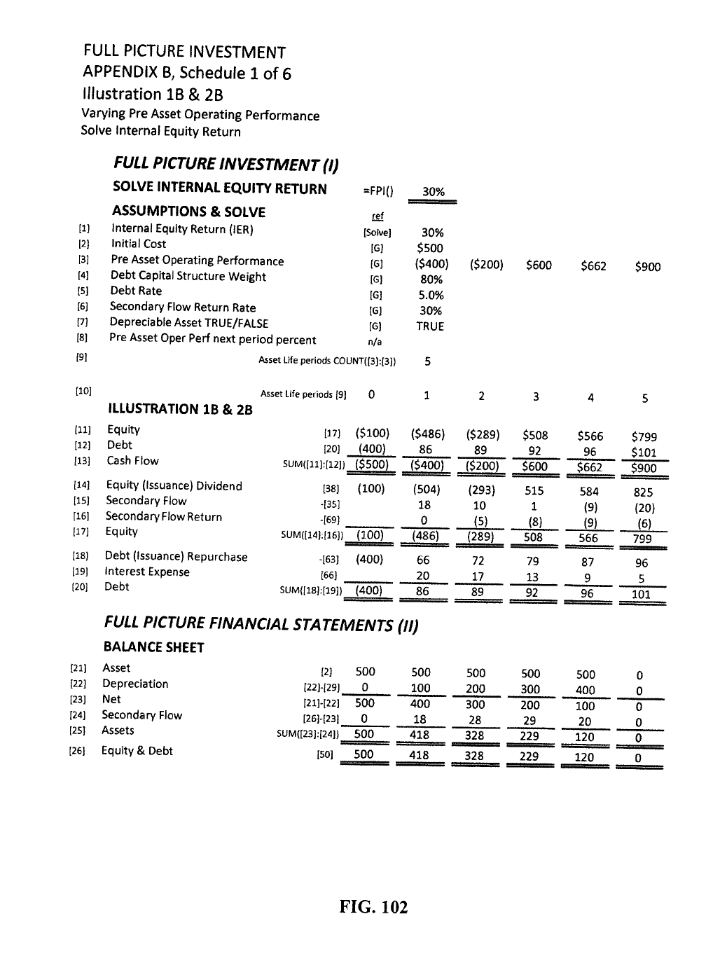

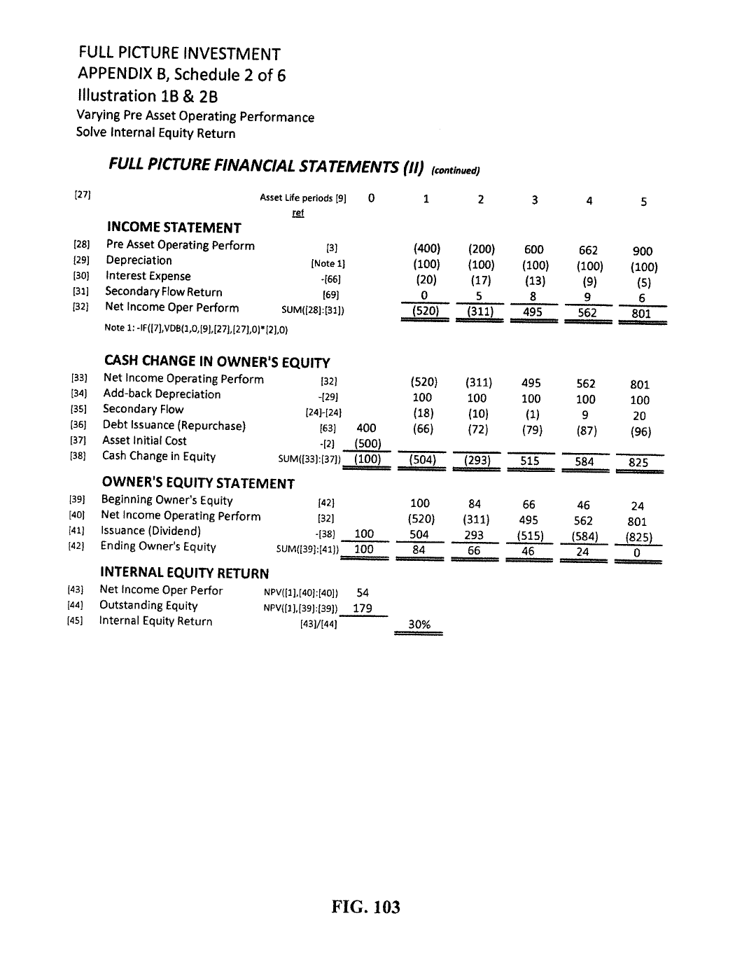

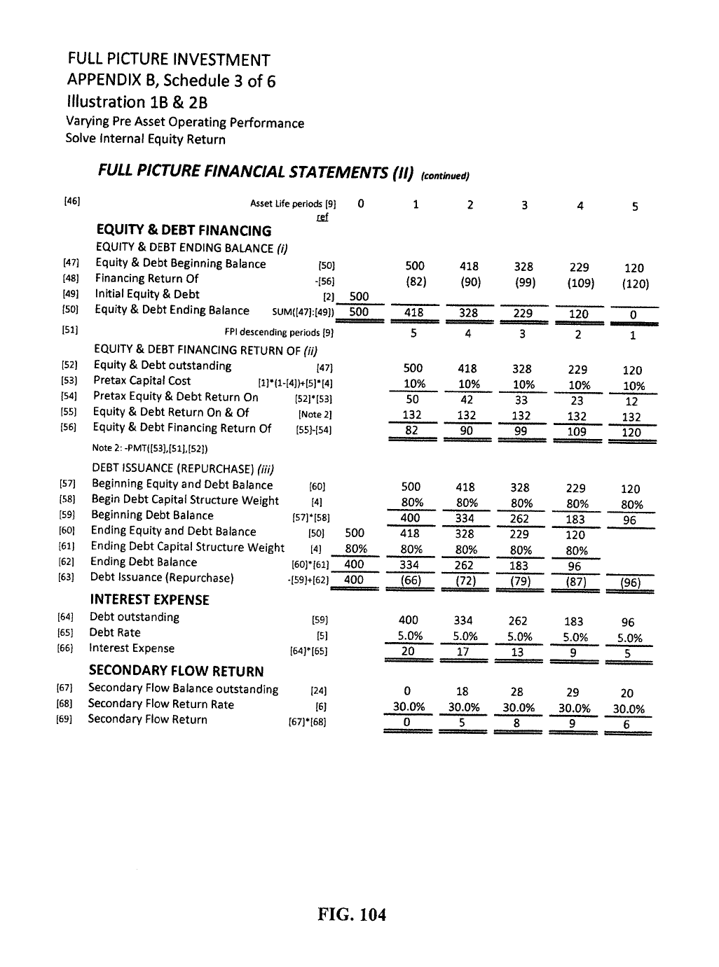

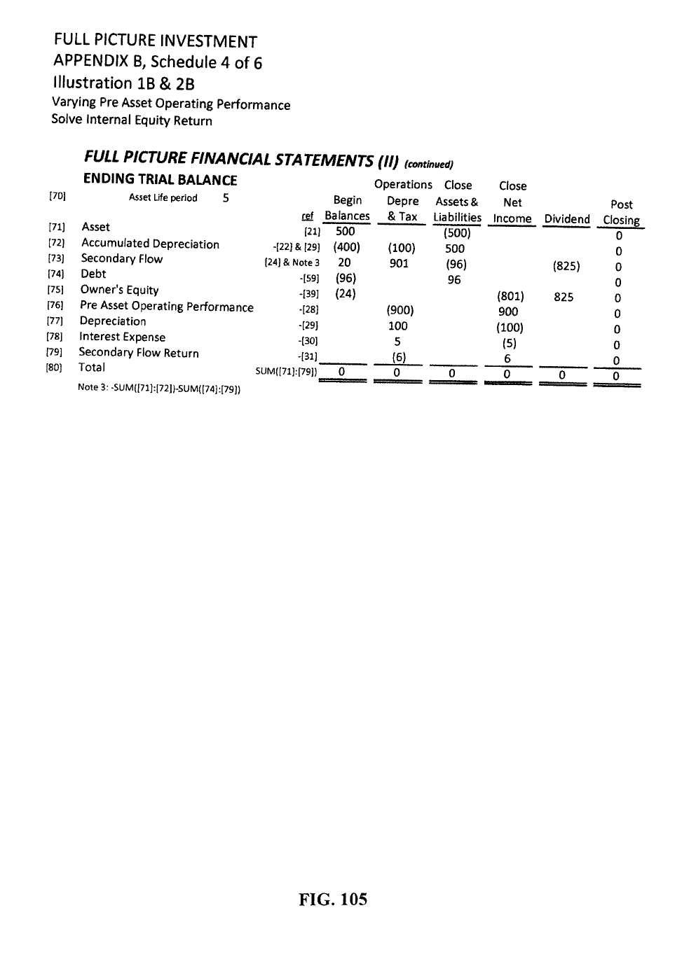

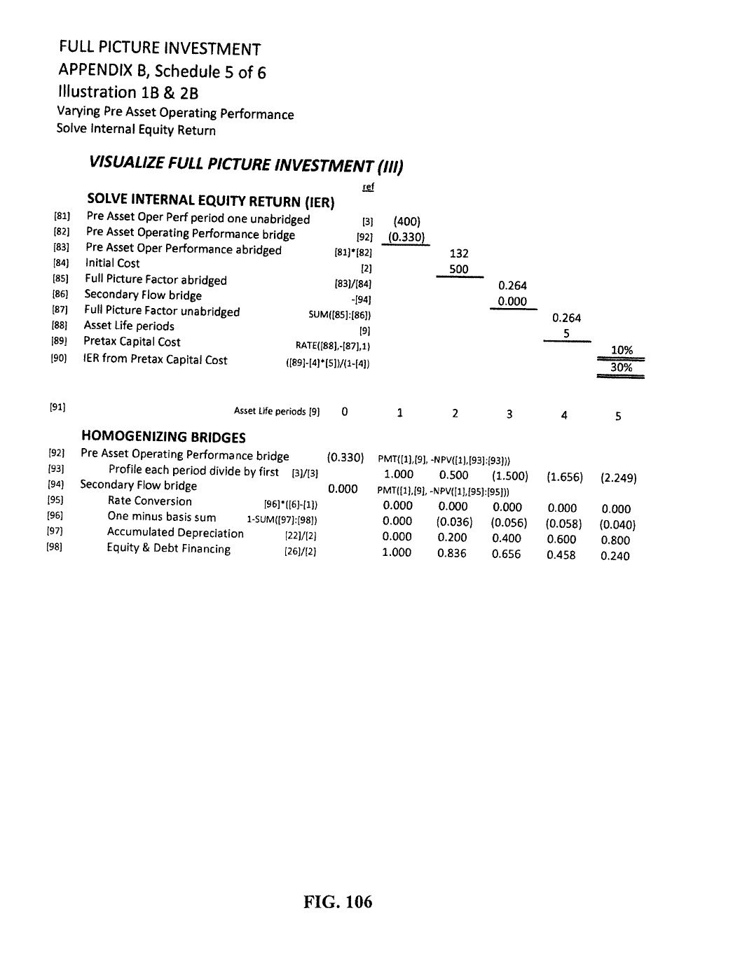

The comprehensive FPI methodology is best displayed and communicated through transitioning investment questions into financial statements. For a set of affirming Illustration 2, Scenarios A and B financial statements, see Appendices A and B, FIGS. 96 and 102. Scenario A, Non-Varying Operating Performance, Lines [1]-[3], can be found in Appendix A, Schedule 1, FIG. 96, Lines [11]-[13]. Scenario B, Varying Operating Performance, Lines [4]-[6], can be found in Appendix B, Schedule 1, FIG. 102, Lines [11]-[13].

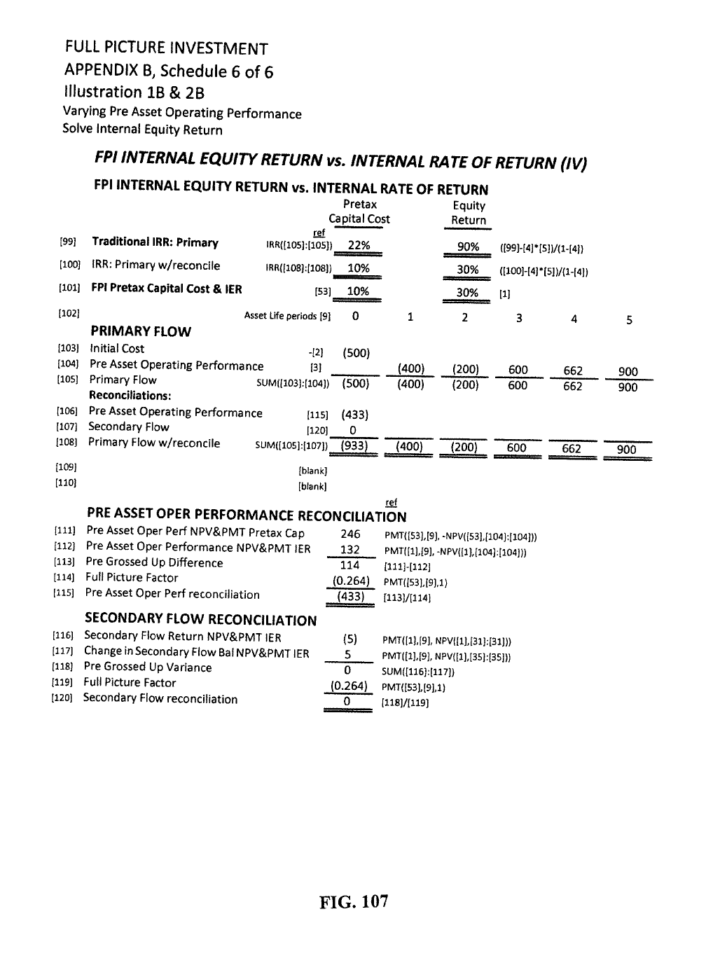

See both Appendix IERs at Line [45] and also the reconciliation between traditional IRR's 22% and FPI's 10% pretax capital cost calculations in Appendix B, Schedule 6, FIG. 107.

Both Illustration and Appendix Scenarios A and B use debt to finance 80% of the asset's $500 initial cost investment. Both Scenarios maintain an 80% debt and 20% equity balance sheet throughout the investment question's lifetime, as shown in Appendices A and B. As a result, the debt flows for both scenarios are the same Illustration Line [2] and [5].

Debt's role in an investment question does not fund operating performance shortfalls. An infusion from the investment question's owner funds operating performance shortfalls. See Scenario B, Line [4], period 1 and 2. The investment question's owner may or may not secure additional debt to provide the operating performance shortfalls. Nevertheless, an investment question owner's specific financing arrangements are not directly pertinent to investment questions. The related pertinent issue is the investment question owner's required investment return over the course of the investment question's lifetime. The investment question owner's required return contemplates risk surrounding the need to fund operating performance shortfalls. As it pertains to analytics surrounding investment questions, specific debt is only used to support the investment's initial cost. This is an aspect where FPI's methodology further delineates investment and financing decisions.

Debt alone does not encompass all of IRR and NPV shortcomings. Even investment questions with no debt have IRR and NPV shortcomings. IRR and NPV apply their overall singular rate to all flows, including each investment question's internal secondary flow. Secondary flows should receive a user-defined return rate and not an overall rate. Table 1 sequence steps allowing secondary flows to receive the traditional tool's overall rate create an ignored time-value axiom similar in nature to the one surrounding debt.

FPI's methodology enables solve/assumption synchronicity. Solve/assumption synchronicity entails being able to switch the solved for investment category by rotating assumptions. In Appendix B the $500 initial cost and the operating performances were given assumptions and the 10% pretax capital cost was the item solved. FPI's methodology allows the subsequent rotation of the 10% pretax capital cost and the operating performance into the given assumptions and then solve for an investment question's initial cost. Being able to interchange assumptions and the solved for investment category is FPI's solve/assumption synchronicity. Starting in Exhibit 4, a fourth Sale Price Salvage (Disposal) investment category is introduced into the solve/assumption rotation. Solve/assumption synchronicity validates FPI's methodology as an investment structure to give business professionals comfort in making investment decisions.

It is now possible to answer investment questions without ignoring time-value axioms and without hurdle adjustments. Without ignored axioms one can create direct linkage between an investment opportunity and the opportunity's financial statements. Solve/assumption synchronicity and direct linkage between an investment opportunity and the opportunity's financial statements is a powerful advance forward in structuring, formulating and deriving investment answers of all kinds. After investment decisions are executed, financial statement direct linkage is also a powerful advance forward to effectively monitor and reconcile actual results to anticipated.

Ideally, answering an investment question entails applying the appropriate rate to an investment question's various components with secondary flows receiving a user-defined rate. Full Picture Investment is methodology to take these desired attributes and create a synchronized investment structure to evaluate investment questions. FPI's methodology answers investment questions through modifying select traditional tool traits and infusing them into IER comparative return measure.

FPI's methodology causes the need for existing IRR, NPV, hurdle rate and pay-back evaluation processes to be re-engineered around the methodology's structure. Business professionals are able to make an investment decision with a preview the decision has on future equity returns.

When IRR and NPV give conflicting conclusions, determining guidelines surrounding when to rely upon what tool, injects decision processes with bias and uncertainty. Bias and uncertainty actually indicates seriously flawed investment decision making. No longer will either IRR or NPV suffice to answer real world investment questions in an acceptable manner. FPI forever solves the age-old IRR versus NPV debate.

To better understand FPI and how it addresses IRR and NPV shortcomings requires looking below an investment question's initial surface. An investment question's cash in-flow and out-flow components are divided into two flow classes: primary and secondary. A given primary flow comes from the investment question's facts. Primary flow includes initial cost outflow and subsequent operating performance flows. Primary flow's initial cost outflow is financed with owner's equity or as is often the case an equity and debt combination. Over an investment question's duration, equity and debt financing is repaid with primary flow's operating performance.

The primary flows are balanced with the outside world throughout the project's life with the secondary flow. Although secondary flow's visibility is internal to the investment question, secondary flow's activity is outside the investment question. As a result, the secondary flow does not share the same business risk as the primary flow. The secondary flow's business risk is external to the investment question under evaluation; with secondary flow's balancing function outside the investment question and differing business risk, the secondary flow should receive a rate unassociated with either NPV or IRR's rate. The secondary flow should receive a user-defined investment rate from the investment question's owner. Depending on the investment question owner's circumstances the rate is usually found in a range between cash reserve returns and an equity return based upon other investments opportunities. Properly addressing the secondary flow rate with a user-defined rate solves a traditional tool shortcoming.

Another significant IRR and NPV shortcoming occurs when an organization leverages equity capital with debt. IRR and NPV's rates must portray a combined debt and equity mixture. Discussion will show discounting varying period-to-period operating performance with a lower leveraged mixed rate can be a more significant traditional tool shortcoming than the secondary flow shortcoming.

TABLE 3
INVESTMENT QUESTION COMPONENTS:

```
Primary Flow:
  Equity
  Asset Initial Cost
  Operating Performance
  Asset Sale Price
  Debt (if any)
Secondary Flow
```

An investment question has several primary flow components and one secondary flow component. See Table 3. The traditional tool's critical flaw is their tools each have only one rate to apply to flow components. The cause of the traditional tool's critical flaw is their overly simple mechanics. An investment structure IRR and NPV replacement tool needs to be versatile enough to apply the appropriate rate to each flow. Today's computers are advantageous in this endeavor.

Table 4 is a summary comparison between FPI's IER and the traditional tool's IRR results for a shared set of assumptions. The two results attempt to convey to an investment question's owner the investment question's comparative attractiveness. Table 4's result difference (FPI's 20% vs. traditional's 58% equity return) illustrates how varying operating performance, secondary return rates and other impacts are properly captured by FPI and not the IRR traditional tool. This discussion not only explores reasons behind Table 4's IER vs. IRR result difference but also differences between FPI and other traditional tools.

TABLE 4
FPI vs. IRR TRADITIONAL TOOL

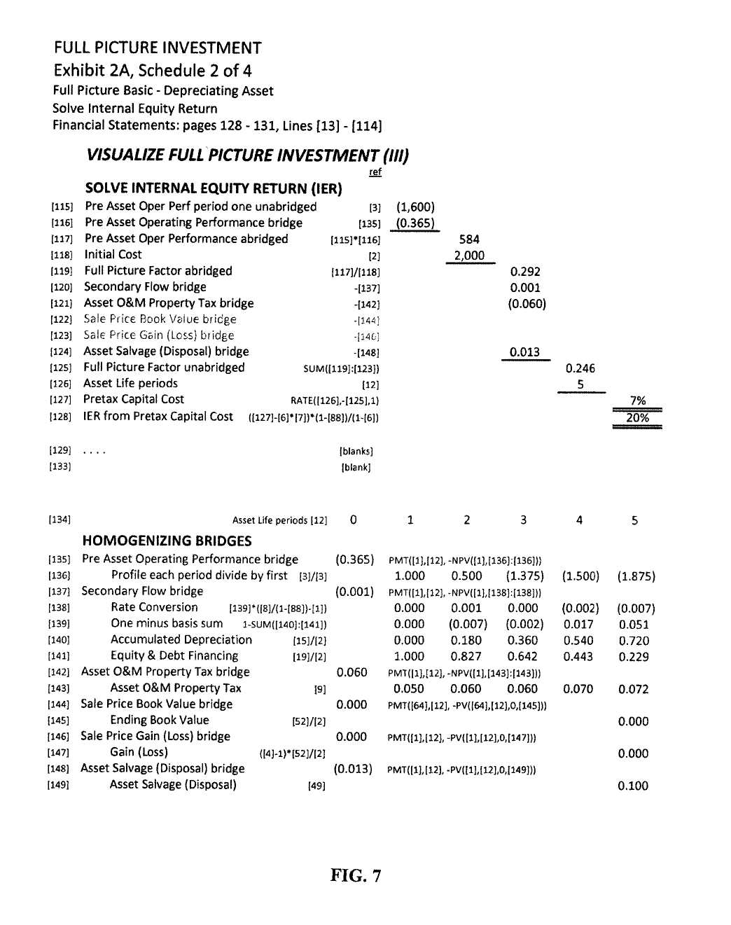

Results
Exhibit 2A, FIG. 7

| Methodology | | Pretax | Equity |
|---|---|---|---|
| (focus) | Description | Capital Cost | Return |
| Traditional | IRR | 15% | 58% |
| (Primary Flow) | | | |
| FPI | Internal Equity | 7% | 20% |
| (Equity) | Return (IER) | | |

IRR, NPV and the other traditional tools are both easy to apply and prolific in their application. They both are also inflexible and can produce conflicting conclusions. Chapter 1 discusses how conflicting conclusions between IRR and NPV are caused by an ignored time-value axiom.

The quantitative NPV involves a user-defined return rate in order to form an investment question's evaluation. NPV begins with an insight to the answer through an assigned return rate with not first contemplating the investment question's individual facts. In order to be relevant, NPV is forgiven this shortcoming; when NPV calculations start with an agreeable return rate, dollar denominated results are allowed to be used for making investment decisions.

A positive NPV is viewed as a positive quantitative outcome. A high potential investment generates a large NPV. A lesser potential investment with deferred operating performance upside can also generate a large NPV.

A debt influenced NPV rate over recognizes operating performance towards the investment question's end. Over recognizing operating performance impacts at the investment question's end creates flawed investment decisions.

IRR is a comparative measure and does utilize investment question's facts. IRR deduces an overall return rate from an investment question's single primary flow. However, within the primary flow are individual components having their own individual rate.

When debt financing is present, IRR's singular overall rate must portray a combined debt and equity mixture. A high potential investment question's mixed IRR is still lower than an equity only IRR. A lower leverage mixed rate can over recognize operating performance impacts towards an investment question's end and create flawed investment decisions.

A high potential investment question's IRR can move considerably above an appropriate secondary flow return. An extremely high IRR makes relying solely on IRR for business decisions problematic. Secondary flows returning an unrealistic rate (even if deduced from investment question's facts) can call into question the investment question's true attractiveness.

What is needed to properly answer investment questions is a synchronized investment structure with a comparative equity return and a user-defined secondary flow rate. These traits are best found, observed, highlighted and authenticated in financial statements.

Every investment question and its FPI answer can produce affirming financial statements. FPI's methodology demonstrates itself through financial statements. Financial statements can be used to visualize what is often unclear or not easily identifiable in an investment question and answer. For example, FPI has ability to preview an investment question's equity return through financial statements. Another FPI ability is to visually present secondary flow activity through financial statements.

The four investment question categories (comparative return measure (IER), initial cost, operating performance and sale price salvage) and a common assumption set, combined with their FPI answers produce four identical sets of financial statements (an identical set of financial statements for each investment question category). Upcoming Exhibits illustrate how identical financial statements are a distinguishing FPI attribute and help highlights FPI's investment structure synchronicity surrounding investment questions.

A traditional tool's answer for simple investment questions can also produce financial statements. However, once investment question properties start to exhibit real-world characteristics the traditional tools ability to easily generate financial statements goes to the wayside. Converting a non-simple traditional tool investment question and answer into financial statements requires additional assumptions. These additional financial statement assumptions are not related to the investment question and at a minimum detract from the original task of answering the investment question. In addition, absent an overarching investment methodology the traditional tool's financial statements are not identical for the four investment question categories.

Compiling an investment question's financial statements using an FPI answer requires only assumptions germane to the investment question. The basic financial statements are Balance Sheet, Income Statement, Change in Cash and Owner's Equity. They are interconnected and interrelated. The first three give rise to the fourth—Owner's Equity. An Owner's Equity statement is where an investment question and answer are interfaced with the investment question's owner.

The owner's equity statement is a summary of the other financial statements flowing in to it. A period over period change in balance sheets comprises a financial statement's change in cash. A change in cash statement focusing on an owner's equity change in cash and an income statement's net income comprise an owner's equity statement activity.

Resident in owner's equity statements is means to calculate Return on Equity (ROE). Like IRR, ROE is a desired comparative measure and utilizes internal investment question facts. Unlike an all-encompassing IRR rate, ROE and the owner equity statement represents a single component flow to and from the investment question's owner. The owner's equity statement has distilled out all other investment question's component flows. There is a direct unencumbered relationship between the owner's equity statement and the investment question owner. An investment question is only answered when a FPI answer encompasses an equity return profile (IER) the question's owner agrees is commensurate with the investment question's business risk.

As a snap shot, ROE communicates a result bestowed on outstanding owner's investment for a single period. Traditional ROE calculations entail a single net income amount divided by the corresponding outstanding equity. Obviously, a single ROE does not communicate an investment question's quality measure spanning several periods. Each individual period's traditional ROE is either above or below the question's true comparative essence. ROE's scattered fractional focus is a significant shortcoming.

What is needed is a multiple period equity return capturing an entire investment question's given life time. A suitable multiple period ROE would define an investment question's internal equity return (IER). How would an investment question's multiple period ROE be defined? Would such a calculation entail a return rate to bring an owner equity statement's multiple net incomes and outstanding equities to single point-in-time amounts? Would a multiple period ROE calculation then have the resulting cumulative singular net income divided by the cumulative singular outstanding equity also equal the same rate used to produce the singular net income and outstanding equity? This seems both logical and unconventional at the same time.

Conventional ROE is single dimensional. Collapsing multiple periods into one to define a multiple period ROE expands the traditional ROE's usual single dimension to two. The second dimension's purpose is to bring multiple incomes and equities back to singular numbers for a ROE calculation. However, to validate a second ROE dimension the traditional ROE mechanics must produce the same rate used to produce the singular amounts. If accomplished, the second dimension's introduction effectively neutralizes the multiple period investment question's time value aspect. The result is a multiple period ROE. IER's nature as a multiple period ROE satisfies both investment questions and owner's equity statement comparative measures.

To add further clarity to FPI's methodology it would be helpful to take Table 3's flow components and further expand and identify flows between income and balance sheet items. See Table 5. Equity, debt, combined equity and debt and a user-defined rate are the four FPI rates. Table 5 also shows the appropriate FPI rate relative to each component. Both income and balance sheet secondary flow components receive a user-defined rate.

When an investment question's capital financing contemplates an equity and debt mixture assigning IRR and NPV's single return rate to both income and balance sheet items is very problematic. For example, only an investment question's initial cost and sale price book value (Table 5, Items 2 & 4) are supported by combined equity and debt. IRR and NPV correctly use their combined equity and debt rate for Table 5's, Items 2 & 4. However, when IRR and NPV discount any other flow components with their equity and debt mixture it produces erroneous results.

TABLE 5
Investment Question Components:
Table 2 Revisited

| | Financial | |
|---|---|---|
| | Statement | FPI Rate |
| Primary Flow: | | |
| 1. Equity | Balance Sheet | IER |
| 2. Asset - Initial Cost | Balance Sheet | Combined |
| | | IER & Debt |
| 3. Pre Asset Operating | Income | IER |
| Performance | | |
| 4. Sale Price Book Value | Balance Sheet | Combined |
| | | IER & Debt |
| 5. Sale Price Gain (Loss) | Income | IER |
| 6. Debt (if any) | Balance Sheet | Debt |
| Secondary Flow: | | |
| 7. Return Earned | Income | User-defined |
| 8. Account Balance | Balance Sheet | User-defined |

Net income's operating performance is an example when traditional tools are erroneous. Table 5, Item 3 uses a ‘pre asset’ operating performance—an operating performance prior to any asset influences. An investment question's pre asset operating performance is a precursor to net income and the owner's equity statement. Pre asset operating performance's aspect is absent any debt influence. As such, pre asset operating performance is in the owner equity's sole domain. There is no debt supporting pre asset operating performance. Debt is solely used to support the asset. Therefore, pre asset operating performance should only be discounted using IER, not IRR and NPV's combined debt and equity rate.

IRR and NPV's combined debt and equity rate on varying pre asset operating performance is the main explanation for Table 4's 20% vs. 58% equity difference. Table 4 is further discussed later and illustrated in Exhibit 2A, FIG. 7.

Obviously, IRR and NPV cannot distinguish between income and balance sheet items. Nor do they have separate equity and debt return rates to apply to them. Simple IRR and NPV mechanics assign their singular individual rate to all flows—primary and secondary, income statement and balance sheet items alike.

FPI's methodology is developed to address IRR and NPV's shortcomings. It incorporates some desirable IRR and NPV traits. One of FPI's strengths is similar to one of IRR's strengths. IRR's deduced rate is derived from facts specific to the investment question being evaluated. FPI's internal equity return (IER) also comes from or applies to facts specific to the investment question being evaluated. Like IRR, the ‘internal’ designation in the internal equity return depicts sources from within the given investment question's facts.

One of FPI's strength is also similar to one of NPV's strengths. NPV's strength is flexibility from using a user-defined return rate (although, NPV's rate is applied to all component flows). Similarly, FPI assigns a user designated rate to the secondary flow—but only the secondary flow.

Investment questions deal with owner's equity in-flow and out-flow over a given time-period. FPI answers investment questions through applying straightforward present value and annuity calculations to the question's various flows—utilizing the appropriate rate. Present value and annuity calculations results in a superior FPI answer to IRR and NPV. FPI's ability to replace IRR and NPV manifests itself when a real-world investment question and FPI answer are combined to create affirming financial statements—The Full Picture. The owner's equity financial statement demonstrates FPI's focal point as IER. FPI's methodology through IER gives business professionals comfort FPI should replace existing IRR and NPV tools for making an investment question's evaluation.

FPI states answers to investment questions can be measured as to, or be derived there in, by a return accruing to the question's owner or as an initial cost at a point-in-time or as operating performance over the question's time frame. Stated another way, every investment question contains three minimum components: return, initial cost and operating performance. Return, initial cost and operating performance are an investment question's special component subset. They are collectively referred to as an investment question's basic elements. Time is a distinguishing factor between the three.
Return is operating performance divided by initial cost's asset, relevant to any time frame.
Initial cost is operating performance divided by return, static to a point-in-time.
Operating performance is initial cost times return, spanning a given time frame.

The investment structure entails relationships between basic elements. Like a triangle when two angles are known, FPI solves for an investment question's third basic element after two are given. See Table 6's Investment Question Summary.

TABLE 6
INVESTMENT QUESTION SUMMARY:
Basic Elements Relationships

| | Question Category | | |
|---|---|---|---|
| | A | B | C |
| Given | Operating | Operating | Initial Cost |
| | Performance | Performance | times |
| | divided by | divided by | Return |
| | Initial Cost | Return | |
| Answer | Return | Initial Cost | Operating |
| | | | Performance |

Each question category (A, B, & C) takes a turn at being the element solved. The other two elements are assumptions imbedded in the investment question. The investment question's analysis determines the appropriate investment question category—a specific component to be solved for as a FPI answer. An investment question's category directs business professionals to a structured process for making investment decisions.

The previously mentioned Sale Price, Salvage or Disposal (investment question category D) is not a basic element but rather a special investment question component. Business professionals can be keenly interested in an investment question's Sale Price, Salvage or Disposal cost. Sale Price, Salvage or Disposal all sit at a point-in-time at operating performance's end. For now, the discussion focus is on the three basic elements. Sale Price Salvage Disposal's fourth investment question category D is discussed in Exhibit 2's Chapter 6.

Table 6 demonstrates basic investment structure solve/assumption synchronicity necessary to appropriately answer investment questions. However, Table 6's depicted relationships require an operating performance and return adjustment and a time frame injection to transcend the investment structure's relationships into practical application.

Operating performance needs to be refined to be an amount void of influences produced by initial cost's asset. Pre asset operating performance is used to describe operating performance prior to any of initial cost's impact on operating performance—without return ‘of’ capital (depreciation), interest expense, property taxes, salvage, secondary flow or any other related impacts from the investment question's asset. Initial cost's asset related operating performance impacts need to be handled through the return element, outside of operating performance.

Removing return ‘of’ capital (depreciation) from operating performance necessitates combining it with return's already existing return ‘on’ capital. In addition, the newly combined return ‘on’ and return ‘of’ needs a pre asset operating performance time frame duration. These adjustments to return's basic comparative measure require an intermediary step between the investment question and IER. The intermediary step is called the Full Picture Factor (FPF).

Table 7's standard annuity formula represents the initial full picture factor. At Table 7's basic level, return's full picture factor incorporates an investment question's return ‘on’ capital, return ‘of’ capital and time frame duration.

Full Picture Factor=i*(1+*i)^{nper}/((1+i)^{nper}−1) FULL PICTURE FACTOR: Table 7

Where ‘i’ equals IER and ‘riper’ equals an operating performance time frame—expressed as a number of periods. An electronic spreadsheet's PMT( )) function with a $1 present value can also be used to produce the full picture factor.

TABLE 8
INVESTMENT QUESTION SUMMARY:
Basic Elements Relationships
Table 6 Revisited

| | Question Category | | |
|---|---|---|---|
| | A | B | C |
| Given | Pre Asset | Pre Asset | Initial Cost |
| | Operating | Operating | times |
| | Performance | Performance | Full Picture |
| | divided by | divided by | Factor |
| | Initial Cost | Full Picture | |
| | | Factor | |
| Answer | Full Picture | Initial Cost | Pre Asset |
| | Factor | | Operating |
| | deduced to the | | Performance |
| | IER | | |

Table 6's relationships still hold true with adjustments to operating performance and return. The full picture factor combines IER (return ‘on’), return ‘of’ capital and time frame periods; initial cost's original definition remains unchanged; operating performance is changed to pre asset operating performance. Table 8 reflects these updates to Table 6.

Table 8, question category A's IER answer cannot be directly solved from the full picture factor. Table 7's polynomial formulaic structure requires category A answers to be deduced using an iteratively based process. Investment question categories B, C and later Sale Price category D answers are direct algebraic solutions and do not require an iteratively based process to solve. Salvage Disposal category D investment questions are iteratively solved similar to IER category A.

Although currently still simple, FPI's investment structure synchronicity, Table 8, can be demonstrated in exhibits using examples. Because the initial examples contain level non-varying operating performance, IER equity only external financing and IER for secondary flow return, the traditional tools and FPI have identical investment question answers. The FPI and the traditional tools answers diverge with more realistic assumptions starting in Exhibit 2. For now, it is important to show similarities between the traditional tools and FPI's methodology.

### Examples and Exhibits:

If there is a machine with five $669 pre asset operating performance each year and a $2,000 initial cost what would be the resulting IER? Answer: 20% (Table 8, question category A). The $669 pre asset operating performance divided by $2,000 initial cost equals a 0.33438 full picture factor. A 0.33438 full picture factor and five periods are equal to a 20% IER. The 20% can be found in the iteratively deduced RATE(5, −0.33438, 1) spreadsheet function.

Similarly, if there is a machine with a five-year life generating an $669 pre asset operating performance each year and required a 20% IER (0.33438 full picture factor) what should be the machine's initial cost? Answer: $2,000 (Table 8, question category B). The $669 pre asset operating performance divided by a 0.33438 full picture factor equals $2,000 initial cost. The 0.33438 full picture factor is equal to the full picture factor Table 7 formula of: 0.2*(1+0.2)5/((1+0.2)5−1) or the PMT(0.2, 5, 1) function.

Finally, if there is a machine with a five-year life with a $2,000 initial cost and a required 20% IER (0.33438 full picture factor) what would be the required pre asset operating performance each year? Answer: $669 (Table 8, question category C). The $2,000 initial cost times the 0.33438 full picture factor equals a $669 pre asset operating performance.

The three examples above are depicted in the accompanying Exhibits 1A, 1B and 1C. The three exhibit's financial statements are identical and are replicated once as Exhibit 1 AB&C. The four exhibits are collectively referred to as Exhibit 1. Exhibit 1 portrays the investment question categories described in Table 8. IER is the item solved in Exhibit A, initial cost is the item solved in Exhibit B and pre asset operating performance is the solved unknown in Exhibit C.

This discussion contains six Exhibits (1-6). Exhibit 2 and 3 build from Exhibit 1. Exhibits 2 and 3 introduce real-world investment aspects to Exhibit 1's base investment question. Exhibits 4 and 5 introduce the ability to create an investment question timeframe different than the asset's lifetime footprint. Exhibit 6 allows varying financing rates during the course of the investment question.

The first five Exhibits are sub divided into four individual sections. The following bullet points describe how Exhibits are constructed with each organizing section and how to utilize various reference and navigational aids:
The first five exhibits each contains sections I, II, III & IV.
An Exhibit's first section is titled FULL PICTURE INVESTMENT (I) and represents the =FPI( )) spreadsheet function and assumptions. Everything necessary to make a FPI calculation is contained in the first section.
The second section is titled FULL PICTURE FINANCIAL STATEMENTS (II) and contains the Exhibit's related financial statements. The second section's financial statements are driven by the first section FPI answer and assumptions. Supporting schedules to the basic financial statements are included to show further detail. Rather than duplicate a set of financial statements for each investment category, one set of financials is provided at the end of Exhibit 1, 2, 3 and 4's individual categories.
For Exhibits 2, 3, 4 and 5 a trial balance and closing entries are included at the second section's end. Beginning balances are brought forward with operating, depreciation and tax entries. Entries to close assets, liabilities, net income to owner's equity and a closing dividend disbursement are shown.
The third section is a visual FPI calculation representation titled VISUALIZE FPI (III). Section three shows Table 8 relationships between IER, initial cost and pre asset operating performance. For Exhibits 2, 3, 4 and 5 the third section explicitly shows the necessary FPI adjustments (bridges) to maintain FPI's investment structure synchronicity. Exhibit's 6 varying financing assumptions introduces logic complexity which prohibit easily visualizing FPI adjustments in a similar manner to Exhibits 2, 3, 4 and 5. Exhibit 6 does not contain a third section.
FPI vs. Traditional Tool Reconciliation (IV) is the fourth Exhibit section. Exhibits 2, 3, 4 and 5's fourth section depicts reconciliation between FPI and the traditional tool answers (Exhibit A—IER vs. IRR; Exhibit B—Initial Cost vs. Purchase Price (NPV); Exhibit C—Pre Asset Operating Performance vs. PMT Annuity; and Exhibit D—Asset Sale Price vs. Future Value). Exhibits, 1A, 1B and 1C (Traditional Tools) have no differences between FPI and the traditional tools and thus no reconciliations. The fourth section format does not accommodate Exhibits 6B's varying financing rates. Exhibit 6 does not contain a fourth section.
Topics are covered and built sequentially on a cumulative basis. Generally, subsequent Chapters do not go back into the same detail of previously covered topics.

### Transactional and Navigational Aids:

All transactions depicted within FPI are deemed to occur at the period's end. Likewise, beginning balances are held constant until the period's end.
In each Exhibit, each line is consecutively numbered beginning with the first through the Exhibit's last section. Line numbers and line number references are distinguished by encasement in [ ] brackets.
Each number in an Exhibit is unique to a single line. Each number is horizontally associated to the line number down the Exhibit's left side. Multiple related numbers on the same line are differentiated horizontally by periods indicated elsewhere on the page, unless otherwise marked.
A number's reference displays corresponding line numbers, operators and functions to trace individual items used in calculating the number in question.
Those cells referencing their own line number are referencing their most recent calculation moving from left to right. Initial values are either zero or one.
The Exhibit's spreadsheet framework style incorporates stair-casing calculations in a top/left-to-right/bottom manner. Calculations progress downward in a singular columnar fashion. A single underline is meant to signal a pause for an intermediate calculation in the adjacent column. Double underlines signal the calculation's end.
All exhibits are depicted in five year periods for illustrative purposes. When implementing FPI for real-world decision purposes, investment questions should be calculated in a time basis to create period counts in excess of five.

Chapter 5, Exhibit 1's overly simple nature causes a lack of difference between FPI and the traditional tools. Exhibit 1 illustrates initial fundamental similarities between FPI and the traditional tools. Divergence between FPI and the traditional tools starts in Chapter 6, Exhibit 2 (Exhibits 2A, 2B, 2C and 2D) and continues in Chapter 9, Exhibit 3 (Exhibits 3A, 3B, 3C and 3D), and Chapter 10, Exhibit 4 (Exhibits 4A, 4B, 4C and 4D), and Chapter 11, Exhibit 5D and Chapter 12, Exhibit 6B. FPI's methodology diverges from the traditional tools when addressing and resolving real world investment questions.

### Exhibit 1, FULL PICTURE FINANCIAL STATEMENTS (II), Second Section:

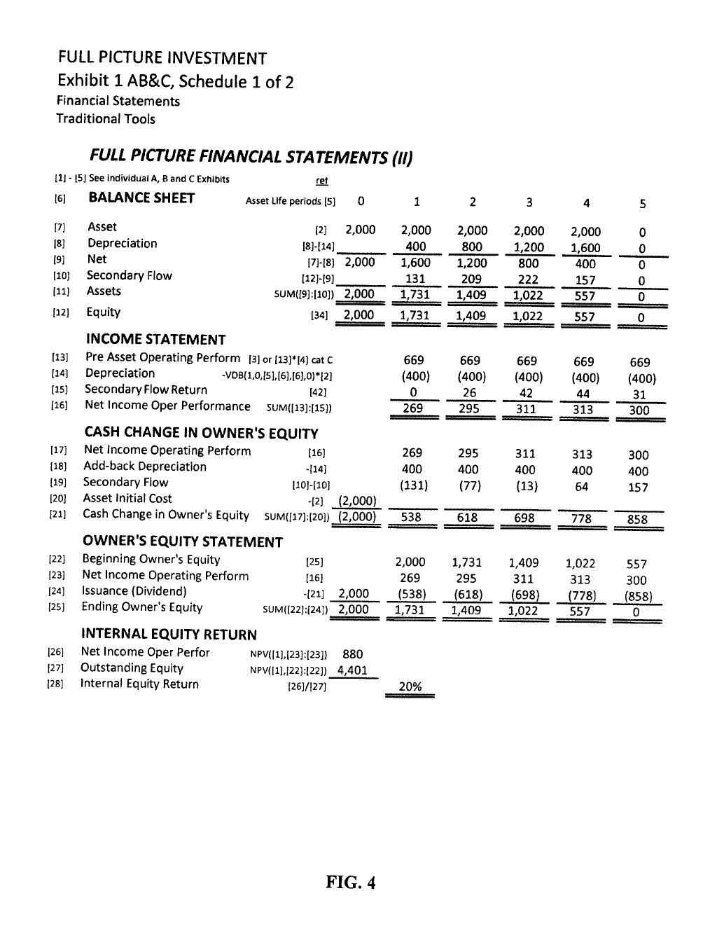

Exhibit 1's second section FULL PICTURE FINANCIAL STATEMENTS are identical for all three categories (1A, 1B and 1C). Exhibit 1's single copy of the financial statements begin on FIG. 4. The balance sheet Line [7] starts with initial cost from Line [2]'s individual investment categories. Net asset is the asset less accumulated depreciation for each period, Line [9]. Secondary Flow on Line [10] balances the investment question with the outside world. The net asset and secondary flow accounts form total assets. The owner's equity financing Line [12] provides the balance sheet's asset counter-balancing properties with no debt or other liabilities in Exhibit 1.

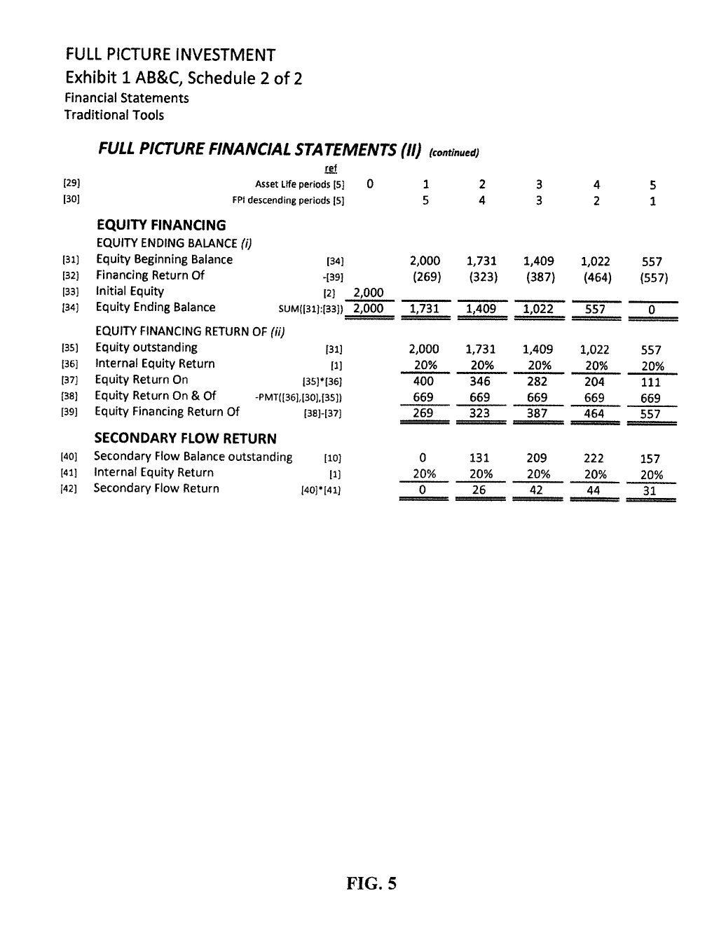

The equity financing detail is found in two pieces starting on FIG. 5, Schedule 2, Line [31] EQUITY ENDING BALANCE (i) and continuing on Line [35], EQUITY FINANCING RETURN OF (ii). Financing Return ‘Of’, Line [32] is subtracted from the beginning equity balance to form equity's ending balance.

Equity financing's equity return ‘of’ of calculation starts on Line [35]. Equity outstanding is multiplied by IER to create Equity Return ‘On’, Line [37]. The combined Equity Return ‘On’ & ‘Of’, Line [38] is calculated by taking the full picture factor times equity outstanding. Taking equity return ‘on’ and ‘of’ less equity's return ‘on’ leaves equity return ‘of’, Line [39].

The income statement, FIG. 4, Line [13] starts with an investment question's pre asset operating performance. Depreciation is recognized in a one-fifth straight-line fashion on Line [14]. Depreciation's calculation utilizes the variable declining balance function =VDB( ) In Exhibit 1 the secondary flow account earns IER on the secondary flow outstanding balance on Line [15]. Secondary flow calculation detail is on Lines [40] through [42]. Pre asset operating performance, depreciation, and investment return create Net income Operating Performance on Line [16].

The financial statement Cash Change in Owner's Equity statement melds components from the balance sheet and income statement. The income statement's net income and depreciation, Lines [17] and [18] and the balance sheet's change in secondary flow, Line [19] and initial cost, Line [20] comprise the cash change in owner's equity on Line [21]. Line [21] becomes the cash flow Issuance (Dividend) line in the owner's equity statement on Line [24].

FIG. 4, Lines [22] through [25] contain the owner's equity statement from other financial statements flowing into it. Line [24], period zero, shows the owner's $2,000 equity issuance to recognize the example's machine at period zero. For the next five periods net income operating performance from Line [16] and dividends from Line [21] flow into the owner's equity statement. The equity balance is brought to zero at period five.

Line [28]'s 20% Internal Equity Return (IER as the multiple period ROE) is calculated using Lines [26] and [27]. Multiple incomes, Line [23] and outstanding equity, Line [22] amounts are discounted to single numbers using IER. Line [28]'s 20% IER also matches IER number on Line [1] used for discounting. A return rate equaling the traditional ROE mechanics indicates a valid multiple period ROE and FPI solve/assumption synchronicity for Exhibits 1A, 1B and 1C.

No assumptions other than Exhibit 1's two basic element assumptions are needed to complete the financial statements. The completed owner's equity financial statement acts as the interface to the investment question's owner. The owner's equity statement accredits the investment question's FPI answer to the investment question's owner.

How does FPI create affirming financial statements? Through the full picture factor, the methodology elicits a systematic external financing extinguishment. The systematic external financing extinguishment is used to turn a FPI answered investment question into financial statements.

Exhibit 1A, 1B and 1C, balance sheet, Line [12] and owner's equity statement, Lines [25] and [34] ending equity balances decline ratably in a standard annuity fashion beginning with period one and continuing through period five. Table 9 is a standard annuity amortization schedule for a $2,000 principal amount for 5 periods at 20%. The Remaining Principal balance in Table 9, Column (a), matches Exhibit 1's, Lines [12], [34] and [25] owner's equity balance. The full picture factor aspect is embodied in all FPI calculations and is the first step necessary to transform an investment question and FPI answer into affirming financial statements.

The other step to create financial statements is any differences between external financing extinguishment and other financial statement areas are absorbed in the balance sheet's secondary flow account FIG. 4, Line [10]. Each period's secondary flow balance is the difference between the period's owner's equity, Line [12] and net asset, Line [9]. As previously mentioned, the subsequent secondary flow operating performance IER earning impact is captured in the income statement, Line [15], detailed in Lines [40] through [42].

TABLE 9
ANNUITY AMORTIZATION SCHEDULE
EXHIBIT 1

| | (a) = | (b) = | | |
|---|---|---|---|---|
| | (a) − (b) | (d) − (c) | (c) = | (d) = |
| | Remaining | Principal | (a) * 20% | PMT(0.2,5,2000) |
| Period | Principal | Reduction | Interest | Annuity |
| 0 | $2,000 | | | |
| 1 | 1,731 | $269 | $400 | $669 |
| 2 | 1,409 | 323 | 346 | 669 |
| 3 | 1,022 | 387 | 282 | 669 |
| 4 | 557 | 464 | 204 | 669 |
| 5 | 0 | 557 | 111 | 669 |

### Exhibit 1, VISUALIZE FULL PICTURE INVESTMENT (III), Third Section:

Each third section VISUALIZE FULL PICTURE INVESTMENT patterns itself after Table 8 and the relationships between IER, initial cost, pre asset operating performance and the full picture factor.

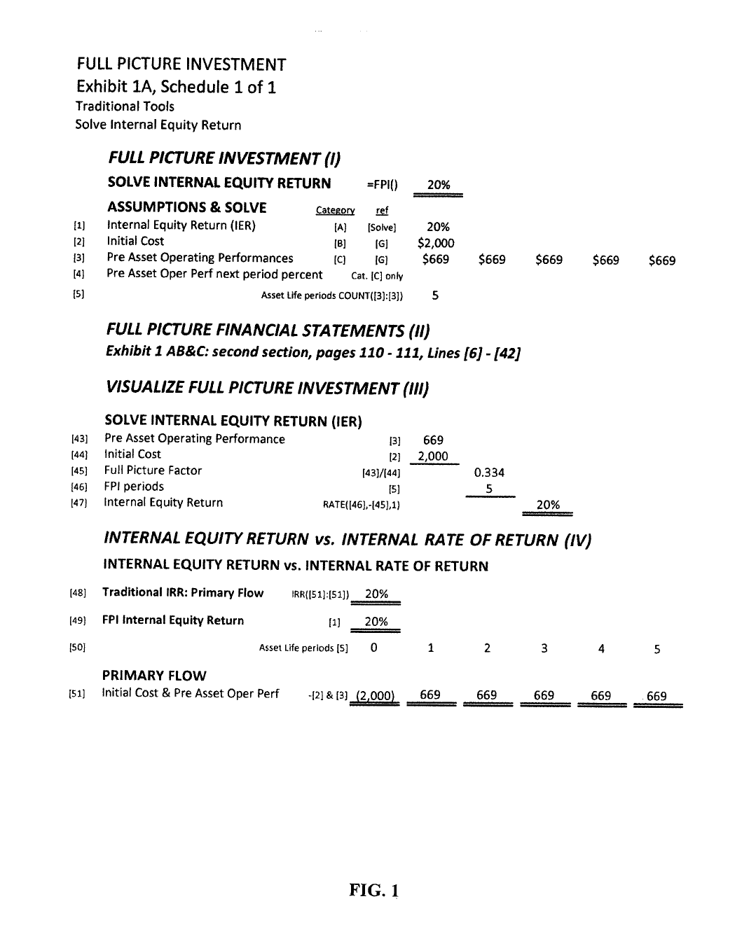

Exhibit 1A's, FIG. 1, VISUALIZE FULL PICTURE INVESTMENT, Lines [43] through [47] shows dividing pre asset operating performance by initial cost equals the full picture factor. The full picture factor combined with the five period time frame is used to deduce IER, Line [47].

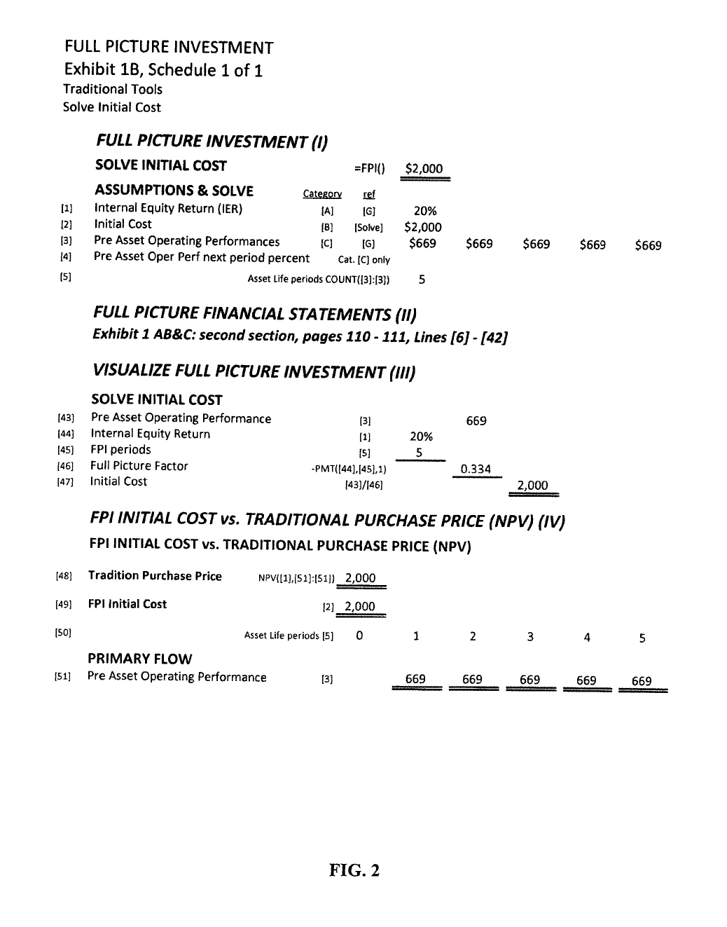

Exhibit 1B's, FIG. 2, VISUALIZE FULL PICTURE INVESTMENT shows dividing pre asset operating performance by the full picture factor equals initial cost, Lines [43] through [47].

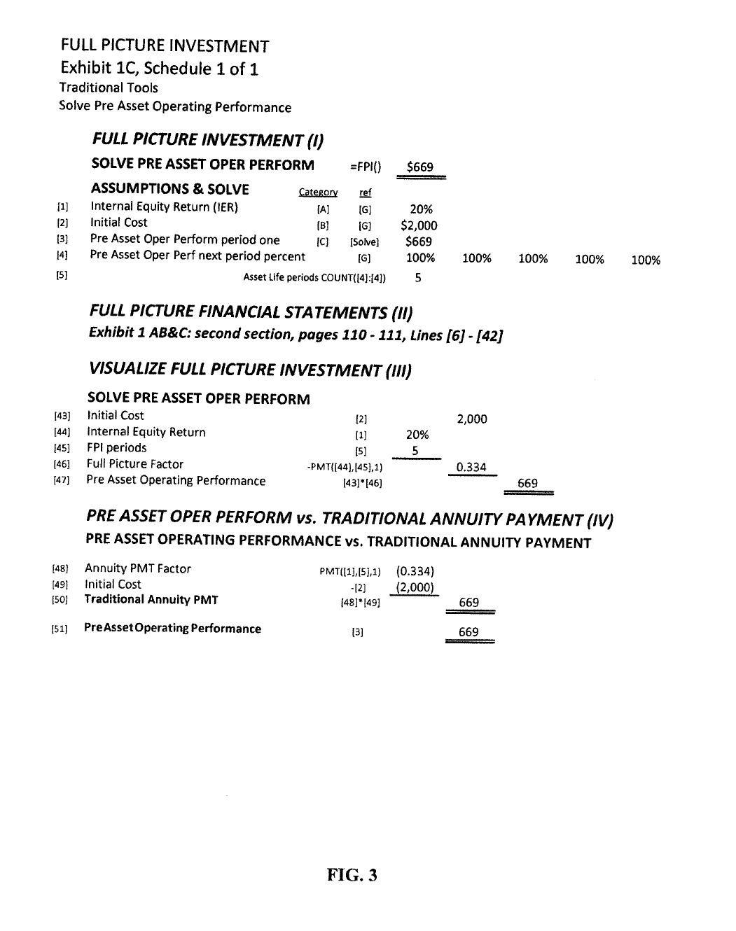

Exhibit 1C's, FIG. 3, VISUALIZE FULL PICTURE INVESTMENT shows multiplying initial cost by the full picture factor equals the pre asset operating performance, Lines [43] through [47].

Exhibit 1, FULL PICTURE INVESTMENT vs. TRADITIONAL TOOLS (IV), Fourth Section:

Exhibit 1's fourth section compares FPI answers to traditional tool answers. Traditional tools always use an investment question's primary flow in their calculations. Even as investment questions get more sophisticated beyond Exhibit 1, traditional tools use only an investment questions stated primary flows. Traditional tools do not contemplate secondary flow's existence.

Exhibit 1A's, FIG. 1, Line [48] FPI INTERNAL EQUITY RETURN vs. INTERNAL RATE OF RETURN shows the traditional IRR(−2000, 669, 669, 669, 669, 669) calculation equals 20%. This equals FPI's IER 20%, Line [1].

Exhibit 1B's, FIG. 2, Line [48] FPI INITIAL COST vs. TRADITIONAL PURCHASE PRICE (NPV) shows the traditional NPV(0.2, 669 669 669 669 669) calculation equals $2,000. This equals FPI's initial cost Line [2].

Exhibit 1C's, FIG. 3, Line [48] FPI PRE ASSET OPERATING PERFORMANCE vs. ANNUITY PMT PAYMENT shows the traditional PMT(0.2, 5, 1) calculation times initial cost equals $669. The $669 also matches FPI's non-varying operating performance, Line [3].

Solve/assumption synchronicity is demonstrated for both FPI and the traditional tools in the three Exhibit 1's fourth (IV) sections. The three investment questions assumptions and answers are interchangeable amongst the investment question categories.

Exhibit 1's non-varying operating performance, equity only external financing and IER for secondary flows are simple investment question components. Simple investment questions allow investment question components to receive the same 20% for both FPI and the traditional tools. Investment question's components receiving the same rate compels no differences between FPI and the traditional tools.

As stated previously, initial Exhibit 1 simple examples are used to demonstrate similar fundamental workings between FPI and traditional tools. FPI takes the initial fundamental similarity and builds upon it while maintaining FPI's investment structure integrity and solve/assumption synchronicity in Exhibits 2, 3, 4, 5 and 6.

The discussion now focuses on assumption introductions to take FPI calculations to where they can answer real world investment questions. Exhibits 2 and 3 represents increases in assumptions and sophistication toward a real world application. In Exhibit 2 and 3, FPI assigns appropriate rates to differing investment question components.

It is important to point out how FPI's secondary flow account balance, FIG. 4, Line [10] and owner's equity financing balance, Line [12] automatically balance themselves to zero at period five. The auto balancing is achieved with only the first (I) section's FPI assumptions. Financial statement auto balancing to zero for these two items, [10] & [12] is accomplished through FPI's methodology and is visualized through steps described earlier: systematic external financing extinguishment and secondary flow account activity and return.

What also becomes evident in Exhibit 1 is the traditional tools have always been inherently using systematic external financing extinguishment, secondary flow activity and secondary flow equity return for simple investment questions. Recognizing the traditional tool's systematic external financing extinguishment, secondary flow activity and secondary flow return began the first step to unfold FPI's methodology.

Exhibit 2 and 3 with real world investment assumptions will show auto-balancing financial statements remain a trait imbedded within FPI's methodology. That is not the case for the traditional tools.

### Depreciating Asset

Exhibit 2's discussion introduces new investment question assumptions. Exhibit 2 builds upon Exhibit 1's initial framework. The following is Exhibit 2's additional assumption list:

Varying pre asset operating performance levels

Asset Salvage (Disposal)

Debt financing

Income tax (structure)

Pretax capital cost

A user-defined secondary flow rate

Asset O&M and Property Tax

Depreciable Asset Option Switch

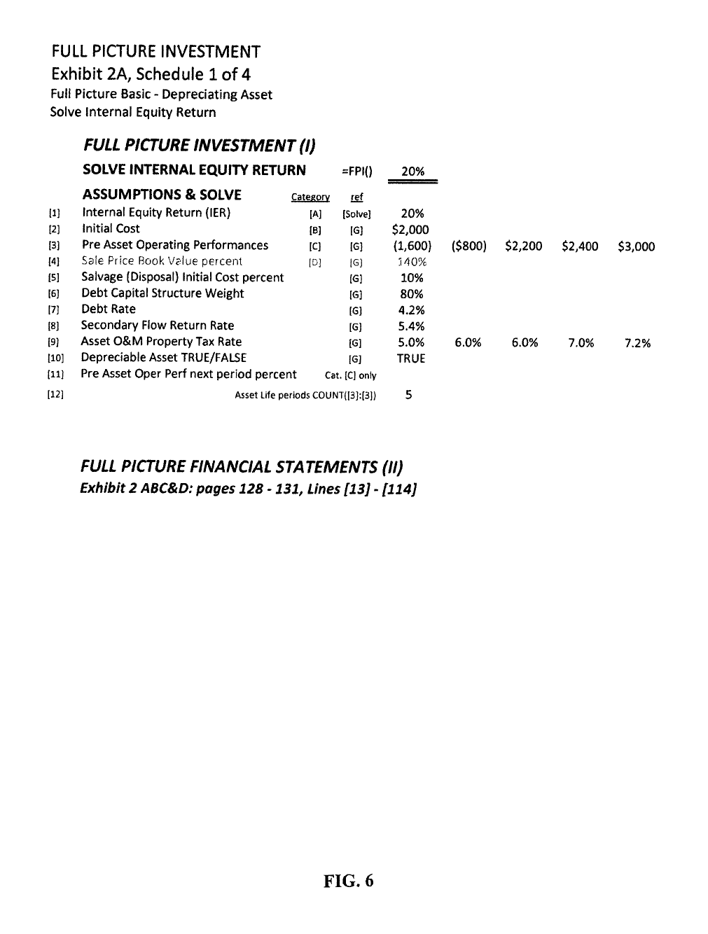

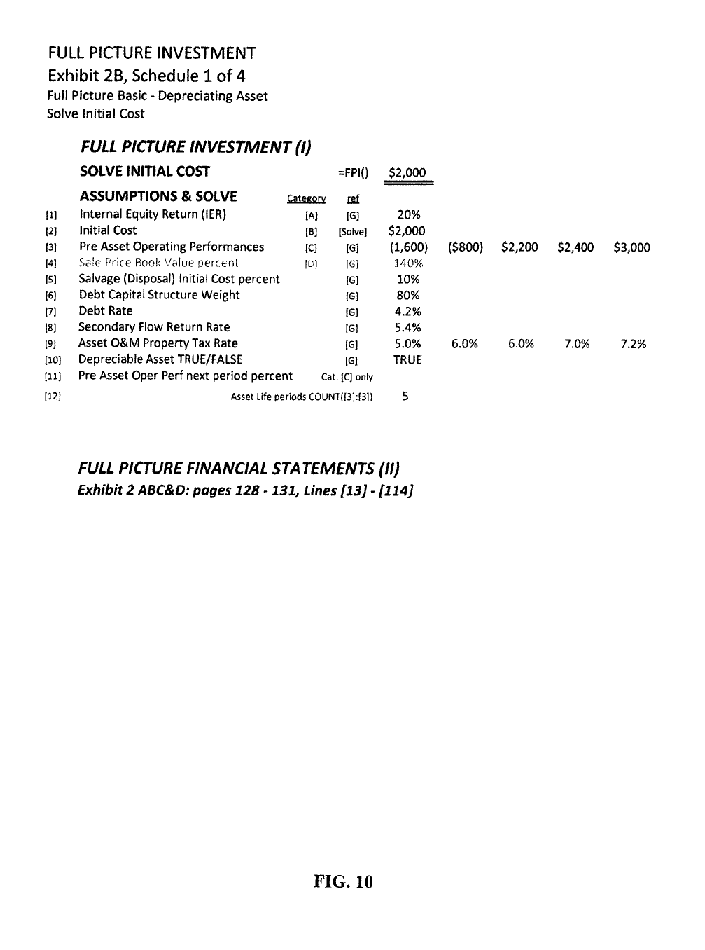

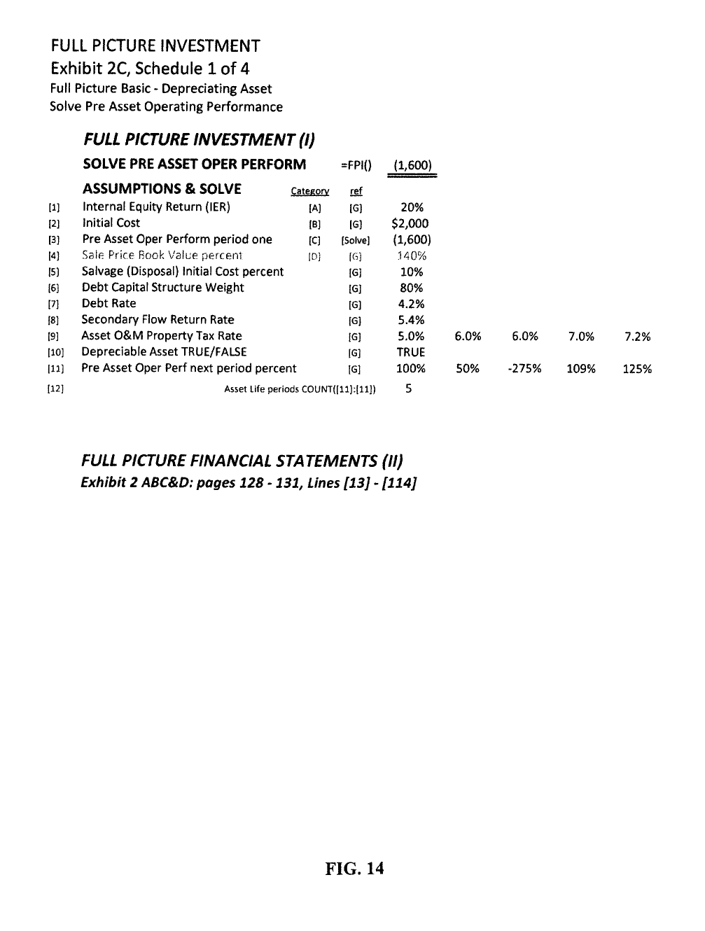

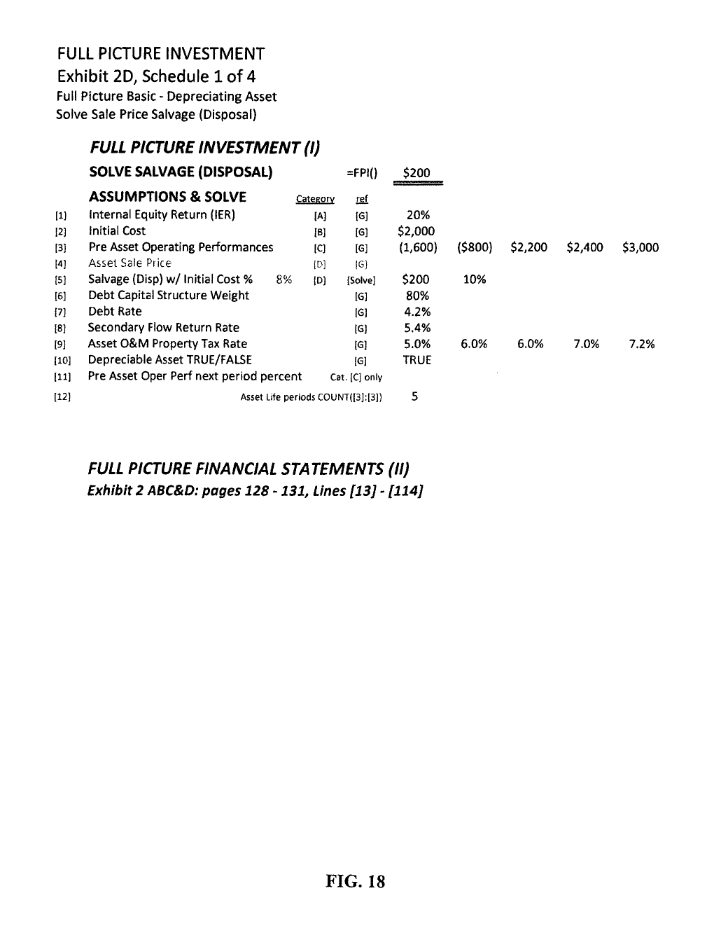

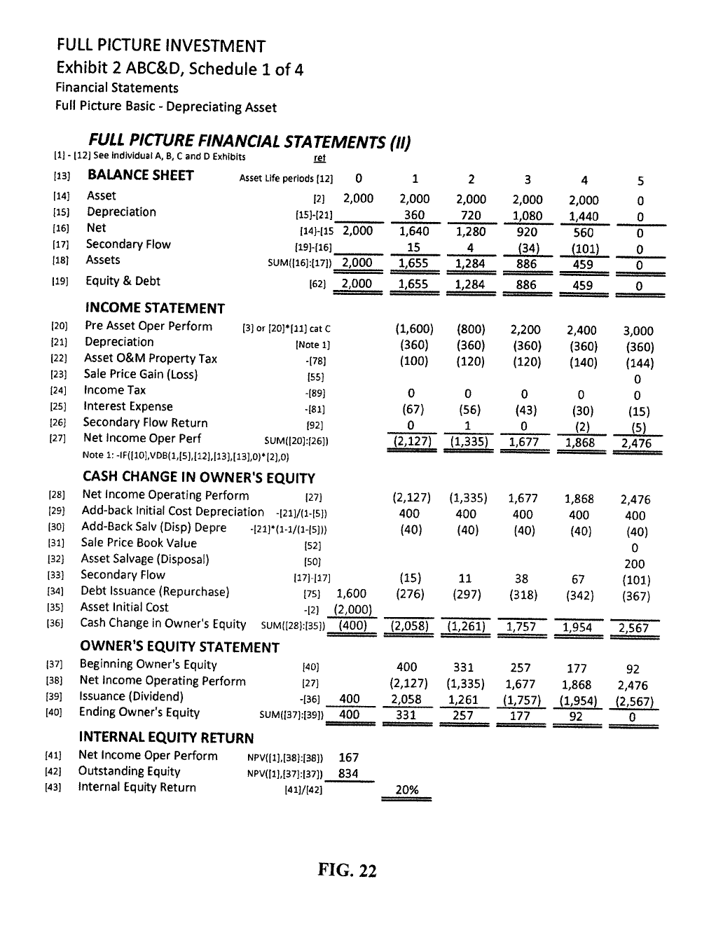

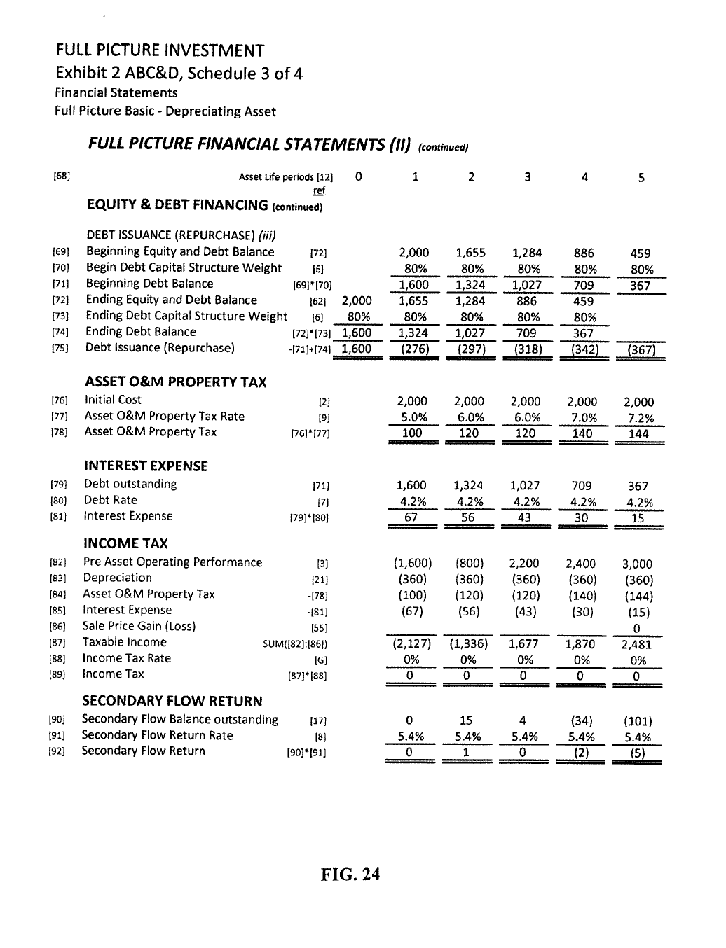

Exhibit 2A is found on FIG. 6, 2B on FIG. 10, 2C on FIGS. 14 and 2D on FIG. 18. The single set of Exhibit 2 ABC&D financial statements is found on FIGS. 22-25, Lines [13]-[114], collectively Exhibit 2. Exhibit 2 focuses on a depreciating asset like the one in Exhibit 1.

Exhibit 3 will focus on the same new assumptions as Exhibit 2 but also differ from Exhibit 2 by using a non depreciating asset and its sale at the end of the investment question.

Varying period-to-period pre asset operating performance is more typical than level amounts in Exhibit 1. In addition, many entities use debt financing to leverage their equity investment and extend their business's reach. Income and property tax are an all too familiar a constant with for-profit organizations. The user-defined secondary flow rate solves a traditional tool shortcoming. Asset salvage or disposal cost is often a pertinent investment issue for a depreciating asset.

Injecting these new Exhibit 2 items into an investment question becomes very problematic for the traditional tool's single return rate. The new Exhibit 2 assumptions increases Exhibit 1's single IER discount rate to four discount rates. In addition to Exhibit 1's IER rate, there is the newly introduced debt, a user-defined secondary flow rate and a fourth conveniently combined equity, debt and income tax rate called pretax capital cost.

Pretax capital cost is created with IER, debt weight, debt rate, interest tax deductibility and income tax rate. Pretax capital cost recognizes equity return is not deductible for income taxes. Therefore, weighted equity return is grossed up for income taxes by dividing it by one minus the tax rate. Recent national discussion concerning interest expense tax deductibility has created a need to place interest tax deductibility as a variable assumption. In Exhibit 2, all other income statement items within the investment question are assumed to be tax deductible and do not require being grossed up for taxes.

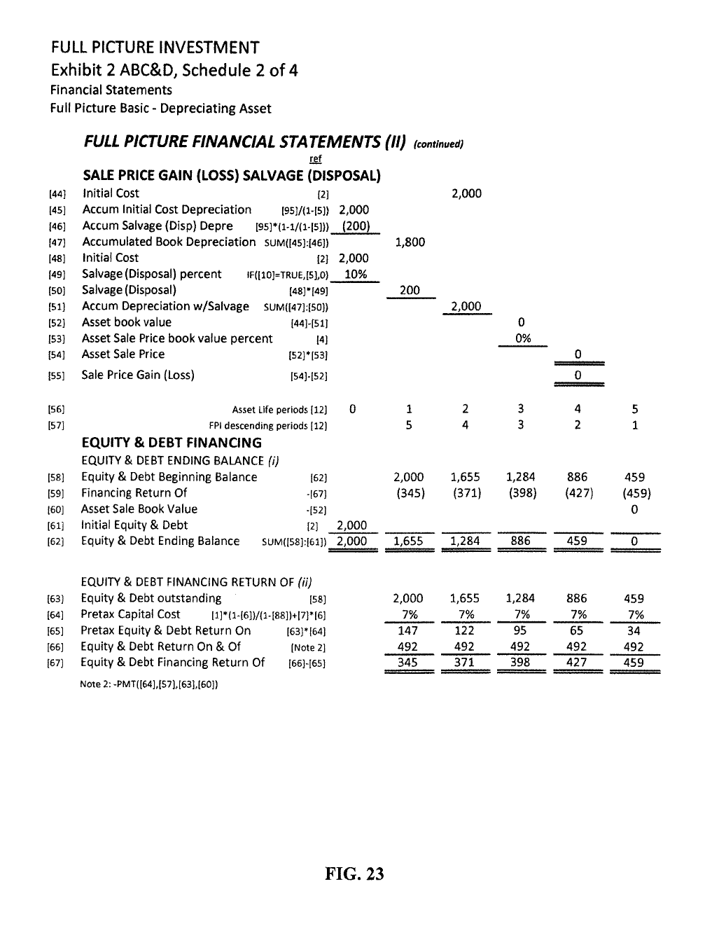

Combining pretax weighted equity and weighted debt creates a 7%¹ pretax capital cost. See Exhibit 2 ABC&D, FIG. 23, Line [64], for the specific pretax capital cost calculation. Table 5's FPI Rate ‘Combined IER & Debt’ designation will be further referred to as pretax capital cost. ¹ The actual number is 7.36. 7% is used for ease of readability

For basic FPI in Exhibits 2 and 3 the income tax rate is set to zero. The income tax structure is presented in Exhibits 2 and 3 to show its potential application.

Going forward, pretax capital cost becomes the input driving the full picture factor in the FPI calculations and the external financing extinguishment in the financial statements. For the traditional tools pretax capital cost is their singular rate.

The new items introduced in Exhibit 2 moves answering investment questions towards a framework for depicting more realistic investment questions. Exhibit 2 starts the distinction between the traditional tools and FPI. In Exhibit 2, the FPI vs. traditional tool differentiation is FPI's ability to use four return rates on appropriate component flows as outlined in Table 5.

### Exhibit 2, FULL PICTURE INVESTMENT (I), First Section:

For Exhibit 2, Exhibit 1's pre asset operating performance goes from a flat $669 for five periods to ($1,600) period one, ($800) period two, $2,200 period three, $2,400 period four and $3,000 period five Exhibit 2A, Exhibit 2B and Exhibit 2D, Line [3], FIGS. 6, 10 and 18 respectively. Exhibit 2's IER remains at Exhibit 1's 20%, Line [1] and Initial Cost remains at $2,000, Line [2].

Category C investment questions solve for the period one pre asset operating performance. Again in Exhibit 2, to solve a category C first period pre asset operating performance amount, remaining periods (two through five) must be a relative assumption. Period one is always 100%. The remaining periods two through five pre asset operating performances assumptions are previous period sequential percentages. The percentages are Exhibit 2C, FIG. 14, Line [11], period one 100%, period two 50%, period three −275%, period four 109% and period five 125%. Category C's affirming financial statement's income statement uses the solved ($1,600) for the first period's pre asset operating performance, Line [3]. Period two's pre asset operating performance uses Line [11]'s 50% assumption and calculates a ($800) pre asset operating performance. Lines [11] and [20] continue calculating for the remaining periods. For investment question categories A, B and D pre asset operating performance prior period percent assumption, Line [11] is not applicable.

Although there is an Exhibit 2 provision for an Asset Sale Price, Line [4], the depreciating nature of Exhibit 2's asset places the asset's book value at zero in the last period. The last period's zero book value precludes an asset sale. Exhibit 3's asset is non depreciating. For non depreciating assets the last period's non zero book value allows a calculable asset sale price.

To recognize additional assumptions, Asset Salvage (Disposal), Line [5] is 10% of initial cost. Any asset salvage decreases depreciation expense and any disposal cost increases book depreciation expense over the pre asset operating performances time frame. Debt Capital Structure Weight, Line [6] is added at 80%. External debt financing is placed at eighty percent and the resulting equity at twenty percent throughout the investment question's duration. The Debt Rate, Line [7] on outstanding debt is 4.2%. The user-defined Secondary Flow Return Rate, Line [8] is 5.4%. The income statement's Asset O&M and Property Tax, Line [9] starts at 5.0% of initial cost and increases to 7.2% in the last period. The Depreciable Asset TRUE/FALSE switch, Line [10] selects whether the investment question is a depreciable or a non depreciable asset. Exhibit 2's depreciable asset switch is set to TRUE and in the up-coming Exhibit 3 the switch is set to FALSE.

### Exhibit 2, FULL PICTURE FINANCIAL STATEMENTS (II), Second Section:

Exhibit 2's second section FULL PICTURE FINANCIAL STATEMENTS are identical for all four categories (2A, 2B, 2C and 2D). Exhibit 2 ABC&D's single copy of financial statements begin on FIG. 22. For Exhibit 2 ABC&D, Exhibit 1's equity balance sheet line is now renamed as combined equity and debt financing, Line [19]. The detail surrounding equity and debt financing is found in three pieces starting in the financial statements Schedule 2, FIG. 23, Line [58], EQUITY & DEBT ENDING BALANCE (i), continuing on Line [63], EQUITY & DEBT FINANCING RETURN OF (ii) and finishing on Line [69], DEBT ISSUANCE (REPURCHASE) (iii).

The first piece EQUITY & DEBT ENDING BALANCE (i) Line [58] tracks outstanding equity and debt financing. The beginning balance is netted against the Financing Return Of, Line [59] to form the equity and debt ending balance. Throughout the Exhibits there is minimal delineation between equity and debt balances. The Debt Capital Structure Weight assumption, Line [5] locks the initial relationship between outstanding equity and debt. The joint equity and debt external financing's extinguishment maintains the initial relationship for the investment question's duration. The fixed equity and debt relationship is evidenced in the pretax capital cost calculation.

The next equity and debt financing piece is EQUITY & DEBT FINANCING RETURN OF (ii) starting at Line [63]. To begin, total equity and debt outstanding is multiplied by pretax capital cost to create Pretax Equity & Debt Return On, Line [65]. The combined Equity & Debt Return On & Of, Line [66] is calculated by using the PMT( )function. Taking equity & debt return ‘on’ and ‘of’, Line [66] less equity & debt's return ‘on’, Line [65] leaves equity & debt return ‘of’, Line [67].

The third equity and debt financing piece is DEBT ISSUANCE (REPURCHASE) (iii). Beginning Equity and Debt Balance, Schedule 3, Line [69] and Ending Equity and Debt Balance, Line [74] are multiplied by the Debt Capital Structure Weight, Lines [70] and [73] to calculate Beginning and Ending Debt Balance, Lines [71] and [74]. Each period's Debt Issuance (Repurchase) is the difference between beginning and ending balances, Line [75]. Chapter 12's, Exhibit 6, Varying Financing Rates will take full advantage of the debt issuance (repurchase) mechanics.

The three equity and debt financing pieces (i, ii, iii) show changes to the balance sheet's combined equity and debt balances and their return ‘on’ and ‘of’. The last piece shows separate debt outstanding and subsequent debt issuances and repurchases.

Expanding the balance sheet's equity financing label to include equity and debt is the only balance sheet presentation impact going from Exhibit 1 AB&C to Exhibit 2 ABC&D.

The Exhibit 2 ABC&D income statement, starting at Line [20] now contains Asset O&M Property Tax, Income Tax and Interest Expense line items. Asset O&M Property Tax detail is shown on Lines [76] through [78]. Interest Expense detail is shown on Lines [79] through [81]. Income Tax detail is shown on Lines [82] through [89]. Interest expense and income taxes are internalized in the full picture factor's pretax capital cost. Actual income statement presentation is included to highlight pretax capital cost's summarizing function in FPI's methodology. Sale Gain Price (Loss), Line [23] is unused in Exhibit 2 but is used in Exhibit 3.

Another income statement change is the secondary flow return, Line [26] uses the user-defined secondary flow rate, Line [7] on outstanding secondary flow balances, Lines [90] through [92] instead of IER. The income statement's net income operating performance, Line [27] flows to the owner's equity statement on Line [38].

The cash change in owner's equity statement has four new lines. Salvage (Disposal) depreciation add-back, Line [30] is broken out of the overall depreciation expense, Sale Price Book Value, Line [31] is unused in Exhibit 2 but is used in Exhibit 3. Thirdly, the last period's Asset salvage (disposal), Line [32] is a new cash change item. Finally, Debt Issuance (Repurchase), Line [34] is employed to effectuate debt financing. The debt issuance (repurchase) source is Line [75]. Cash change in owner's equity bottom line, Line [36] flows into the owner's equity statement on Line [39].

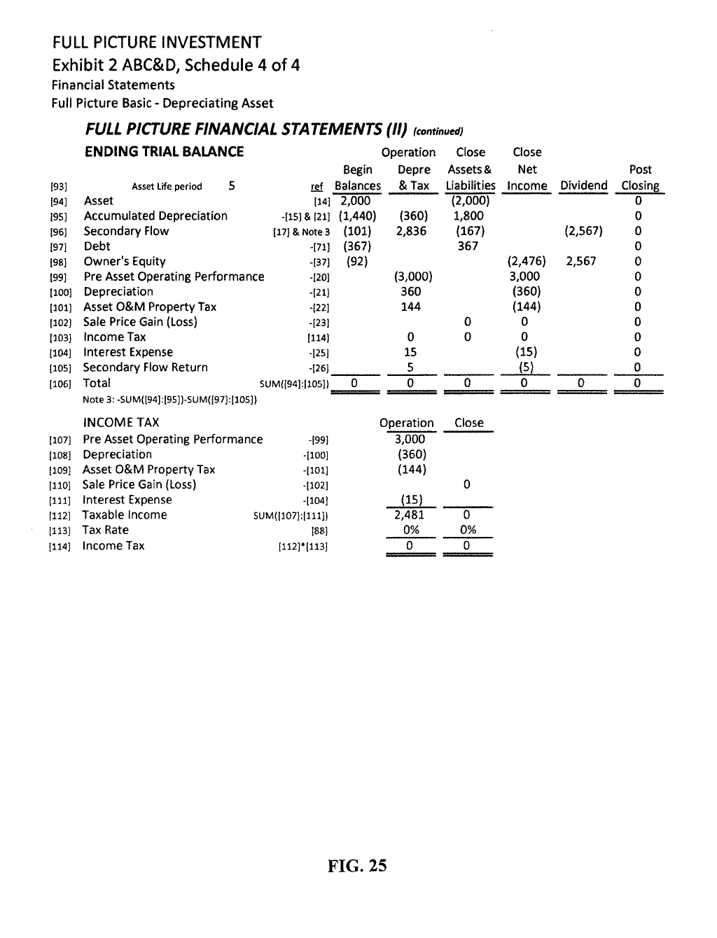

New in Exhibit 2 ABC&D's second section is an Ending Trial Balance at period five, FIG. 25. The ending trial balance starts with period four's ending balances as beginning balances in column one. The second column captures the last period's operations, depreciation and tax. Entries to close the balance sheet are in column three. Closing the balance sheet sets up net income operating performance for closure to owner's equity in column four. Finally, dividends are paid in column five to close out the financial statements in column six. Explicit details surrounding an investment question's trial balance and closing entries gives business professionals additional investment decision comfort.

Although the financial statements do not change significantly from Exhibit 1, in Exhibit 2 there is significant activity going on relative to FPI's methodology. Exhibit 2's FPI's methodology discussion continues with FPI bridge introductions. FPI bridges are mechanisms to maintain FPI's investment question structure and solve/assumption synchronicity. FPI bridges are necessary as investment questions take on additional assumptions introduced in Exhibit 2. Exhibit 2's third (III) section discussion is an introduction to the homogenizing bridge.

### Homogenizing Bridges

Exhibit 2's pre asset operating performance and full picture factor require adjustments to maintain FPI's overarching investment structure. Exhibit 2's varying pre asset operating performance creates a need to shape pre asset operating performance into to a level amount, like the $669 found in Exhibit 1. To shape multiple varying pre asset operating performances into a level non-varying representation requires a proxy. Also, replacing secondary flow's Exhibit 1 IER rate with a user-defined secondary flow rate creates a need to adjust the full picture factor going forward. In addition, the varying O&M property tax and the one time asset salvage (disposal) amounts need to be made into constant and non-varying proxies throughout the operating performance timeframe. Like the secondary flow proxy, the O&M property tax and asset salvage (disposal) proxies are also made through adjustments to the full picture factor. Proxies are needed in Exhibit 2 to continue to emulate the solve/assumption synchronicity found in Exhibit 1. The pre asset operating performance, the secondary flow, the O&M property tax and the asset salvage (disposal) full picture factor proxies are created through FPI bridges.

As defined earlier in Table 8, an investment question has three basic elements: A) a return measure represented by the full picture factor (driven initially by IER, now driven by pretax capital cost), B) initial cost and C) pre asset operating performance.

As assumptions or answers, the basic elements are unabridged (without bridge). To transcend assumptions into FPI answers, unabridged basic elements are temporarily transformed to an abridged state (with bridge). Temporary abridged basic elements are proxies necessitated by FPI's methodology to create synchronized investment structure answers.

Bridges are the mechanism used to transform an unabridged basic element to an abridged state—and the reverse is true—a bridge's removal transforms an abridged state to a FPI answer (unabridged). The investment question category and the manner the basic element is addressed in the investment question determines whether the basic element transformation is going from unabridged to abridged or from abridged to unabridged.

### Exhibit 2, VISUALIZE FULL PICTURE INVESTMENT (III), Third Section:

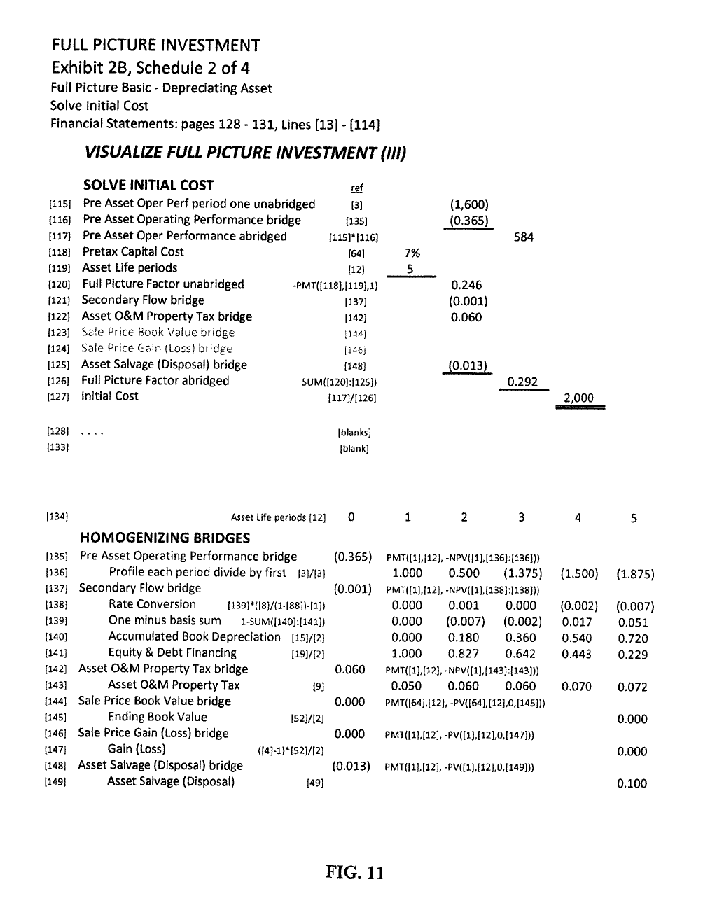

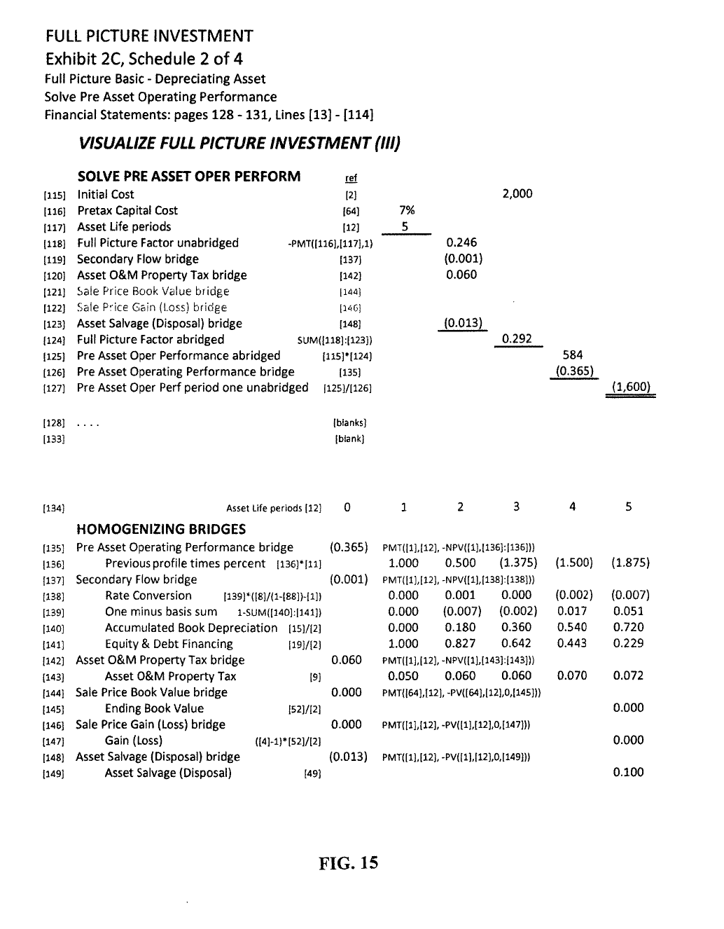

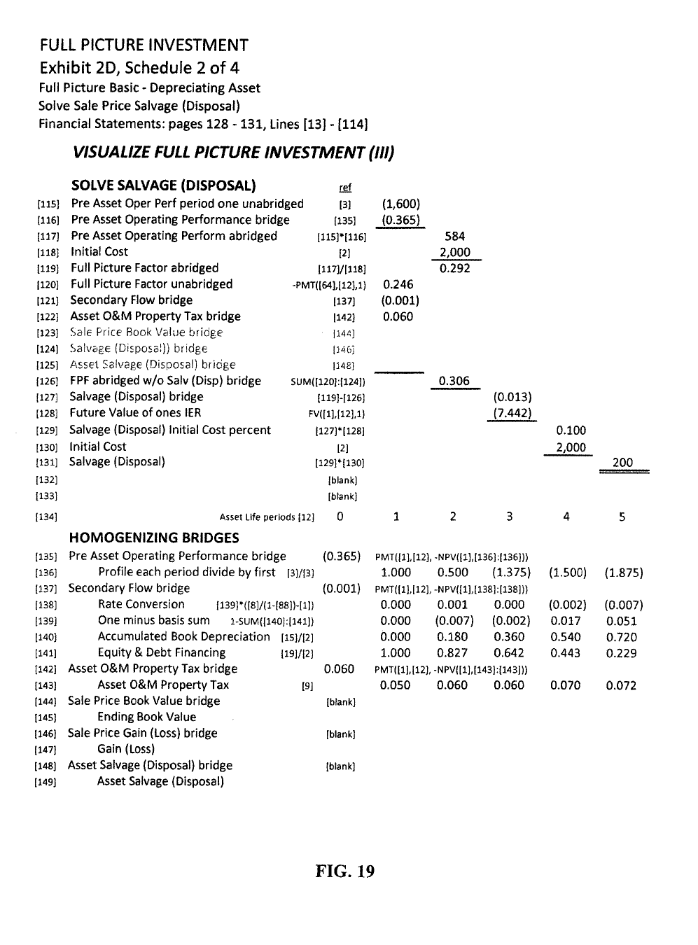

Exhibit 2A, FIG. 7, Exhibit 2B, FIG. 11, Exhibit 2C, FIG. 15 and Exhibit 2D's, FIG. 19, third section VISUALIZE FULL PICTURE INVESTMENT, begin on Line [115] and continue through Line [149].

Exhibit 2A's Pre Asset Operating Performance bridge (0.365), Schedule 2, FIG. 7, Line [116], Secondary Flow bridge (0.001), Line [120], Asset O&M Property Tax bridge 0.060, Line [121] and Asset Salvage (Disposal) bridge (0.013), Line [124] are Table 8 adjustments to maintain investment structure synchronicity. Asset Sale Price bridges, Lines [122] and [123] are used and discussed in Exhibit 3.

The pre asset operating performance bridge starts with the pre asset operating performance profile, Line [136]. For investment question categories A, B and D pre asset operating performance profiles are individual amounts divided by the first period's amount. For question category C, Exhibit 2C, FIG. 15, Line [136] the profile is the previous period profile times the period's next period percent, Line [11]. The profiles are then homogenized into the bridges, Line [135].

For question categories A, B and D period one's ($1,600) pre asset operating performance (unabridged), Line [115] and the bridge, Line [116] produces an abridged $584 pre asset operating performance, Line [117]. For investment question category C, FIG. 15, the $584 abridged pre asset operating performance, Line [125] and the (0.365) bridge, Line [126] are used to produce the unabridged FPI answer ($1,600)—period one's pre asset operating performance Line [127].

Exhibit 2's abridged $584 proxy is the same for five periods. The five period $584s are equal to the varying pre asset operating performances—period one ($1,600), period two ($800), period three $2,200, period four $2,400 and period five $3,000.

The bridge's (0.365) calculation, Line [135] uses IER as a return rate. Pre asset operating performance is absent initial cost impacts, including any debt influences. Pre asset operating performance is therefore a component to the owner's equity net income operating performance. As an owner's equity component, pre asset operating performance requires IER to calculate its bridge. The pre asset operating performance bridge makes Table 8's valid Exhibit 1 relationships still valid in Exhibit 2. Exhibit 2 in essence utilizes an abridged $584 non-varying pre asset operating performance proxy amount. The non-varying proxy creates an identical situation to Exhibit 1's non-varying pre asset operating performance.

The key to the (0.365) pre asset operating performance's bridge is the first period. The bridge is calculated through setting the first period pre asset operating performance basis at 1, profiling remaining periods relative to the first period's 1 basis, Line [136] and homogenizing (taking the five period's basis NPV and then finalizing the bridge through the PMT function). In FPI's methodology, Line [135]'s combined NPV and PMT function nesting is referred to as homogenizing. The homogenizing format is set out in Table 10.

TABLE 10
FPI'S HOMOGENIZING BRIDGE FORMAT:
=PMT(rate, periods, NPV(rate, amounts))

Homogenizing takes disparate amounts over time or individual single amounts and re-represents them as equal amounts over the investment question's duration. FPI homogenizing through NPV discounting and reformulation can occur at either IER or pretax capital cost, depending on the flow's component. Homogenizing is a means to allow the relationships in Table 8 to continue to be held valid even with real-world varying assumptions.

The secondary flow rate is a user-defined assumption in Exhibit 2. Exhibit 2's secondary flow bridge compensates for variances generated by the secondary flow rate being user-defined. An ideal traditional tool replacement allows the business professional to provide a unique rate for secondary flows but yet maintain investment solve/assumption synchronicity. A unique user defined secondary flow rate necessitates a FPI bridge to maintain FPI's investment structure.

The key to the (0.001) secondary flow's bridge is the basis 1 balance sheet representations. The bridge's calculation takes one less the balance sheet basis sum, Line [139], converting from an IER to the user-defined rate, Line [138] and homogenizing it over five periods, Line [137].

The Asset O&M Property Tax bridge homogenizes the period over period increasing O&M property tax assumption. The assumption starts at 0.050 in period one and ends at 0.072 in period five, Line [143]. The 0.060 bridge, Line [142] represents a non-varying proxy for all five periods. The O&M property tax bridge adjusts the full picture factor, Exhibit 2A, FIG. 7, Line [121], Exhibit 2B, FIG. 11, Line [122], Exhibit 2C, FIG. 15, Line [120] and Exhibit 2D, FIG. 19, Line [122].

The (0.013) Asset Salvage (Disposal) bridge, Line [148] homogenizes the single period five 0.100 asset salvage assumption, Line [149]. The (0.013) bridge is a representative non-varying five period proxy. The asset salvage (disposal) bridge adjusts the full picture factor, Exhibit 2A, Line [124], Exhibit 2B, Line [125] and Exhibit 2C, Line [123]. Rather than use a calculated bridge, Exhibit 2D, third (III) section, solves for the Asset Salvage (Disposal) bridge, FIG. 19, Line [127] discussed later in this section.

The Sale Price Book Value bridge, Line [144] and Sale Price Gain (Loss) bridge, Line [146] are used and discussed in Exhibit 3.

For Exhibit 2A, FIG. 7, Line [117], the $584 abridged pre asset operating performance divided by the $2,000 initial cost forms a 0.292 abridged full picture factor. The abridged full picture factor less the secondary flow bridge, O&M property tax bridge and salvage (disposal) bridge equals the 0.246 unabridged full picture factor. The unabridged full picture factor combined with five periods generates the 7% pretax capital cost, Line [127]. Line [127]'s 7% pretax capital cost converted to IER, Line [128] matches the 20% FPI answer on Line [1].

For Exhibit 2B, FIG. 11, the 0.246 unabridged full picture factor, Line [120] plus the secondary flow bridge, O&M property tax bridge and salvage (disposal) bridge equals the 0.292 abridged full picture factor. Line [117]'s $584 abridged pre asset operating performance divided by the 0.292 abridged full picture factor forms the $2,000 initial cost. Line [127]'s $2,000 initial cost matches the FPI answer on Line [2].

For Exhibit 2C, FIG. 15, the 0.246 unabridged full picture factor, Line [118] plus the secondary flow bridge, O&M property tax bridge and salvage (disposal) bridge equals the 0.292 abridged full picture factor, Line [124]. The $2,000 initial cost, Line [115] multiplied by the 0.292 abridged full picture factor forms the $584 abridged pre asset operating performance. The $584 abridged pre asset operating performance divided by the (0.365) pre asset operating performance bridge forms the ($1,600) period one's pre asset operating performance, Line [127]. The ($1,600) unabridged pre asset operating performance equals the FPI answer on Line [3].

For Exhibit 2D, FIG. 19, the 0.292 abridged full picture factor, Line [119] less the 0.306 abridged full picture factor without salvage (disposal) bridge equals the (0.013) salvage (disposal) bridge, Line [127]. The (0.013) salvage (disposal) bridge multiplied by the (7.442) future value of ones forms the 0.100 salvage (disposal) initial cost percent, Line [129]. The salvage (disposal) initial cost percent times initial cost equals the $200 salvage (disposal), Line [131].

So now, at a holistic level, FPI's investment structure demonstrates its versatility outside of Table 8's three basic investment elements. Exhibit 3A, 3B and 3C's given salvage (disposal) bridge can not only be included as a homogenized assumption germane to an investment question, in Exhibit 3D, the former assumption can also be turned around into a solved for homogenized bridge and converted into an investment question's answer—through applying FPI's synchronicity methodology.

In summary, moving to more real world investment situations requires new investment question assumptions. New assumptions require adjustments to FPI's core methodology to maintain synchronicity around the investment structure. FPI homogenizing bridges are the mechanisms to facilitate needed adjustments.

Exhibit 2, FULL PICTURE INVESTMENT vs. TRADITIONAL TOOLS (IV), Fourth Section:

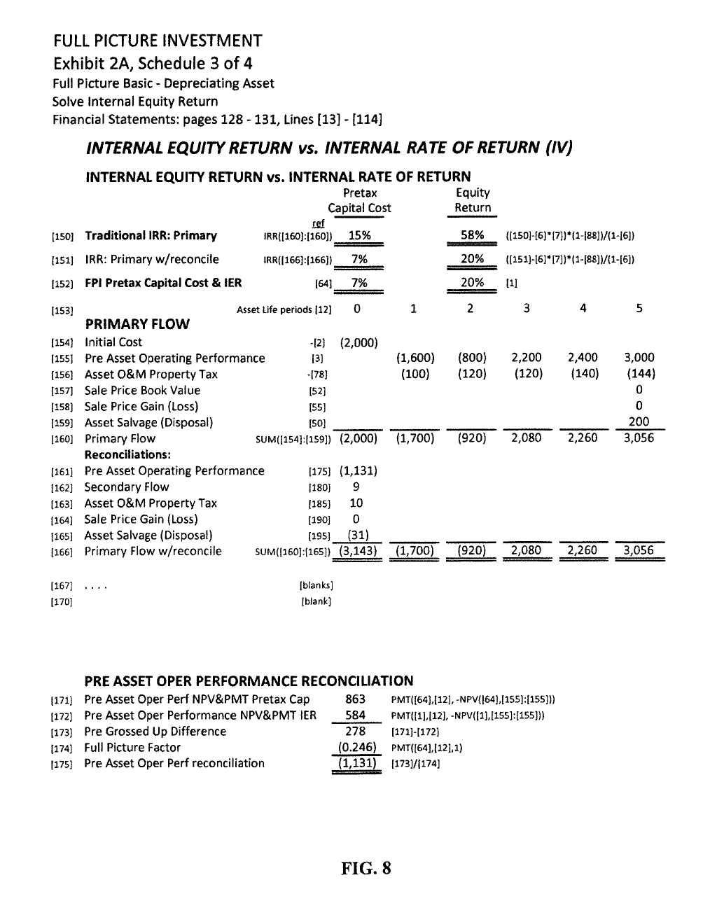

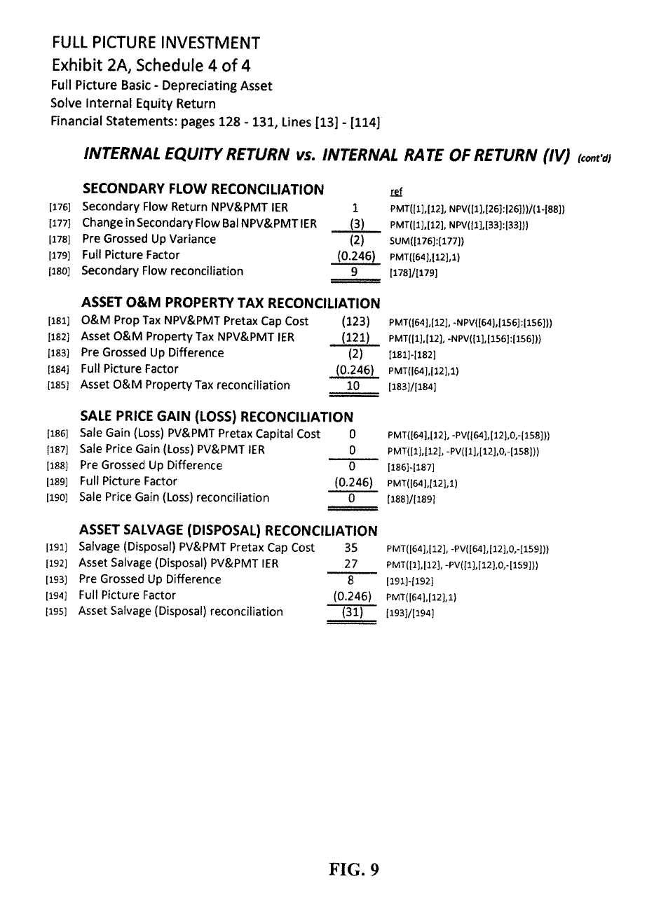

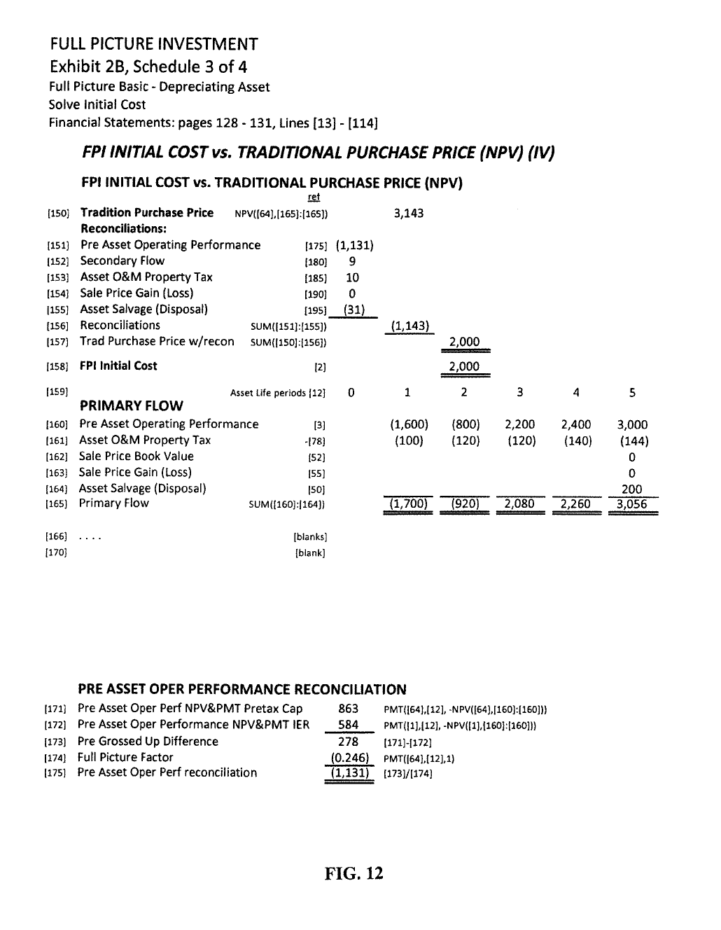

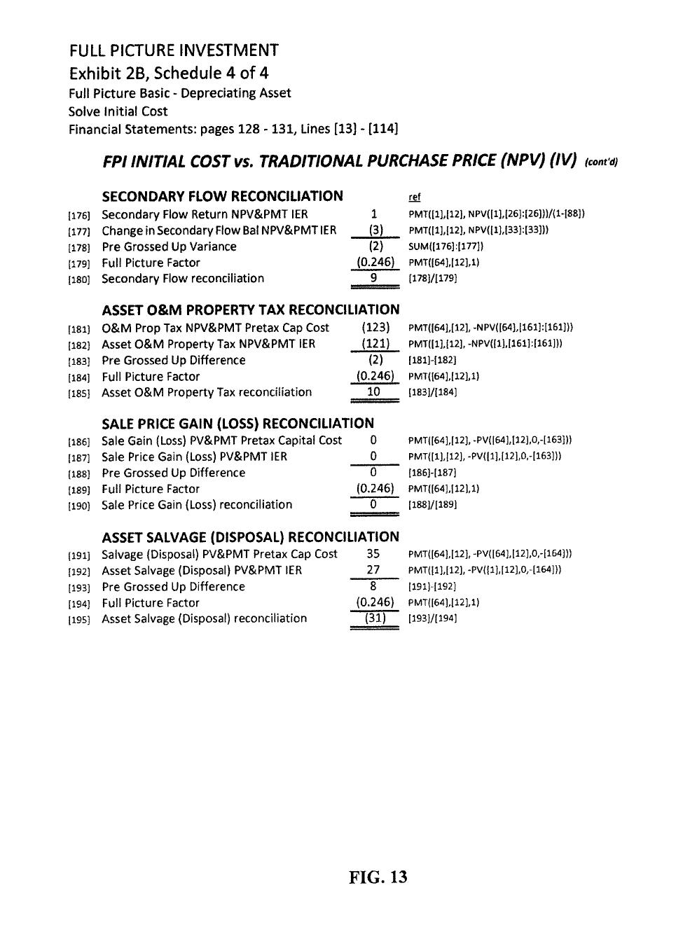

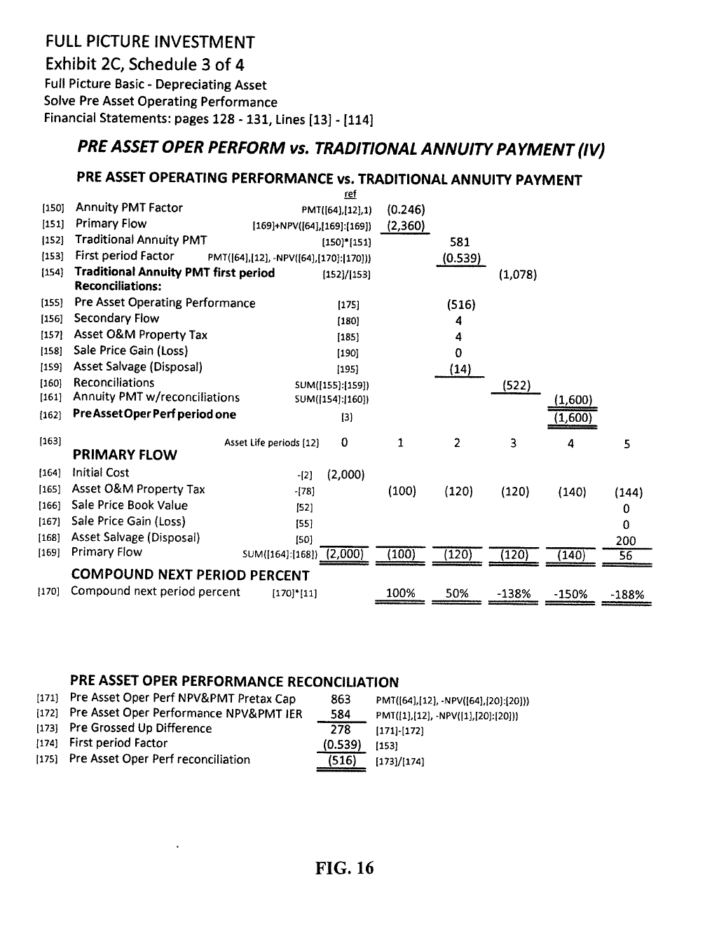

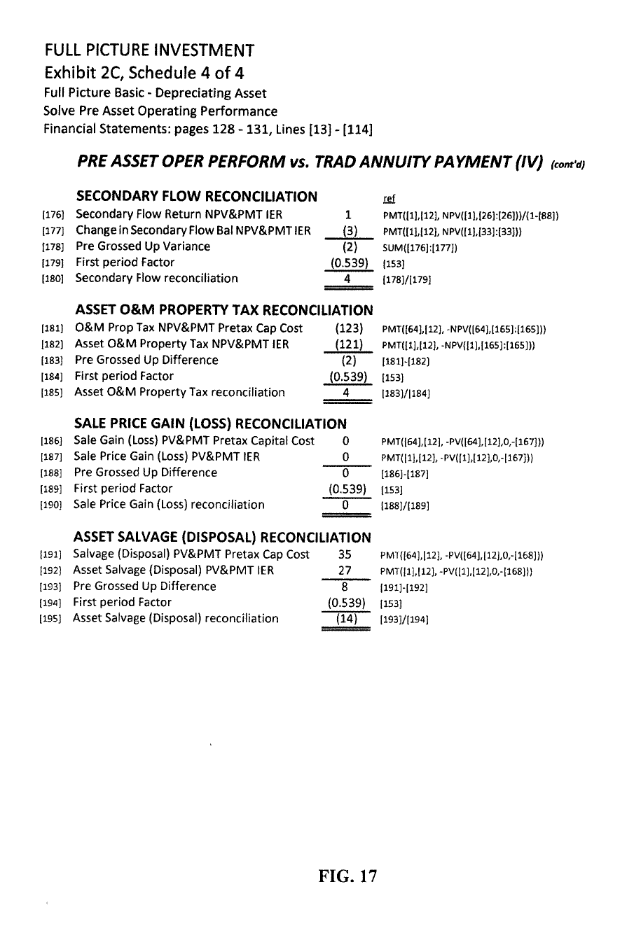

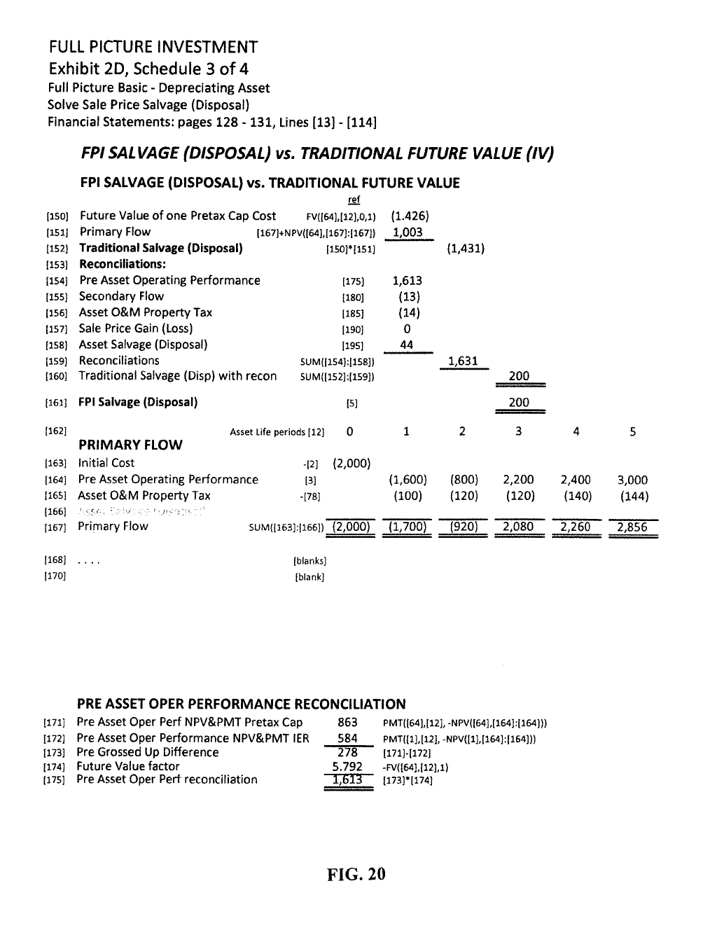

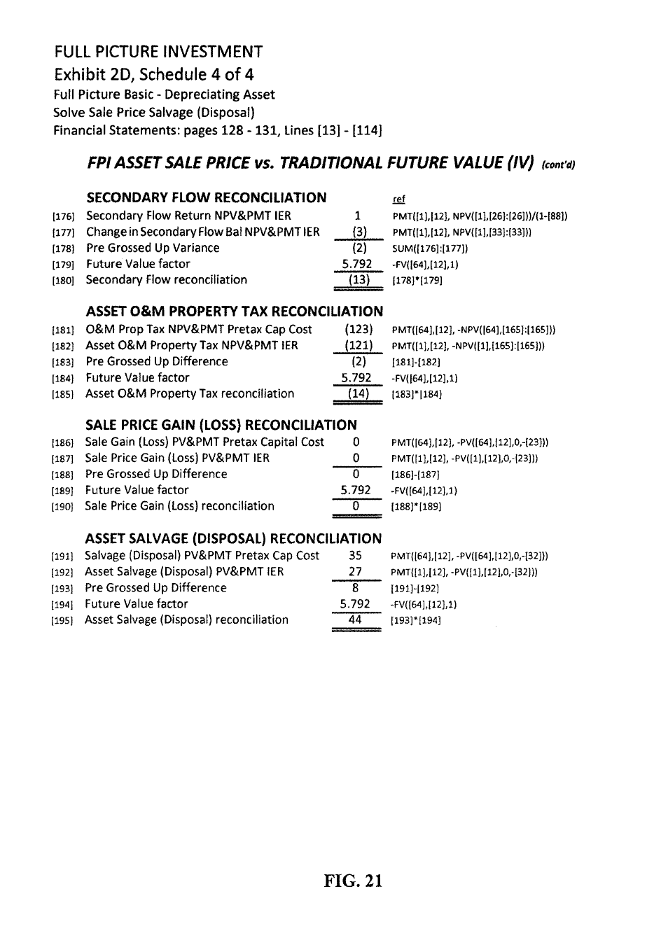

Exhibit 2A, FIG. 8, Exhibit 2B, FIG. 12, Exhibit 2C, FIGS. 16 and 2D's, FIG. 20, fourth section starts on Line [150]. An Exhibit's fourth section highlights FPI and traditional tool differences. Each fourth (IV) section starts with calculating the traditional tool answer for a question category and then reconciles it to the FPI answer (Exhibit 2A—IER vs. IRR; Exhibit 2B—Initial Cost vs. Purchase Price (NPV); Exhibit 2C—Pre Asset Operating Performance vs. PMT Annuity); and Exhibit 2D—Sale Price Salvage (Disposal) vs. Future Value.

The fourth section traditional tool answers use the investment question's primary flow in investment question. The primary flows are found at Exhibit 2A, FIG. 8, Line [160], Exhibit 2B, FIG. 12, Line [165], Exhibit 2C, FIG. 16, Line [169] and Exhibit 2D, FIG. 20, Line [167]. For investment question category C the compound next period percent, Exhibit 2C, FIG. 16, Line [170] is used to drive the (0.539) first period factor, Line [153].

Reconciliations are calculated to corroborate the differences between the traditional tool and FPI answers to investment questions. The reconciliation amounts take an investment question's component and homogenizes the component's flow at two different rates. One homogenizing rate is the traditional tool's singular rate. The other rate is the correct FPI rate. The difference between the two homogenizing results is grossed up in a manner governed by the question category solved. The grossed up amount represents the individual item's reconciliation.

Not every investment question component requires a reconciling item between FPI and traditional tool answers. There will not be a reconciling item for FPI balance sheet components properly using pretax capital cost since pretax capital cost is also the traditional tool's single rate.

In Exhibit 2A, FIG. 8, a 15% traditional tool IRR calculation, Line [150] utilizing Line [160]'s primary flow is compared to a 7% reconciled IRR. Line [151]'s 7% starts with Line [160]'s primary flow and includes reconciliations as totaled on Line [166].

The 15% traditional tool and 7% FPI are both pretax capital cost amounts recognizing debt's presence. Removing debt leverage from pretax capital cost reveal a 58% and 20% equity return also on Lines [150] and [151]. The differences are found in four reconciling items.

First, Exhibit 2A's ($1,131) pre asset operating performance reconciling item, Line [161] is the difference between the pre asset operating performance, Line [155] homogenized at 7% pretax capital cost, $863, Line [171] and the same pre asset operating performance homogenized at 20% IER, $584, Line [172]. The difference between the two, $278, Line [173] is grossed up by the unabridged 0.246 full picture factor (category A investment question) to finalize the pre asset operating performance reconciliation.

Secondly, the $9 secondary flow reconciling item, Line [162] is a two stage aggregate variance. The first part is the secondary flow return, Line [26] homogenized at IER, Line [176]. The second part is the change in secondary flow balances, Line [33] also homogenized at IER, Line [177]. Together they represent the secondary flow reconciliation's pre grossed up variance. The secondary flow reconciliation gross up factor is also the unabridged full picture factor, Line [179].

Thirdly, the $10 asset O&M property tax item, Line [163] is the difference between the asset O&M property tax, Line [156] homogenized at 7% pretax capital cost, $123, Line [181] and the same asset O&M property tax homogenized at 20% IER, $121, Line [182]. The difference between the two ($2), Line [183] is grossed up by the unabridged (0.246) full picture factor (category A investment question) to finalize the asset O&M property tax reconciliation.

Lastly, the ($31) asset salvage (disposal) item, Line [165] is the difference between the asset salvage (disposal), Line [159] homogenized at 7% pretax capital cost, $35, Line [191] and the same asset salvage (disposal) homogenized at 20% IER, $27, Line [192]. The $8 difference between the two, Line [193] is grossed up by the unabridged (0.246) full picture factor (category A investment question) to finalize the asset salvage (disposal) reconciliation.

Exhibit 2A shows FPI's answer to the investment question calculated in section one, 20% IER, Line [1] matching the 20% traditional tool reconciled calculation, Line [151].

The traditional IRR tool's 58% equity return, Line [150] is almost three times greater than FPI's 20% counterpart, Lines [151] and [152]. Given solve/assumption synchronicity and affirming second (II) section financial statements, business professionals are comfortable portraying the investment question at FPI's 20% rather than the traditional tool's 58%.

In Exhibit 2B, FIG. 12, a $3,143 traditional tool purchase price calculation on Line [150], utilizes Line [165]'s primary flow. The $3,143 traditional tool purchase price is reconciled with a FPI $2,000 purchase price on Line [157]. The reconciling $1,143 purchase price difference is made up of four items.

Exhibit 2B's ($1,131) pre asset operating performance reconciling item, Line [151] is the difference between the pre asset operating performance, Line [160] homogenized at 7% pretax capital cost, $863, Line [171] and the same pre asset operating performance homogenized at 20% IER, $584, Line [172]. The difference between the two, $278, Line [173] is grossed up by the unabridged (0.246) full picture factor (category B investment question) to finalize the pre asset operating performance reconciliation.

The $9 secondary flow reconciling item, Line [152] is a two stage aggregate variance. The first part is the secondary flow return, Line [26] homogenized at IER, Line [176]. The second part is the change in secondary flow balances, Line [33] also homogenized at IER, Line [177]. Together they represent the secondary flow reconciliation's pre grossed up variance. The secondary flow reconciliation gross up factor is also the unabridged full picture factor, Line [179].

The $10 asset O&M property tax item, Line [153] is the difference between the asset O&M property tax, Line [161] homogenized at 7% pretax capital cost, ($123), Line [181] and the same asset O&M property tax homogenized at 20% IER, ($121), Line [182]. The ($2), Line [183] difference between the two is grossed up by the unabridged (0.246) full picture factor (category A investment question) to finalize the asset O&M property tax reconciliation.

The ($31) asset salvage (disposal) item, Line [155] is the difference between the asset salvage (disposal), Line [164] homogenized at 7% pretax capital cost, $35, Line [191] and the same asset salvage (disposal) homogenized at 20% IER, $27, Line [192]. The $8, Line [193] difference between the two is grossed up by the unabridged (0.246) full picture factor (category B investment question) to finalize the asset salvage (disposal) reconciliation.

Exhibit 2B shows FPI's answer to the investment question calculated in section one, $2,000 Initial Cost, Line [2] matching the $2,000 traditional tool reconciled calculation, Line [157].

The traditional NPV tool's $3,143 purchase price, Line [150] is 57% greater than FPI's $2,000 counterpart, Lines [157] and [158]. Given solve/assumption synchronicity and affirming second (II) section financial statements, business professionals are comfortable portraying the investment question at FPI's $2,000 initial cost rather than the traditional tool's $3,143.

In Exhibit 2C, FIG. 16, a ($1,078) traditional tool first period pre asset operating performance calculation, Line [154] is reconciled with FPI's ($1,600) first period pre asset operating performance, Line [161]. The ($522) first period pre asset operating performance difference is made up of four items.

The ($516) pre asset operating performance reconciling item, Line [155] is the difference between the pre asset operating performance, Line [20] homogenized at the 7% pretax capital cost, $863, Line [171] and the same pre asset operating performance homogenized at 20% IER, $584, Line [172]. The question category C difference between the two, $278, Line [173] is grossed up by the first period factor, Line [174] to finalize the pre asset operating performance reconciliation.

Exhibit 2C's $4 secondary flow reconciling item, Line [156] is a two stage aggregate variance. The first part is the secondary flow return, Line [26] homogenized at IER, Line [176].

The second part is the change in secondary flow balances, Line [33] also homogenized at IER, Line [177]. Together they represent the ($2) secondary flow reconciliation's pre grossed up variance. The secondary flow reconciliation gross ups are by the first period factor, Line [179].

The $4 asset O&M property tax item, Line [157] is the difference between the asset O&M property tax, Line [165] homogenized at 7% pretax capital cost ($123), Line [181] and the same asset O&M property tax homogenized at 20% IER ($121), Line [182]. The ($2) difference between the two, Line [183] is grossed up by the (0.539) first period factor (category C investment question) to finalize the asset O&M property tax reconciliation.

The ($14) asset salvage (disposal) item, Line [159] is the difference between the asset salvage (disposal), Line [168] homogenized at 7% pretax capital cost $35, Line [191] and the same asset salvage (disposal) homogenized at 20% IER $27, Line [192]. The $8 difference between the two, Line [193] is grossed up by the (0.539) first period factor (category C investment question) to finalize the asset salvage (disposal) reconciliation.

Exhibit 2C shows FPI's answer to the investment question calculated in section one, ($1,600) Pre Asset Operating Performance period one, Line [3] matching the ($1,600) traditional tool reconciled calculation, Line [161].

The traditional PMT tool's ($1,078) annuity first period, Line [154] is 33% less than FPI's ($1,600) counterpart, Lines [161] and [162]. Given solve/assumption synchronicity and affirming second (II) section financial statements, business professionals are comfortable portraying the investment question's answer at FPI's ($1,600) period one pre asset operating performance rather than the traditional tool's ($1,078).

In Exhibit 2D, FIG. 20, a ($1,431) traditional tool salvage (disposal) calculation, Line [152] is reconciled with FPI's $200 salvage (disposal), Line [160].

Table 11 illustrates the typical traditional salvage (disposal) calculation. Each period's unique Future Value factor (Line b) is multiplied by the period's Primary Flow (Line c). The total future value salvage (disposal) is ($1,431) the negative period zero through period five summation. Exhibit 2D, FIG. 20, Line [152], takes an alternate approach to get to the same Table 11 traditional tool ($1,431) future value.

TABLE 11
FUTURE VALUE CALCULATION - EXHIBIT 2D, FIG. 20
Traditional method (Primary Flow)

| | | | | | | | | | Future |
|---|---|---|---|---|---|---|---|---|---|
| | | ref | 0 | 1 | 2 | 3 | 4 | 5 | Value |
| (a) | One plus Pretax | Note 1 | 1.07\hat{ }5 | 1.07\hat{ }4 | 1.07\hat{ }3 | 1.07\hat{ }2 | 1.07\hat{ }1 | 1.07\hat{ }0 | |
| | Capital Cost raised | | | | | | | | |
| | to a future value | | | | | | | | |
| (b) | Future Value factor | (a) | 1.426 | 1.329 | 1.237 | 1.153 | 1.074 | 1.000 | |
| (c) | Primary Flow | [167] | ($2,000) | ($1,700) | ($920) | $2,080 | $2,260 | $2,856 | |
| (d) | FV Sum Across | (b) × (c) | ($2,853) | ($2,258) | ($1,138) | $2,397 | $2,426 | $2,856 | ($1,431) |

Note 1:
The actual number is 1.0736 (One plus Exhibit 2 ABC&D, FIG. 23, Line [64])

The $1,631, Line [159] traditional future value reconciliation is made up of four items.

The $1,613 pre asset operating performance reconciling item, Line [154] is the difference between the pre asset operating performance, Line [164] homogenized at the 7% pretax capital cost, $863, Line [171] and the same pre asset operating performance homogenized at 20% IER, $584, Line [172]. The question category D difference between the two, $278, Line [173] is grossed up by the 5.792 future value factor, Line [174] to finalize the pre asset operating performance reconciliation.

Exhibit 2D's ($13) secondary flow reconciling item, Line [155] is a two stage aggregate variance. The first part is the secondary flow return, Line [26] homogenized at IER, Line [176]. The second part is the change in secondary flow balances, Line [33] also homogenized at IER, Line [177]. Together they represent the ($2) secondary flow reconciliation's pre grossed up variance. The secondary flow reconciliation gross ups are by the future value factor, Line [179].

The ($14) asset O&M property tax item, Line [156] is the difference between the asset O&M property tax, Line [165] homogenized at 7% pretax capital cost, ($123), Line [181] and the same asset O&M property tax homogenized at 20% IER, ($121), Line [182]. The difference between the two, ($2), Line [183] is grossed up by the 5.792 future value factor (category D investment question) to finalize the asset O&M property tax reconciliation.

The $44 asset salvage (disposal) item, Line [158] is the difference between the asset salvage (disposal), Line [32] homogenized at 7% pretax capital cost $35, Line [191] and the same asset salvage (disposal) homogenized at 20% IER, $27, Line [192]. The $8, Line [193] difference between the two is grossed up by the 5.792 future value factor (category D investment question) to finalize the asset salvage (disposal) reconciliation.

Exhibit 2D shows FPI's answer to the investment question calculated in section one $200 Salvage (Disposal), Line [5] matching the $200 traditional tool reconciled calculation, Line [160].

Given solve/assumption synchronicity and affirming second (II) section financial statements, business professionals are comfortable portraying the investment question at FPI's $200 salvage rather than the traditional tool's ($1,431) disposal cost.

All four Exhibit 2A, 2B, 2C and 2D, FULL PICTURE INVESTMENT vs. TRADITIONAL TOOLS pre grossed up reconciliation amounts are identical. The reconciliations stem from homogenizing components at IER versus pretax capital cost or from user-defined secondary flow rate versus IER. The non-grossed up pre asset operating performance difference is $278, the secondary flow difference is ($2), the asset O&M property tax difference is ($2) and the asset salvage (disposal) difference is $8 for the four question categories. The reconciliation differences between the four categories comes from the gross-up factor associated with the investment question's category. Identical pre gross-up reconciliation items show the traditional tools and FPI are acting in a similar manner around investment questions sharing the same assumptions. The traditional tools are consistently and incorrectly applying pretax capital cost to the primary flow. FPI is correctly applying the appropriate rate to an investment question's individual components.

In Exhibit 1 there were no differences and hence no reconciliations between the traditional tools and FPI. Exhibit 2 shows how identical pre grossed-up reconciliations amongst the categories point to FPI still fundamentally grounded with the traditional tools. In Exhibit 2 the only difference between the traditional tools and FPI are the FPI bridges necessary to maintain FPI's investment structure.

Depending on pre asset operating performance's period to period variability and the debt financing level, pre asset operating performance reconciliation is usually the single largest reconciling item between FPI and the traditional tools.

### Solve/assumption Synchronicity

FPI' s solve/assumption synchronicity is a term used to describe Table 8's three investment question categories A, B and C interaction amongst their assumptions and their solved answers. Synchronicity describes how each investment question category should calculate an answer identical to other category's assumptions when assumptions are shared between the question categories.

More specifically, the given pre asset operating performance in a category A investment question and the solved IER, when used in a category B question should solve for the same initial cost answer used as the given initial cost in the category A question. See Table 12.

TABLE 12
SOLVE/ASSUMPTION SYNCHRONICITY - EXHIBIT 1

| | Question Category | | | | | |
|---|---|---|---|---|---|---|
| | A - Equity | | B - Initial | | | |
| | Return | | Cost | | C - Oper Perform | |
| | FPI | IRR | FPI | NPV | FPI | PMT |
| | (a) | (b) | (c) | (d) | (e) | (f) |
| Equity Return | 20%* | 20%* | 20% | 20% | 20% | 20% |
| Initial Cost | $2,000 | $2,000 | $2,000* | $2,000* | $2,000 | $2,000 |
| Pre Asset Operating | $669 | $669 | $669 | $669 | $669* | $669* |
| Performance | | | | | | |

*Indicates a solve for item

Table 12 depicts the previous Exhibit 1 FPI and traditional tools both having synchronicity—columns (a through f) match. However, Exhibit 2's Table 13 has only FPI synchronicity—only the FPI columns (a, c, e, g) match for each basic element. The traditional tools have lost their solve/assumption synchronicity in Exhibit 2.

Solve/assumption synchronicity is a defining FPI methodology trait. Exhibit 2 introduces the FPI pre asset operating performance bridge, secondary flow bridge, the asset O&M property tax bridge and the asset salvage (disposal) bridge to maintain solve/assumption synchronicity. Synchronicity's demonstration, through bridges, fixes IRR, NPV, PMT and FV traditional tool's singular rate on primary flows. Synchronicity extols a congruent and harmonious FPI methodology focusing on IER.

TABLE 13
SOLVE/ASSUMPTION SYNCHRONICITY - EXHIBIT 2

| | Question Category | | | | | | | |
|---|---|---|---|---|---|---|---|---|
| | A - Equity Return | | B - Initial Cost | | C - Oper Perform | | D - Salvage | |
| | FPI | IRR | FPI | NPV | FPI | PMT | FPI | FV |
| | (a) | (b) | (c) | (d) | (e) | (f) | (g) | (h) |
| Equity Return | 20%* | 58%* | 20% | 20% | 20% | 20% | 20% | 20% |
| Initial Cost | $2,000 | $2,000 | $2,000* | $3,143* | $2,000 | $2,000 | $2,000 | $2,000 |
| Pre Asset Oper | ($1,600) | ($1,600) | ($1,600) | ($1,600) | ($1,600)* | ($1,078)* | ($1,600) | ($1,600) |
| Performance | | | | | | | | |
| Salvage | $200 | $200 | $200 | $200 | $200 | $200 | $200* | ($1,431)* |
| (Disposal) | | | | | | | | |

*Indicates a solve for item

FPI's methodology has no limit in the ability to incorporate new assumptions. If a topic is germane to an investment question it can be incorporated into FPI's methodology as a component. FPI incorporates new components and their assumptions along with the three basic elements through different investment structure areas.

In Chapter 9, Exhibit 3 introduces non depreciating assets. Unlike depreciating assets, non depreciating assets have a sale price at the end of the investment question's time frame. Although Exhibit 3's assumptions differ from Exhibit 2, Exhibit 3's four sections (I, II, III and IV) are identically structured to Exhibit 2's four sections.

### Non Depreciating Asset

Chapter 9's Exhibit 3 focuses on a non depreciating asset. FPI's methodology can accommodate investment questions containing both depreciable and non-depreciable assets. An investment question containing both material depreciable and material non depreciable assets requires two FPI calculations. Consolidating the depreciable asset's affirming financial statements with the non-depreciable asset's affirming financial statements provides the business professional with the investment question's full picture.

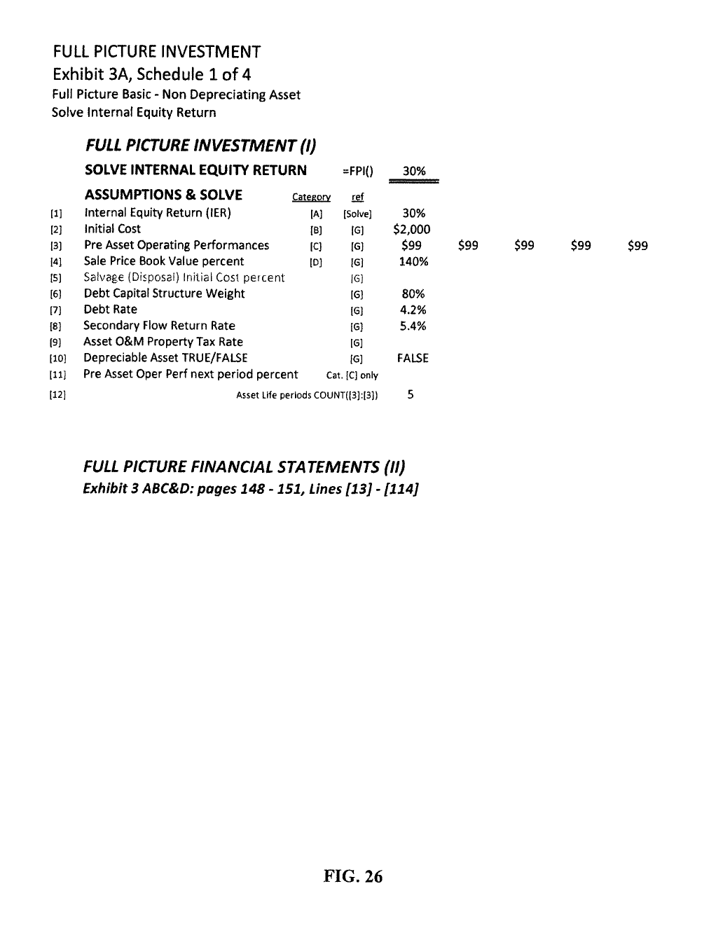

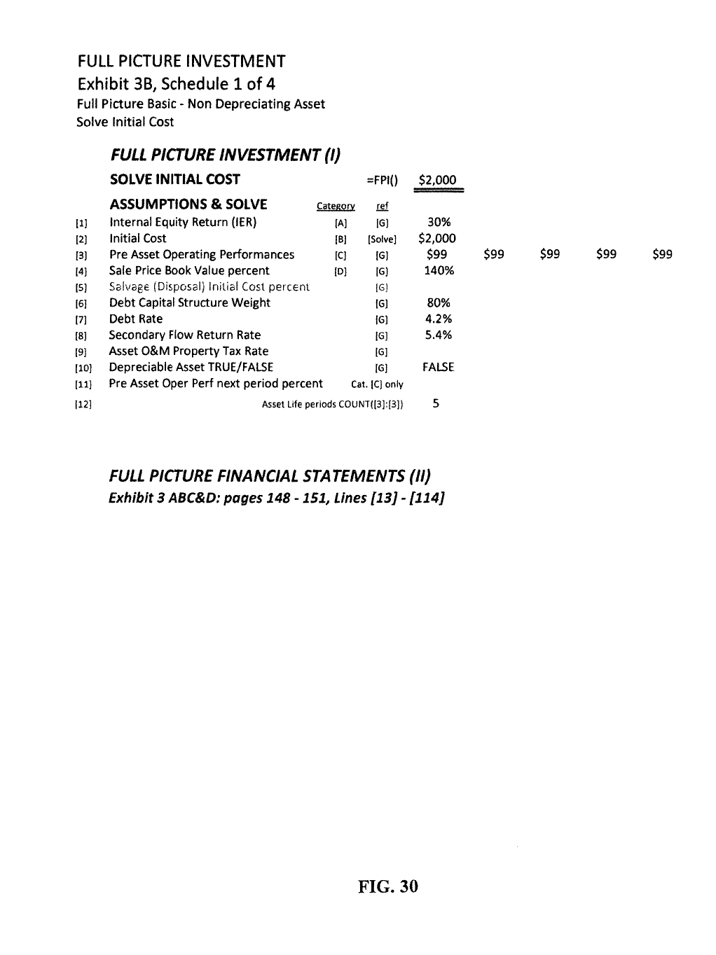

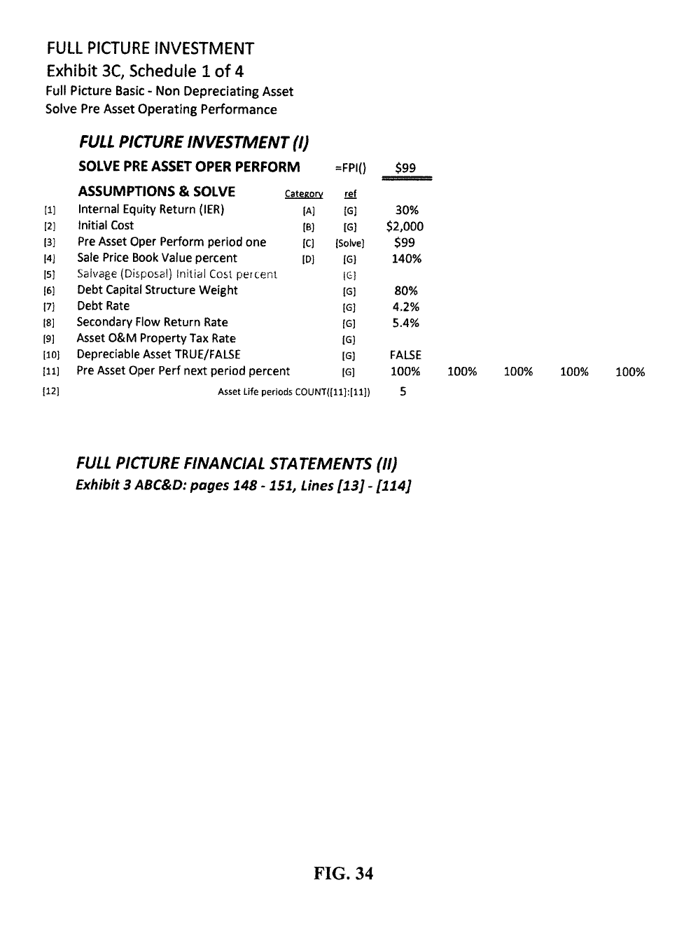

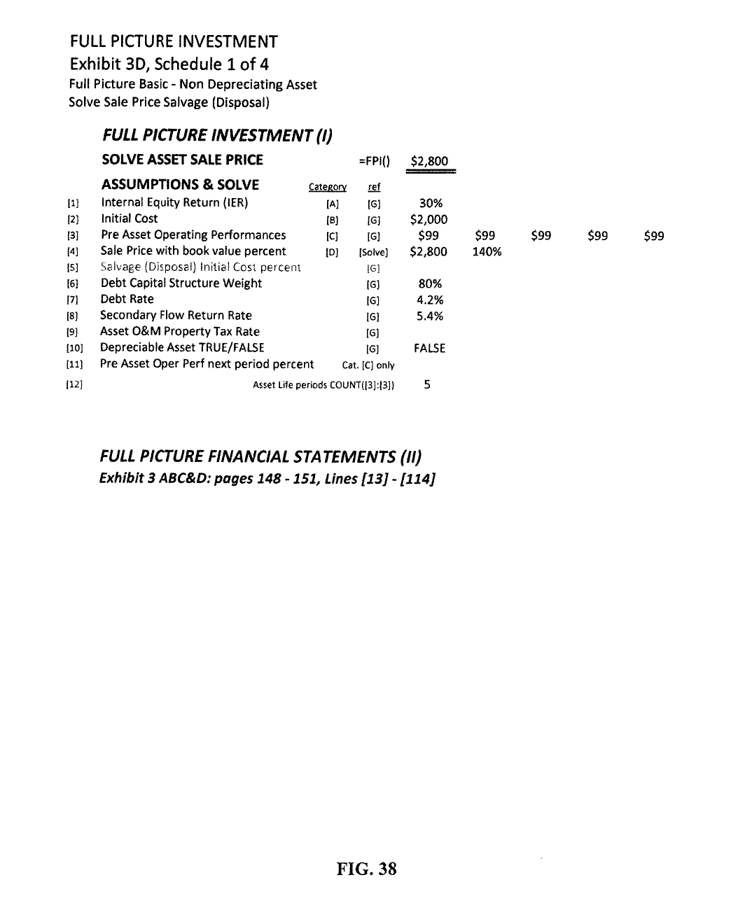

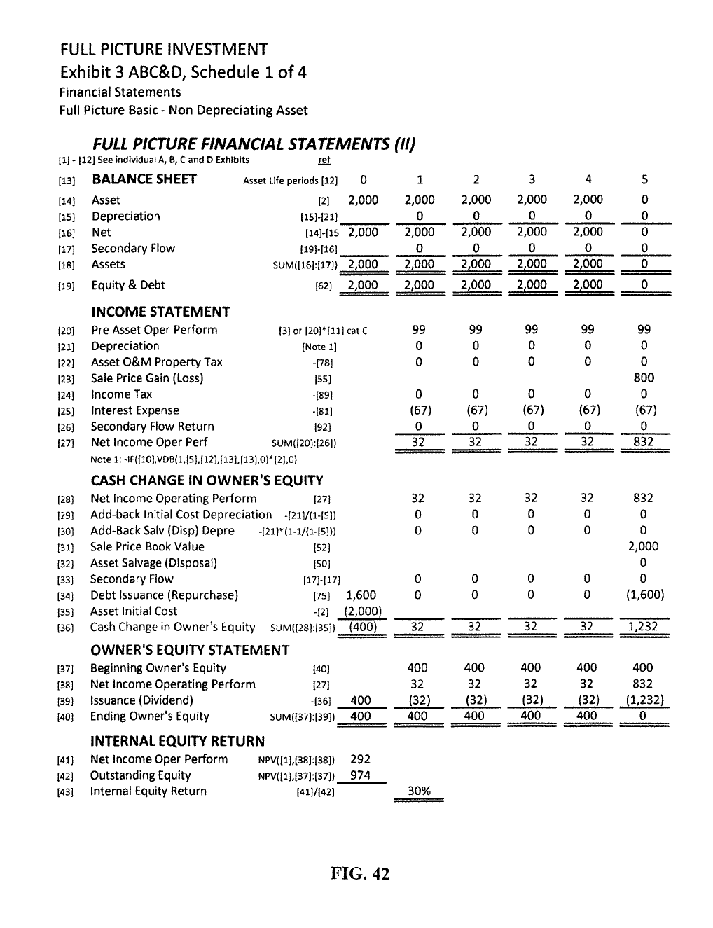

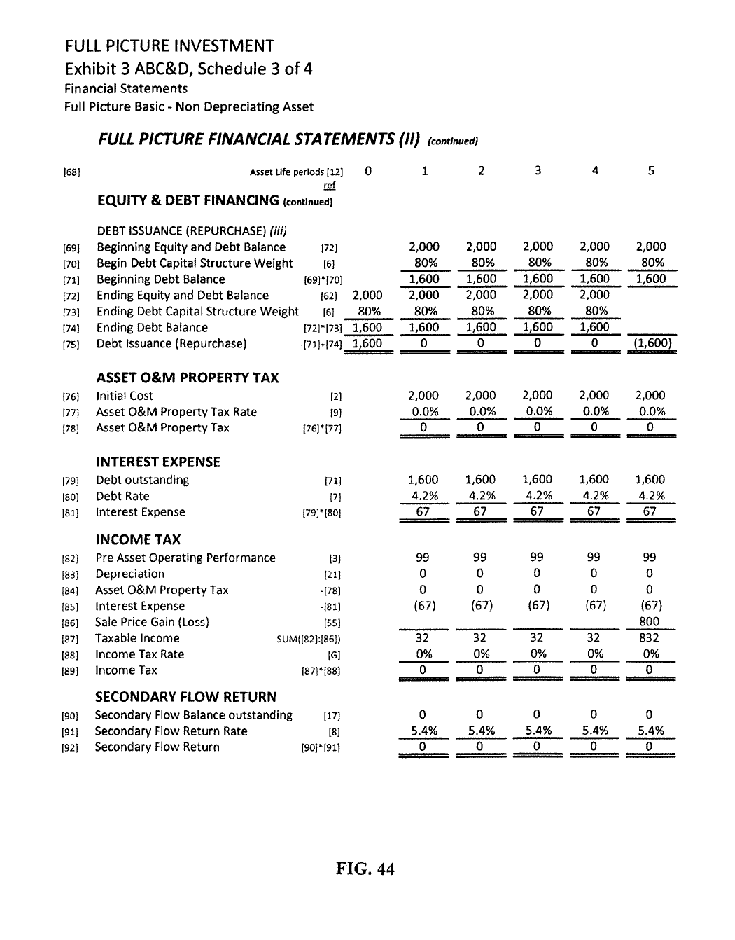

Exhibit 3A is found on FIG. 26, Exhibit 3B on FIG. 30, Exhibit 3C on FIG. 34 and Exhibit 3D on FIG. 38. The single set of Exhibit 3 ABC&D financial statements is found on FIGS. 42-45, Lines [13]-[114], collectively Exhibit 3. There are no new assumptions introduced in Exhibit 3. As explained below, there are assumptions from Exhibit 2 that have changed in Exhibit 3.

### Exhibit 3, FULL PICTURE INVESTMENT (I), First Section:

For Exhibit 3, the basic element's pre asset operating performance is a flat $99 for five periods (Exhibit 3A, Exhibit 3B and Exhibit 3D, Line [3]). Exhibit 3's flat pre asset operating performance eliminates pre asset operating performance as a reconciling item when comparing FPI with the traditional tools. Exhibit 3's focus is on a non depreciating asset's sale price and its difference with a traditional tool sale price (future value). Exhibit 3's other basic elements IER and Initial Cost remain at Exhibit 2's 20%, Line [1] and $2,000, Line [2].

As previously discussed, category C investment questions solve for period one pre asset operating performance. Remaining two through five pre asset operating performances are sequential percentages relative to the previous period. Period one percent is always 100%. In Exhibit 3C, FIG. 34, Line [11] each subsequent period is also 100% percent to maintain the level non-varying pre asset operating performance. The affirming financial statement's category 3C solves for the $99 pre asset operating performance, Line [3]. For investment question categories A, B and D pre asset operating performance prior period percent assumption, Line [11] is not applicable.

Exhibit 3's Sale Price Book Value percent assumption is set at 140% for categories A, B and C, Line [4]. For category D, the Asset Sale Price is solved for at $2,800 or a 140% Sale Price Book Value.

Debt Capital Structure Weight, Line [6] remains at 80%. External debt financing is eighty percent and the resultant equity at twenty percent throughout the investment question's duration. The Debt Rate, Line [7] on outstanding debt remains at 4.2%. The user-defined Secondary Flow Return Rate, Line [8] remains 5.4% after tax. The income statement's Asset O&M and Property Tax, Line [9] is set to 0%.

The Depreciable Asset TRUE/FALSE switch, Line [10] selects whether the investment question contains a depreciable or a non depreciable asset. For Exhibit 3 the depreciable asset switch is set to FALSE. When the depreciable asset switch is set to FALSE the asset salvage (disposal) assumption, Line [5] is used initially for depreciation purposes but then reversed for ending investment question calculations. The last period's non zero book value precludes an asset salvage (disposal).

### Exhibit 3, FULL PICTURE FINANCIAL STATEMENTS (II), Second Section:

Although Exhibit 3's assumptions differ from Exhibit 2, the structure and format of the balance sheet, income statement, cash change in owner's equity and equity statement are identical. Again, the financial statements are produced just once for all four A, B, C and D categories. Exhibit 3 ABC&D financial statements are found on FIGS. 42 through 45.

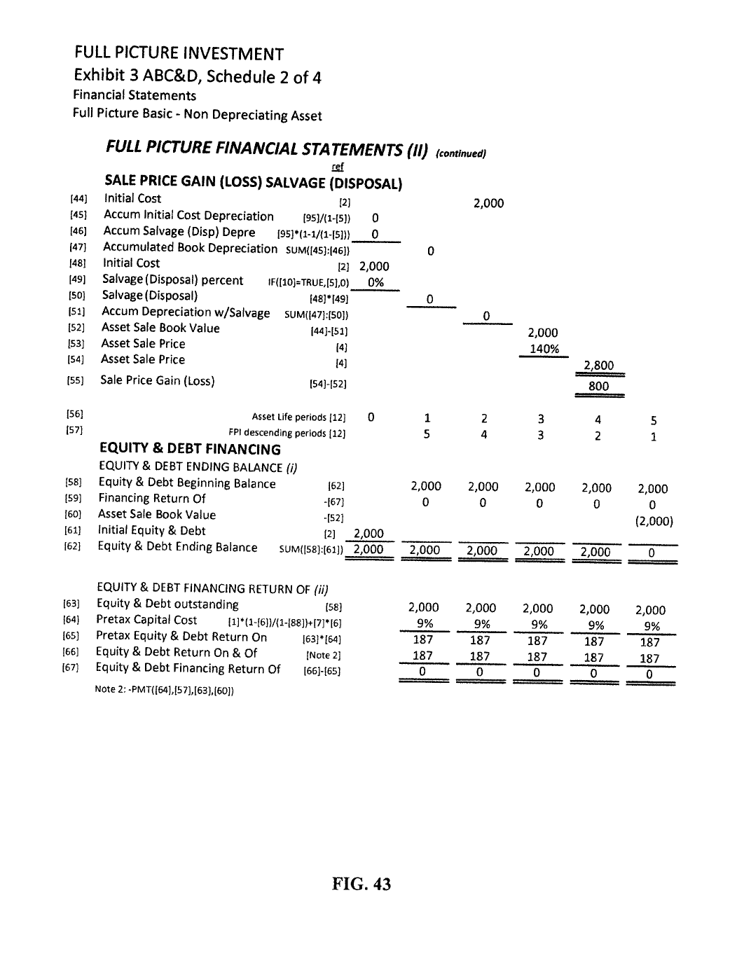

The detail surrounding equity and debt financing is still found in three pieces starting in Schedule 2, FIG. 43, Line [58], EQUITY & DEBT ENDING BALANCE (i), continuing on Line [63], EQUITY & DEBT FINANCING RETURN OF (ii) and finishing on Line [69], DEBT ISSUANCE (REPURCHASE) (iii).

The first piece EQUITY & DEBT ENDING BALANCE (i), Line [58] tracks outstanding equity and debt financing. For a non depreciating asset there is no periodic reduction in financing. The initial equity and debt balance, Line [61] matches the ending period asset sale book value, Line [62].

The next equity and debt financing piece is EQUITY & DEBT FINANCING RETURN OF (ii) starts on Line [63]. Equity and debt outstanding is multiplied by pretax capital cost to create the Pretax Equity & Debt Return On, Line [65]. The combined Equity & Debt Return On & Of, Line [66] is calculated by using the PMT( )function. The equity & debt return ‘on’ and ‘of’ matches the pretax equity and debt return ‘on’. The matching leaves equity & debt return ‘of’ at $0, Line [67] for the non depreciating asset.

The third equity and debt financing piece is DEBT ISSUANCE (REPURCHASE) (iii). Beginning Equity and Debt Balance, Schedule 3, Line [69] and Ending Equity and Debt Balance, Line [72] are multiplied by the Debt Capital Structure Weight, Lines [70] and [73] to calculate Beginning and Ending Debt Balance, Lines [71] and [74]. For periods one through four the Debt Issuance (Repurchase) is $0, Line [75] for Exhibit 3's non depreciating asset.

The Exhibit 3 ABC&D income statement, FIG. 42, Line [20] contains Pre Asset Operating Performance, Interest Expense and Income Tax line items. Depending on the investment category being solved, pre asset operating performance comes directly from Line [3] or in the case of investment category C be calculated in the financial statements on Line [20]. Interest Expense detail is shown on Lines [79] through [81]. Although the Income Tax Rate is set to zero, Income Tax detail is shown on Lines [82] through [89]. Interest expense and income taxes are internalized in the full picture factor's pretax capital cost. Actual income statement presentation is included to highlight pretax capital cost's summarizing function in FPI's methodology.

Sale Price Gain (Loss), Line [23] is $800 in Exhibit 3 ABC&D. Detail for the asset sale gain (loss) is shown on, FIG. 43, Lines [44] through [55].

The secondary flow return after tax, Line [26] is $0. Exhibit 3's non depreciating nature does not generate any secondary flow balances and thus no secondary flow returns.

The income statement's net income operating performance, Line [27] flows to the owner's equity statement on Line [38].

The cash change in owner's equity statement has a $2,000 Sale Price Book Value, Line [31] in the last period.

Cash change in owner's equity bottom line, Line [36] flows into the owner's equity statement on Line [39].

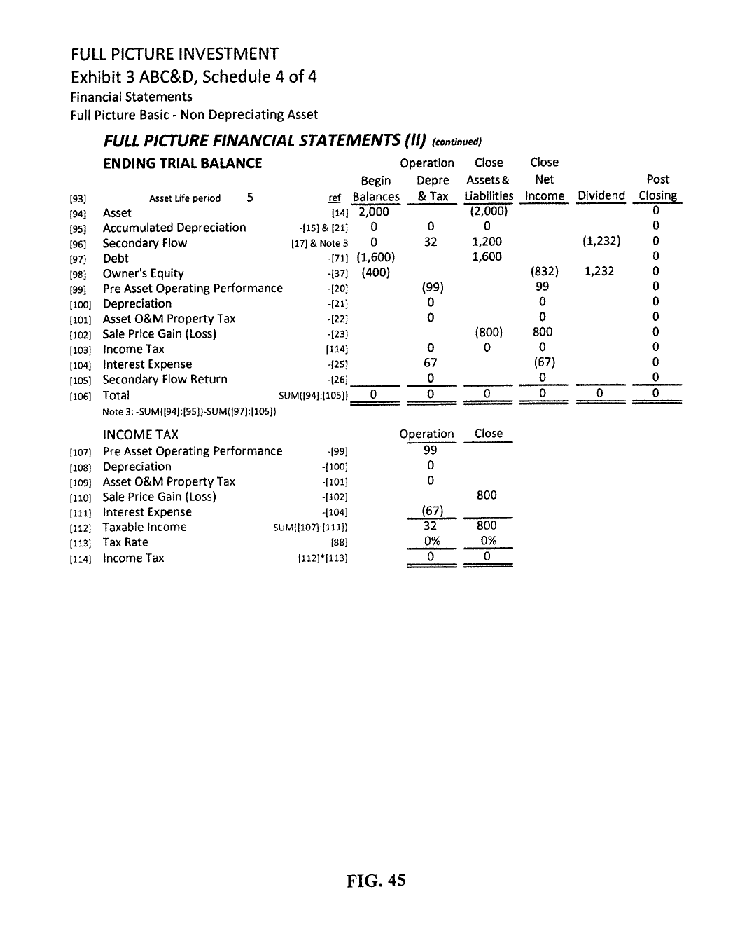

Also in Exhibit 3 ABC&D's second (II) section is an Ending Trial Balance at period five, FIG. 45. The trial balance starts with period four's ending balances as beginning balances in column one. The second column captures the last period's operations, depreciation and tax. Entries to recognize the asset sale and close the balance sheet are in column three. Closing the balance sheet sets up net income operating performance for closure to owner's equity in column four. Finally, dividends are paid in column five to close out the financial statements in column six. Explicit details surrounding an investment question's trial balance and closing entries gives business professionals further investment decision comfort.

### Exhibit 3, VISUALIZE FULL PICTURE INVESTMENT (III), Third Section:

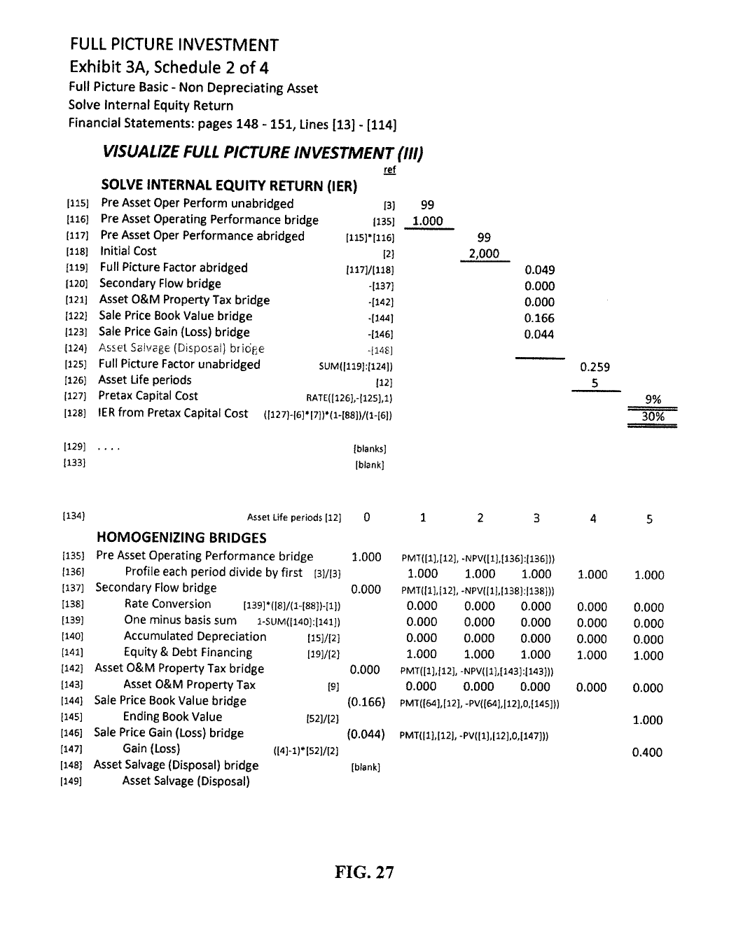

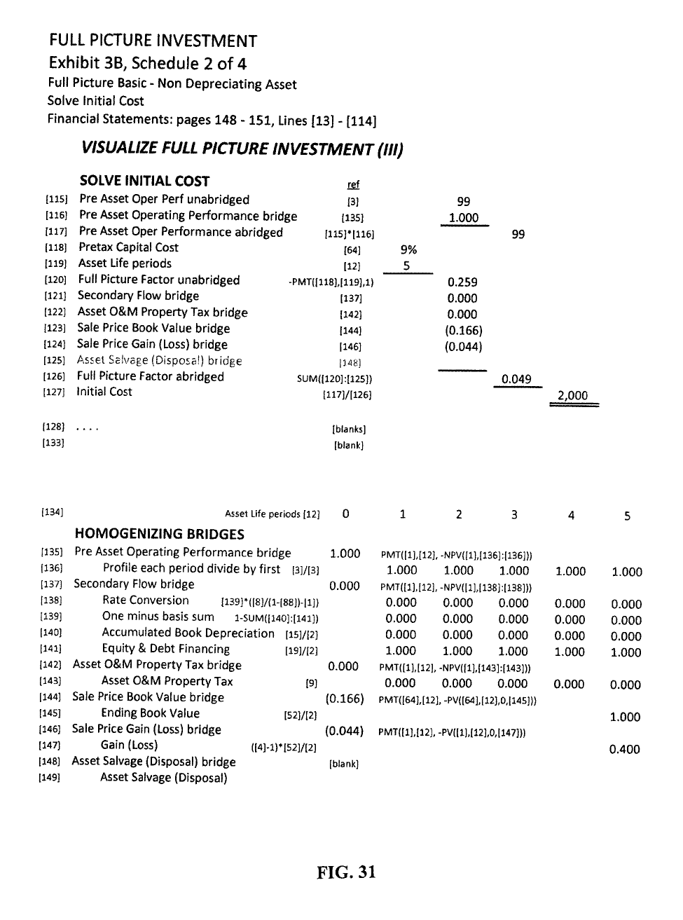

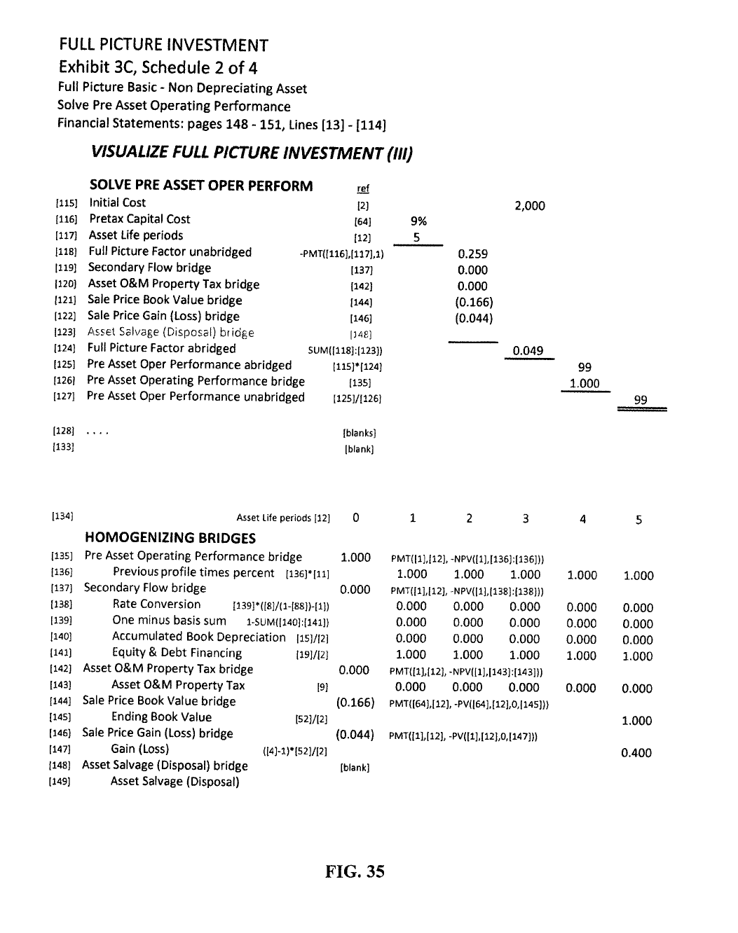

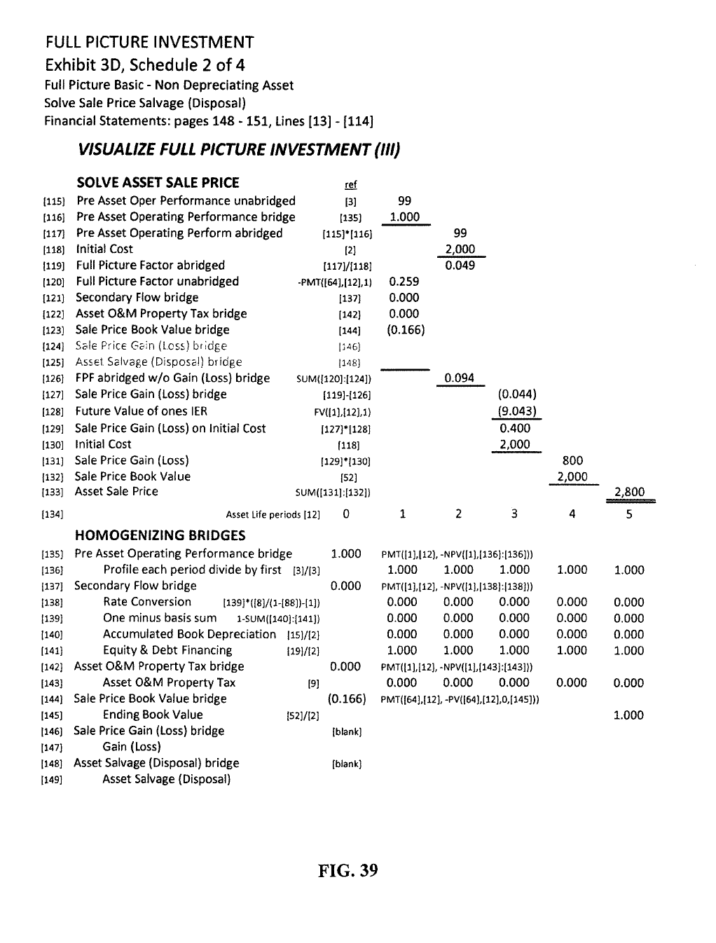

Exhibit 3A, Schedule 2, FIG. 27, Exhibit 3B, FIG. 31, Exhibit 3C, FIG. 35 and Exhibit 3D's FIG. 39, third section VISUALIZE FULL PICTURE INVESTMENT, begin on Line [115] and continue through Line [149] for all four investment categories.

As a recap, Exhibit 3A, 3B and 3C's VISUALIZE FULL PICTURE INVESTMENT third section works in identical fashion to Table 8's Basic Elements Relationships. Exhibit 3A, 3B and 3C have two FPI basic elements as assumptions and solve for the third basic element. However, Sale Price Salvage (Disposal) Exhibit 3D is different. In Exhibit 3D, the three FPI basic elements are known assumptions and the Asset Sale Price component is the item solved, not a basic element. Exhibit 3D, Schedule 2, FIG. 39, solves for the (0.044) Asset Sale Gain (Loss) bridge, Line [127] and further converts it to the $2,800 FPI Asset Sale Price answer, Line [133].

Exhibit 3's third section focus is on the two Sale Price bridges. The homogenizing discount rate depends on whether the item is income based or balance sheet based. The Asset Sale Price is a contrasting homogenizing example. The $2,800 asset sale price is comprised of two pieces. There is a $2,000 Book Value amount and a $800 Gain. The (0.166), Line [144] Asset Sale Book Value bridge is balance sheet based and therefore uses pretax capital cost to homogenize. Exhibits 3A, 3B and 3C's (0.044) Sale Price Gain (Loss) bridge, Line [146] homogenizes the single period 0.400, Line [147] sale price gain assumption (140%−100%). The Sale Price Gain (Loss) bridge is income statement based and therefore uses IER to homogenize. Although, the two individual Book Value and Gain bridges are subsets to the overall Asset Sale Price the two bridges have different homogenizing rates due to differing financial orientations. Both sale price bridges adjusts the full picture factor. See Exhibit 3A, FIG. 27, Lines [122] & [123], Exhibit 3B, FIG. 31, Lines [123] & [124] and Exhibit 3C, FIG. 35, Lines [121] & [122].

For Exhibit 3D, FIG. 39, the (0.044) sale price gain (loss) bridge, Line [127] is the item being solved. The three basic elements (full picture factor, initial cost and pre asset operating performance) are all known, unlike categories A, B and C exhibits.

Again, at a holistic level, FPI's investment structure demonstrates its versatility for a non depreciating asset outside of the three basic elements. Exhibit 3A, 3B and 3C's sale price gain (loss) bridge can not only be included as a homogenized assumption germane to an investment question, in Exhibit 3D, the former assumption can also be turned around into a homogenized bridge to be solved and converted into an investment question's answer—through applying FPI's synchronicity methodology.

For Exhibit 3A, FIG. 27, Line [117], the $99 pre asset operating performance divided by the $2,000 initial cost forms a 0.049 abridged full picture factor. The abridged full picture factor less the sale price book value bridge and the sale price gain (loss) bridge equals the 0.259 unabridged full picture factor. The unabridged full picture factor combined with five periods generates the 9% 2 pretax capital cost, Line [127]. Line [127]'s 9% pretax capital cost converted to IER, Line [128] matches the 30% FPI answer on Line [1].

For Exhibit 3B, FIG. 31, the unabridged full picture factor, Line [120] plus the sale price book value bridge and the sale price gain (loss) bridge equals the 0.049 abridged full picture factor. Line [117]'s $99 pre asset operating performance divided by the 0.049 abridged full ² The actual number is 9.36%. 9% is used for readability picture factor forms the $2,000 initial cost. Line [127]'s $2,000 initial cost matches the FPI answer on Line [2].

For Exhibit 3C, FIG. 35, the 0.259 unabridged full picture factor, Line [118] plus the sale price book value bridge and the sale price gain (loss) bridge equals the 0.049 unabridged full picture factor. The $2,000 initial cost multiplied by the 0.049 abridged full picture factor forms the $99 abridged pre asset operating performance. The abridged pre asset operating performance divided by the 1.000 pre asset operating performance bridge forms the period one's pre asset operating performance. Line [127]'s $99 unabridged pre asset operating performance equals the FPI answer on Line [3].

For Exhibit 3D, FIG. 39, the difference between the 0.049 abridged full picture factor, Line [119] and the abridged full picture factor without sale price gain (loss) bridge, Line [126] is the (0.044) sale price gain (loss) bridge, Line [127]. The sale price gain (loss) bridge is used to calculate the sale price gain (loss) on initial cost, Line [129]. The sale price gain (loss) on initial cost generates the asset sale gain, Line [131]. The asset sale gain plus the sale price book value equals the asset sale price, Line [133].

In summary, moving to more real world investment situations requires new investment question assumptions. New assumptions require adjustments utilizing FPI's core methodology to maintain synchronicity around the investment structure. FPI bridges are the mechanisms to facilitate needed adjustments.

Exhibit 3, FULL PICTURE INVESTMENT vs. TRADITIONAL TOOLS (IV), Fourth Section:

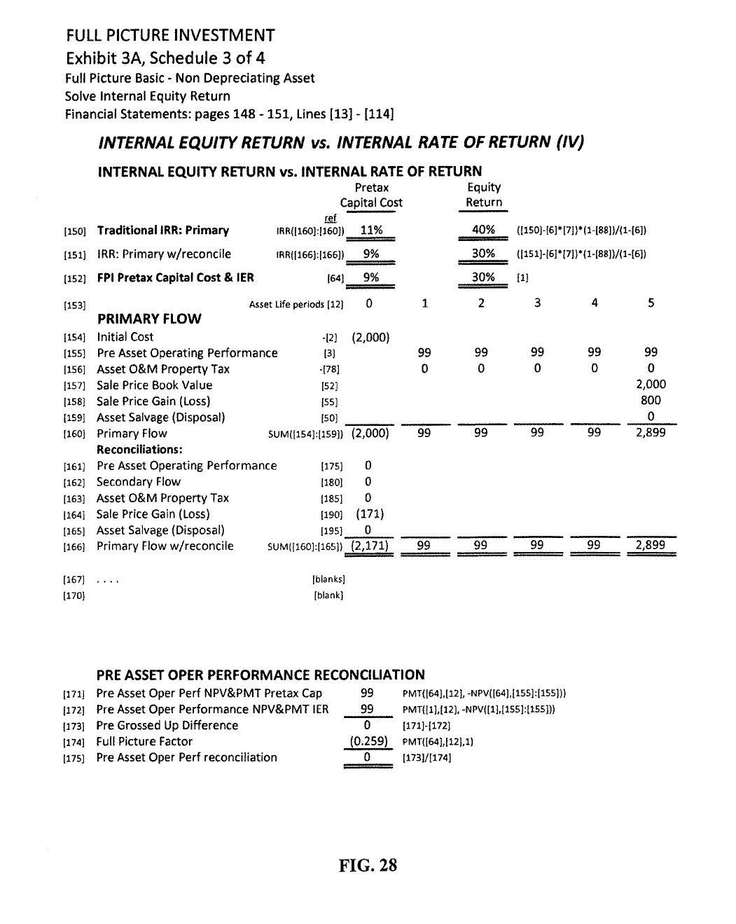

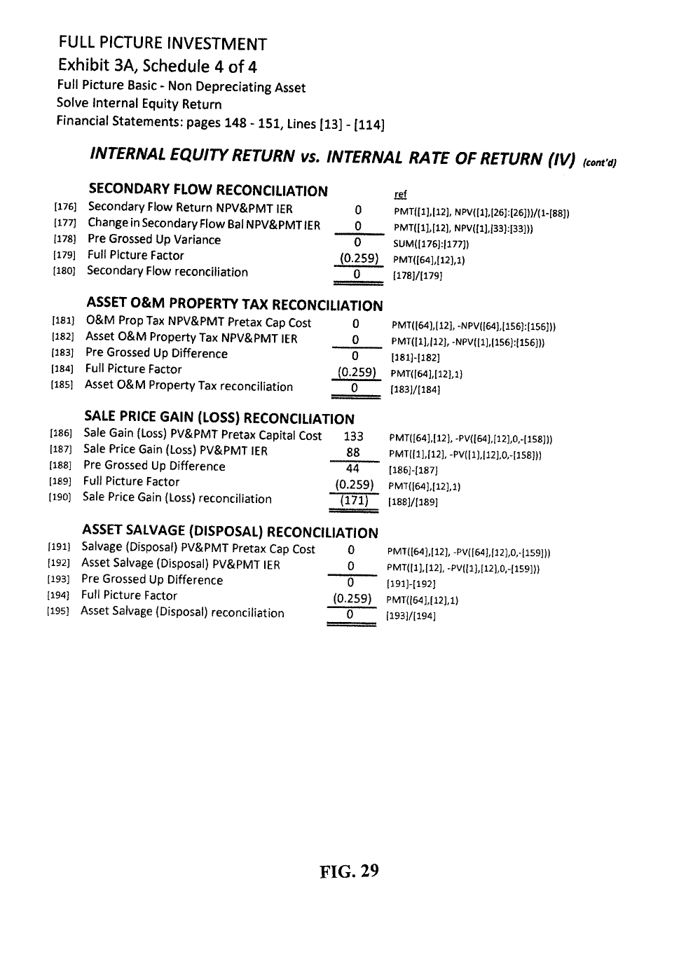

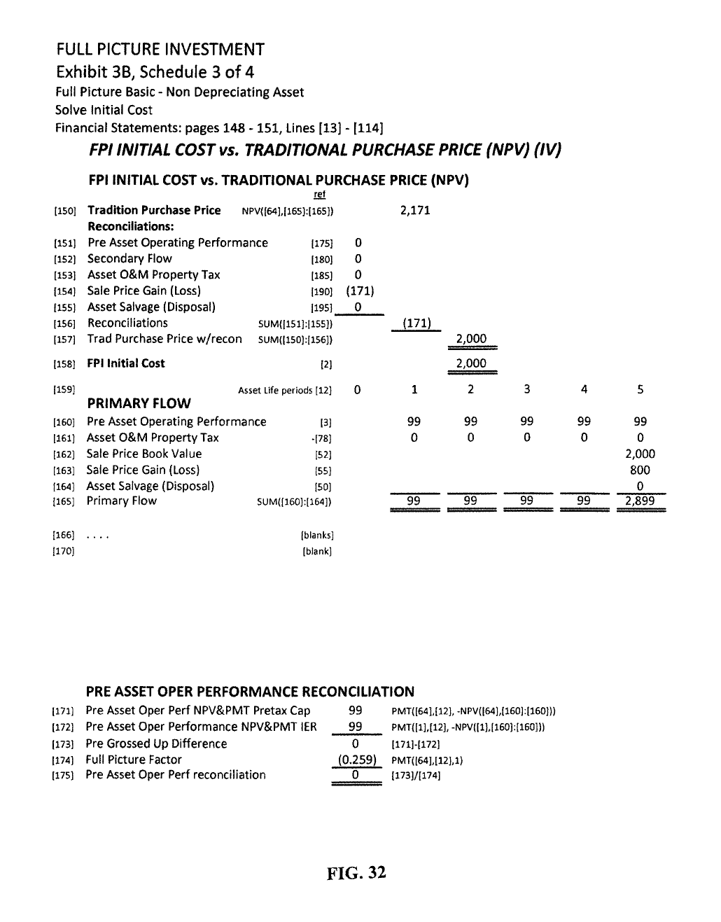

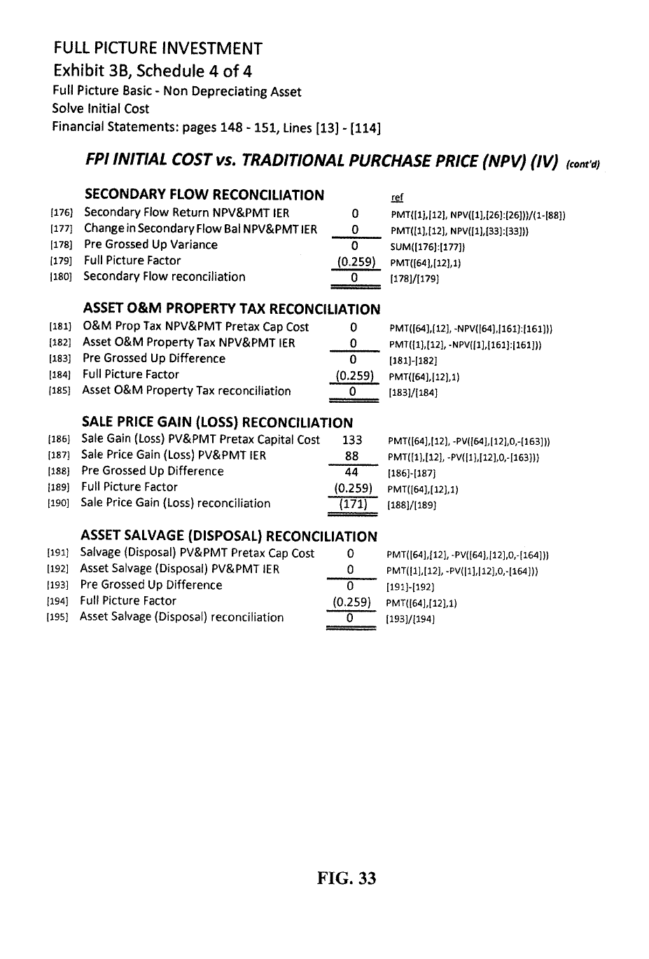

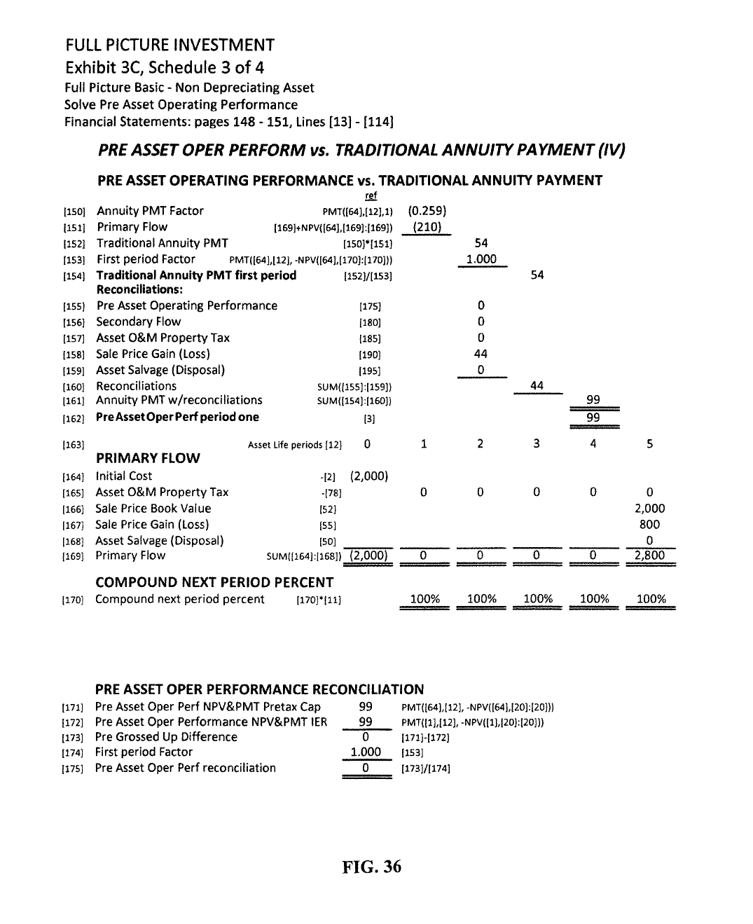

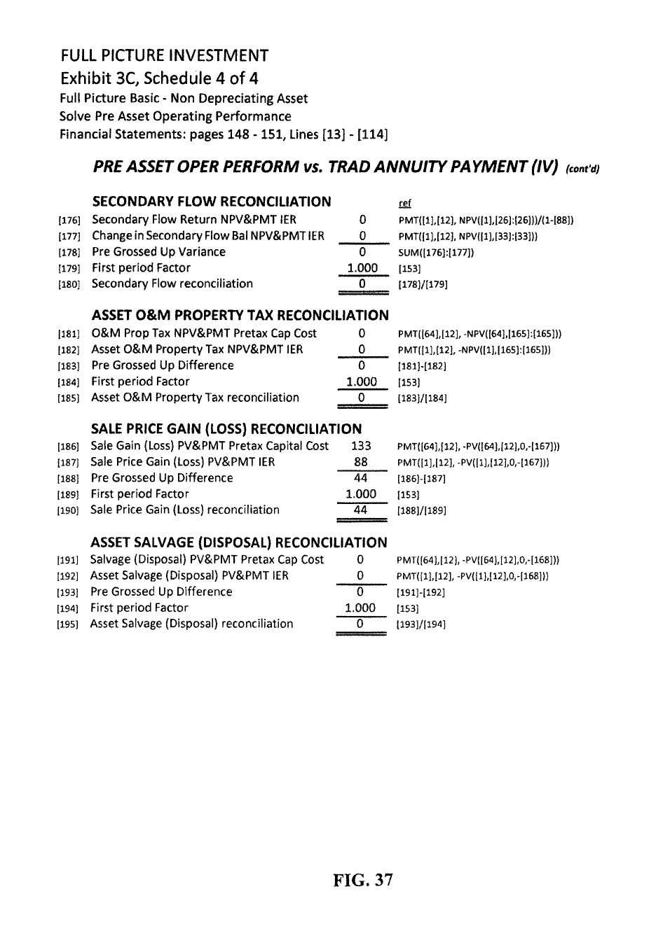

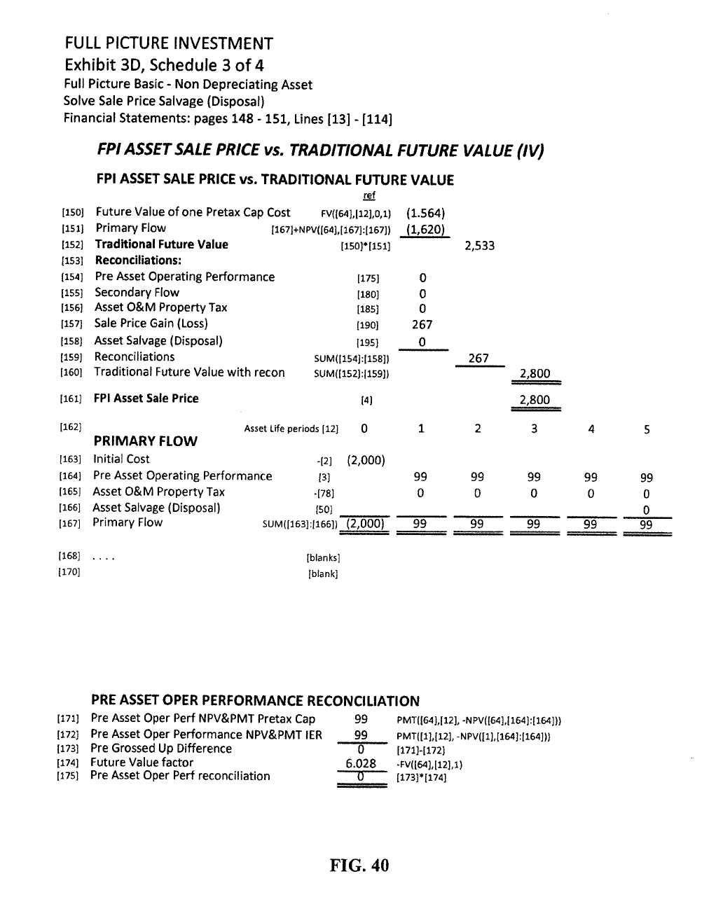

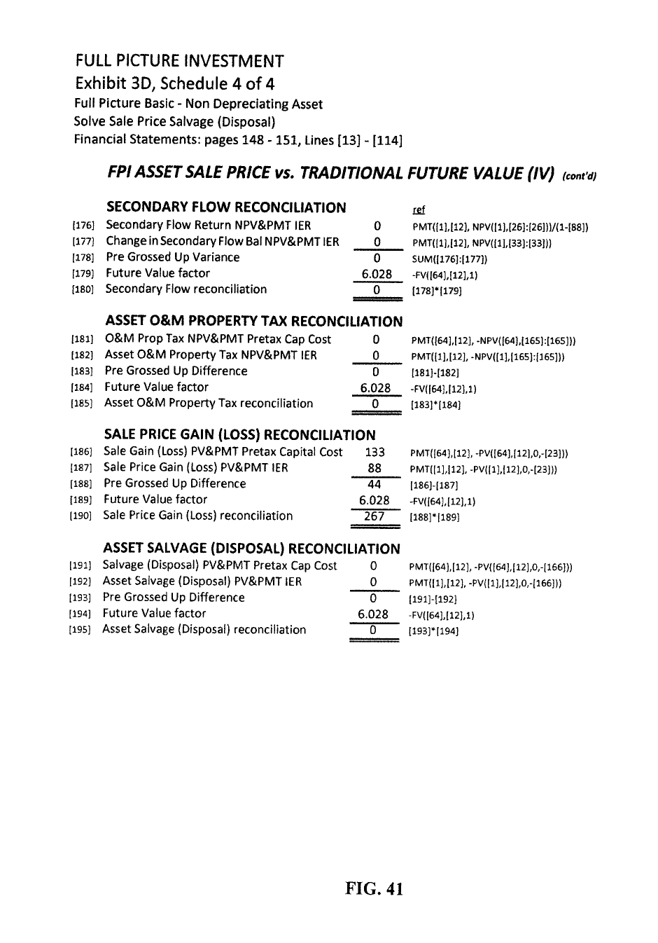

Exhibit 3A, Schedule 3, FIG. 28, Exhibit 3B, FIG. 32, Exhibit 3C, FIG. 36 and Exhibit 3D's FIG. 40, fourth section starts on Line [150]. The fourth section highlights FPI and traditional tool differences. Each section starts with calculating the traditional tool answer for a question category and then reconciles it to the FPI answer (Exhibit 3A—IER vs. IRR; Exhibit 3B—Initial Cost vs. Purchase Price (NPV); Exhibit 3C—Pre Asset Operating Performance vs. PMT Annuity; and Exhibit 3D—Asset Sale Price vs. Future Value.

The fourth (IV) section traditional tool calculations use the investment question's primary flow to answer investment question. The primary flows are found at Exhibit 3A, FIG. 28, Line [160], Exhibit 3B, FIG. 32, Line [165], Exhibit 3C, FIG. 36, Line [169] and Exhibit 3D, FIG. 40, Line [167]. For investment question category C the compound next period percent, Exhibit 3C, FIG. 36, Line [170] is used to drive the first period factor, Line [153]. In Exhibit 3, the non-varying pre asset operating performance generates an expected 1.000 first period factor.

Reconciliations are calculated to corroborate the differences between the traditional tool and FPI answers to investment questions. The reconciliation amounts take an investment question's component and homogenizes the component's flow at two different rates. One homogenizing rate is the traditional tool's singular rate. The other rate is the correct FPI rate. The difference between the two homogenizing results is grossed up in a manner governed by the question category solved. The grossed up amount represents the reconciliation.

Not every investment question component requires a reconciling item between FPI and traditional tool answers. There will not be a reconciling item for components where FPI and the traditional tools are both appropriately using pretax capital cost.

In Exhibit 3A, FIG. 28, a 11% traditional tool IRR calculation, Line [150] utilizing Line [160]' s primary flow is compared to a 9% reconciled IRR. Line [151]'s 9% starts with Line [160]'s primary flow and includes reconciliations as totaled on Line [166].

The 11% traditional tool and 9% FPI are both pretax capital cost amounts recognizing debt's presence. Removing debt leverage from pretax capital cost reveal a 40% and 30% equity return (also on Lines [150] and [151]). The difference is found in one reconciling item.

Exhibit 3A's ($171) sale price gain (loss) reconciling item, Line [164] is the difference between the sale price gain (loss), Line [158] homogenized at 9% pretax capital cost, $133, Line [186] and the same sale price gain (loss) homogenized at 30% IER, $88, Line [187]. The difference between the two, $44, Line [188] is grossed up by the (0.259) full picture factor (category A investment question) to finalize the pre asset operating performance reconciliation.

Exhibit 3A shows FPI's answer to the investment question calculated in section one, 30% IER, Line [1] matching the 30% traditional tool reconciled calculation, Line [151].

The traditional IRR tool's 40% equity return, Line [150] is 33% greater than FPI's 30% counterpart, Lines [151] and [152]. Given solve/assumption synchronicity and affirming second (II) section financial statements, business professionals are comfortable portraying the investment question's equity answer at FPI's 30% rather than the traditional tool's 40%.

In Exhibit 3B, FIG. 32, a $2,171 traditional tool purchase price calculation on Line [150], utilizes Line [165]'s primary flow. The $2,171 traditional tool purchase price is reconciled with a FPI $2,000 purchase price on Line [157]. The reconciling $171 purchase price difference is made up of one item.

Exhibit 3B's ($171) sale price gain (loss) reconciling item, Line [154] is the difference between the sale price gain (loss), Line [163] homogenized at 9% pretax capital cost, $133, Line [186] and the same sale price gain (loss) homogenized at 30% IER, $88, Line [187]. The difference between the two, $44, Line [188] is grossed up by the unabridged (0.259) full picture factor (category A investment question) to finalize the pre asset operating performance reconciliation.

Exhibit 3B shows FPI's answer to the investment question calculated in section one, $2,000 Initial Cost, Line [2] matching the $2,000 traditional tool reconciled calculation, Line [157].

The traditional NPV tool's $2,171 purchase price, Line [150] is 9% greater than FPI's $2,000 counterpart, Lines [157] and [158]. Given solve/assumption synchronicity and affirming second (II) section financial statements, business professionals are comfortable portraying the investment question at FPI's $2,000 initial cost rather than the traditional tool's $2,171.

In Exhibit 3C, FIG. 36, a $54 traditional tool pre asset operating performance calculation, Line [154] is reconciled with FPI's $99 pre asset operating performance, Line [161]. The $44 pre asset operating performance difference is made up of one item.

Exhibit 3C's $44 sale price gain (loss) reconciling item, Line [158] is the difference between the sale price gain (loss), Line [167] homogenized at 9% pretax capital cost, $133, Line [186] and the same sale price gain (loss) homogenized at 30% IER, $88, Line [187]. The difference between the two, $44, Line [188] is grossed up by the First period Factor 1.000 (category C investment question) to finalize the pre asset operating performance reconciliation.

Exhibit 3C shows FPI's answer to the investment question calculated in section one, $99 Pre Asset Operating Performance, Line [3] matching the traditional tool reconciled calculation, Line [161].

The traditional PMT tool's $54 annuity first period, Line [154] is $44 different than FPI's $99 counterpart, Lines [161] and [162]. Given solve/assumption synchronicity and affirming second (II) section financial statements, business professionals are comfortable portraying the investment question at FPI's $99 pre asset operating performance rather than the traditional tool's $54.

TABLE 14
FUTURE VALUE CALCULATION - EXHIBIT 3D, FIG. 40
Traditional method (Primary Flow)

| | | | | | | | | | Future |
|---|---|---|---|---|---|---|---|---|---|
| | | ref | 0 | 1 | 2 | 3 | 4 | 5 | Value |
| (a) | One plus Pretax | Note 1 | 1.09\hat{ }5 | 1.09\hat{ }4 | 1.09\hat{ }3 | 1.09\hat{ }2 | 1.09\hat{ }1 | 1.09\hat{ }0 | |
| | Capital Cost raised | | | | | | | | |
| | to a future value | | | | | | | | |
| (b) | Future Value factor | (a) | 1.564 | 1.430 | 1.308 | 1.196 | 1.094 | 1.000 | |
| (c) | Primary Flow | [167] | ($2,000) | $99 | $99 | $99 | $99 | $99 | |
| (d) | FV Sum Across | (b) × (c) | ($3,128) | $141 | $129 | $118 | $108 | $99 | $2,533 |

Note 1:
The actual number is 1.0936 (One plus Exhibit 3 ABC&D, FIG. 43, Line [64])

In Exhibit 3D, FIG. 40, a $2,533 traditional tool future value calculation, Line [152] is reconciled with FPI's $2,800 asset sale price, Line [160]. Table 14 illustrates the typical traditional future value calculation. Each period's unique Future Value factor (Line b) is multiplied by the period's Primary Flow (Line c). The total future value is $2,533 (negative period zero through five summation). Exhibit 3D, FIG. 40, Line [152] takes an alternate approach to get to the same Table 14 traditional tool $2,533 future value.

The reconciling $267 traditional future value difference, Line [159] is made up of one item. Exhibit 3D's sale price gain (loss) reconciling item, Line [157] is the difference between the sale price gain (loss), Line [23] homogenized at 9% pretax capital cost, $133, Line [186] and the same sale price gain (loss) homogenized at 30% IER, $88, Line [187]. The difference between the two, $44, Line [188] is grossed up by the Future Value factor 6.028 (category D investment question) to finalize the pre asset operating performance reconciliation.

Exhibit 3D shows FPI's answer to the investment question calculated in section one, $2,800 Asset Sale Price, Line [4] matching the $2,800 traditional tool reconciled calculation, Line [160].

The traditional NPV tool's $2,533 sale price, Line [152] is 10% less than FPI's $2,800 counterpart, Lines [160] and [161]. Given solve/assumption synchronicity and affirming second (II) section financial statements, business professionals are comfortable portraying the investment question at FPI's $2,800 sale price rather than the traditional tool's $2,533.

All four Exhibit 3A, 3B, 3C and 3D, FULL PICTURE INVESTMENT vs. TRADITIONAL TOOLS pre grossed up reconciliation amounts are identical. The reconciliations stem from homogenizing components at IER versus pretax capital cost or from user-defined secondary flow rate versus IER. The reconciliation differences between the four categories comes from the gross-up factor associated with the investment question's category. The non-grossed up sale price gain (loss) is $44 for the four question categories. Identical reconciliation items show the traditional tools and FPI are acting in a similar manner around investment questions sharing the same assumptions. The traditional tools are consistently and incorrectly applying pretax capital cost to the primary flow. FPI is correctly applying the appropriate rate to an investment question's individual components.

In Exhibit 1 there were no differences and hence no reconciliations between the traditional tools and FPI. Exhibits 2 and 3 show how identical pre grossed-up reconciliations amongst the categories point to FPI still fundamentally grounded with the traditional tools. In Exhibits 2 and 3 the only difference between the traditional tools and FPI are the FPI bridges necessary to maintain FPI's investment structure.

Table 15 demonstrates Exhibit 3's continued FPI solve/assumption synchronicity with a non depreciating asset. FPI's columns (a), (c), (e) and (g) are identical. None of the traditional tool's columns (b), (d), (f) and (h) match.

TABLE 15
SOLVE/ASSUMPTION SYNCHRONICITY - EXHIBIT 3

| | Question Category | | | | | | | |
|---|---|---|---|---|---|---|---|---|
| | A - Equity | | | | C - Oper | | | |
| | Return | | B - Initial Cost | | Perform | | D - Sale Price | |
| | FPI | IRR | FPI | NPV | FPI | PMT | FPI | FV |
| | (a) | (b) | (c) | (d) | (e) | (f) | (g) | (h) |
| Equity Return | 30%* | 40%* | 30% | 30% | 30% | 30% | 30% | 30% |
| Initial Cost | $2,000 | $2,000 | $2,000* | $2,171* | $2,000 | $2,000 | $2,000 | $2,000 |
| Pre Asset Oper | $99 | $99 | $99 | $99 | $99* | $54* | $99 | $99 |
| Performance | | | | | | | | |
| Asset Sale Price | $2,800 | $2,800* | $2,800 | $2,800 | $2,800 | $2,800 | $2,800* | $2,533* |

*Indicates a solve for item

FPI demonstrates its flexibility in being able to accommodate both depreciation and non depreciating assets while maintaining solve/assumption synchronicity.

### Full Picture

Beginning the first year of an asset's eleven year life and given the asset's initial cost and next five year operating performances what is the future asset sale price at the end of year five necessary to earn a targeted equity return over the five years?

Exhibit 4 discussion introduces new investment question assumptions. Exhibit 4's assumptions further build upon the assumptions in previous Exhibits. The following is Exhibit 4's assumption addition list:

Asset Life periods

Book Depreciation method

Income Tax Rate percent

Interest Tax Deductibility percent

Tax Life periods

Tax Depreciation method

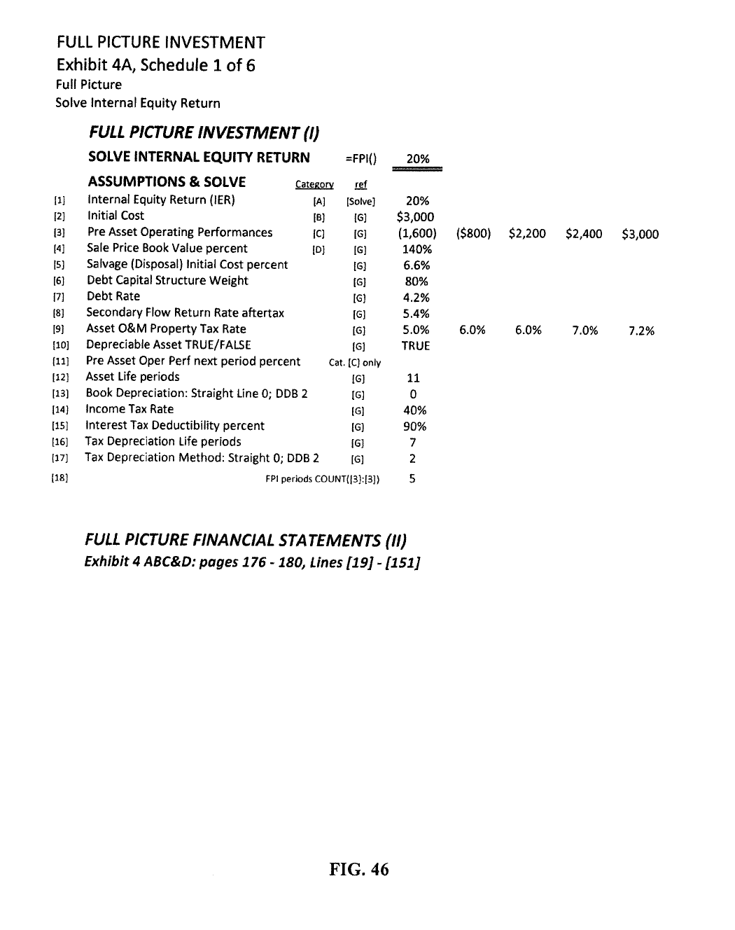

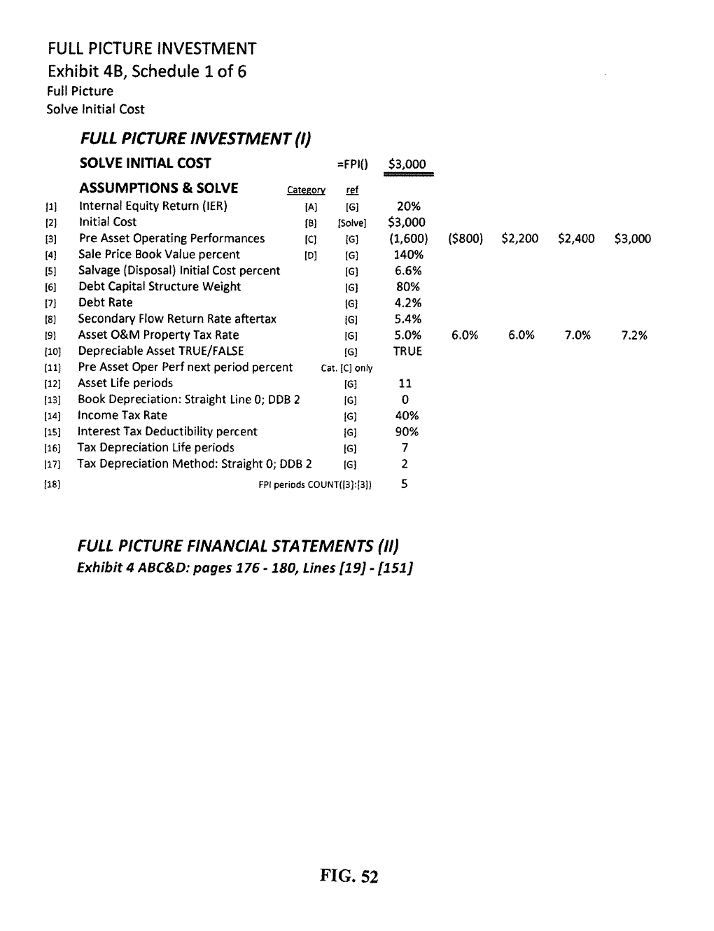

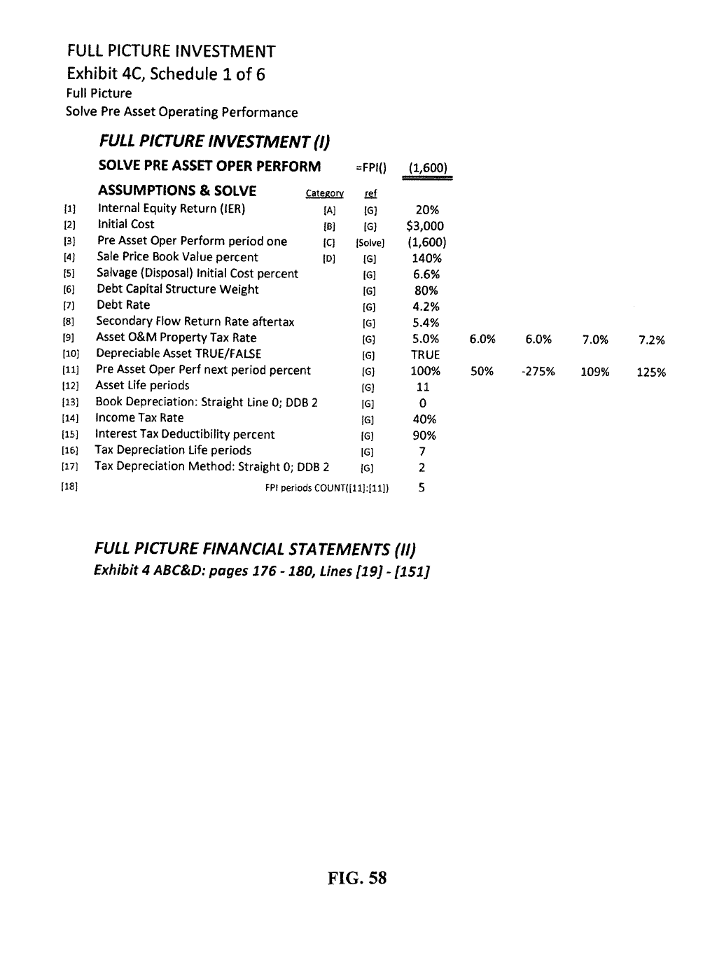

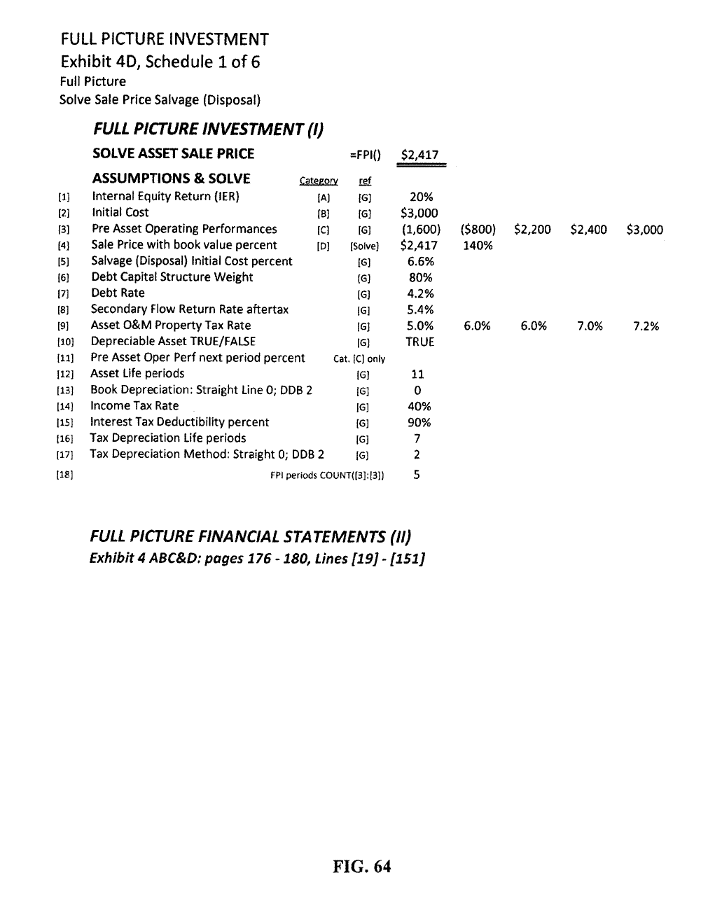

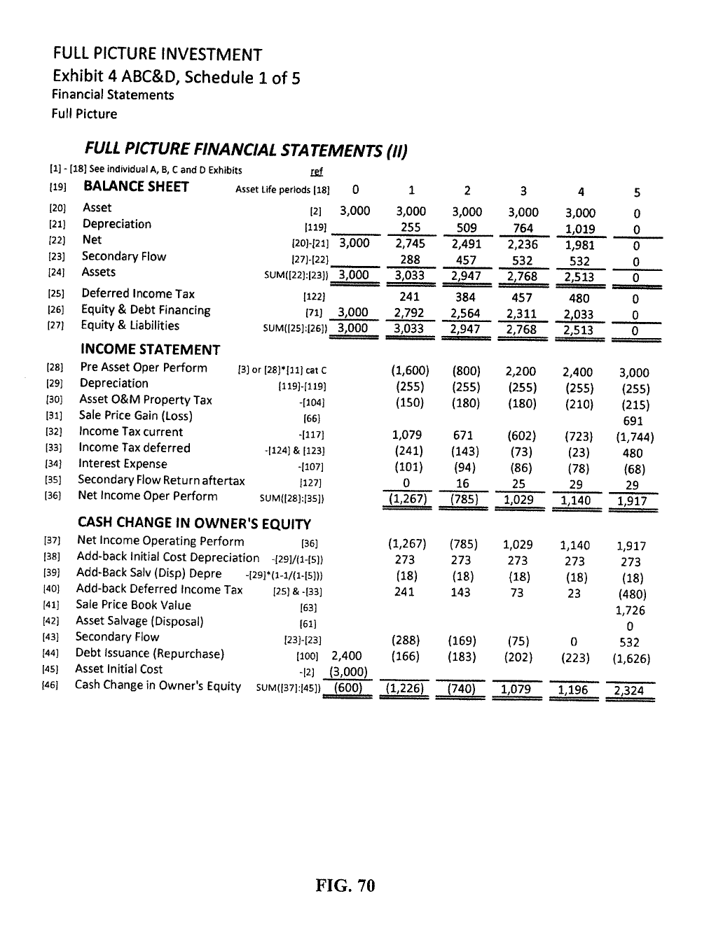

Exhibit 4A is found on FIG. 46, 4B on FIG. 52, 4C on FIG. 58 and Exhibit 4D on FIG. 64. The single set of Exhibit 4 ABC&D financial statements is found at the end of Exhibit 4 on FIGS. 70-74, Lines [19]-[151]. Exhibit 4 focuses on a depreciating asset like Exhibit 2. However, unlike Exhibit 2, Exhibit 4 has an asset sale at the end of the investment question before the end of the asset's life.

The new items introduced in Exhibit 4 moves answering investment questions to a framework for depicting even more realistic investment questions. Exhibit 4 also furthers the distinction between the traditional tools and FPI.

Often competing investment question time frames do not line-up with one and another. An investment choice dealing with buildings is a classic example. Is it better to build a new building or buy and renovate an existing building? The building choice is expected to have different expense and maybe even revenue assumptions between the build new versus buy and renovate scenarios but there should not be a difference in time frames. Chances are the new building's life expectancy is longer than the buy and renovate option. To create comparability between the two investment questions the new building's theoretical sale at the renovate option's life expectancy is necessary. FPI's Sale Price Book Value percent and other depreciation techniques allow for the new building's theoretical sale as an assumption. The example's two competing building investment choices are now on comparable equal footing when utilizing the same time frame.

### Exhibit 4, FULL PICTURE INVESTMENT (I), First Section:

The new Asset Life periods assumption, FIG. 46, Line [12] recognizes an asset's physical life exceeding the investment question's life. In Exhibits 1, 2 and 3 the investment question's life matched the asset life. Asset lives can now not only match but now exceed investment question's life. The asset life can not be less than FPI's investment question life, Line [18].

In Exhibit 4 specifically, the asset's expected life is eleven periods compared to the investment question's five period length. This leaves six asset periods to occur at the investment question's end—outside the investment question.

A depreciable asset has depreciation attributes to define the asset's physical consumption or depletion over time. The book depreciation assumption, Line [13] provides an indicator as to whether the book depreciation technique is straight-line or a multiple of declining balance depreciation. The asset life periods assumption, book depreciation method and initial cost formulate book depreciation expense.

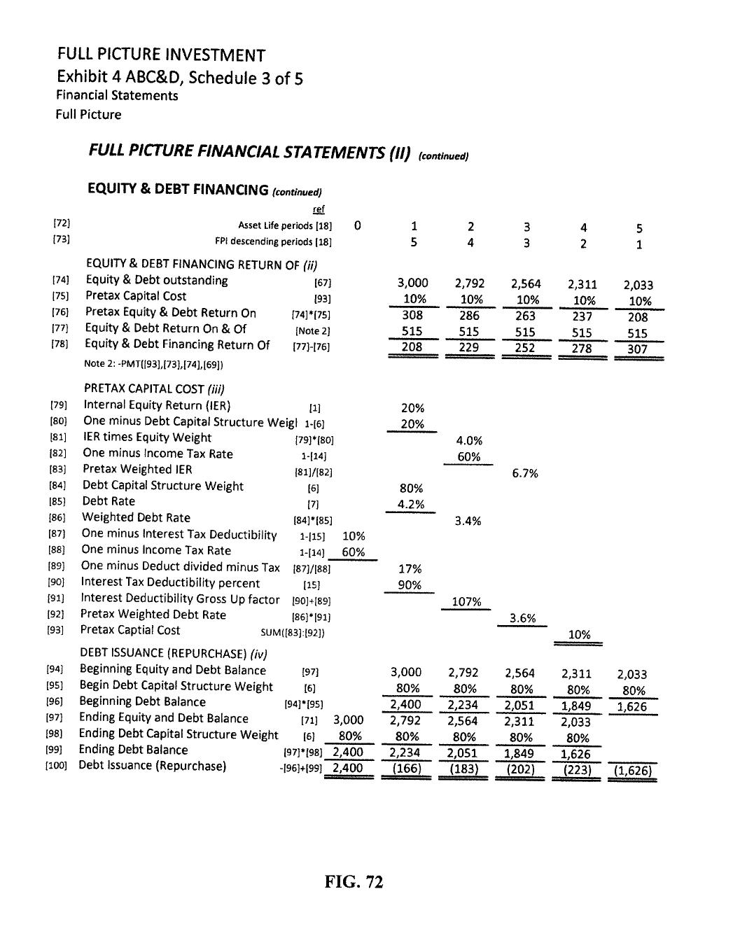

The income tax rate assumption in Exhibit 4 is 40%, Line [14]. Interest tax deductibility is a recent topic and is incorporated in FPI's methodology. Today's, debt interest is 100% deductible for income tax purposes. Recent tax policy discussion is questioning whether this should remain 100%. FPI's flexible structure has included an assumption to accommodate a interest deductibility percent for amounts less than 100%. Exhibit 4's interest tax deductibility percent is 90%, Line [15]. The 90% interest tax deductibility assumption impacts the pre tax capital cost calculation in the financial statements, FIG. 72, Lines [87] and [90].

Tools to answer depreciable Exhibit 4 investment questions with income taxes need to incorporate accelerated tax depreciation's significant cash flow impact. A tax code's accelerated depreciation is aimed at influencing macro economic outcomes and not necessarily a particular asset's consumption or deterioration time frame. Accelerated income tax depreciation and subsequent deferred tax is invoked through both shorter tax lives and front loaded tax depreciation techniques. FPI's accelerated depreciation is effectuated through tax life periods assumptions, Line [16] and depreciation techniques assumptions, Line [17]. Exhibit 4's accelerated tax depreciation assumes a seven period tax life (versus an eleven period asset life) and a double declining balance depreciation method.

Both book and tax depreciation techniques switch to straight-line for remaining periods when straight-line is larger than a multiple declining balance method.

### Exhibit 4, FULL PICTURE FINANCIAL STATEMENTS (II), Second Section:

Again, the new Exhibit 4 assumptions have minimal changes on the existing financial statements from Exhibit 3. The new assumptions create an Exhibit 4 ABC&D, FIG. 70, Deferred Income Tax, Line [25] balance sheet item. The income statement has one new line. Accelerated tax depreciation's introduction has created a need to bifurcate income taxes between current and deferred, Lines [32] and [33]. The cash change in owner's equity has one new line item. There is an add-back item for deferred income tax, Line [40]. The owner's equity statement's components are unchanged from Exhibit 3.

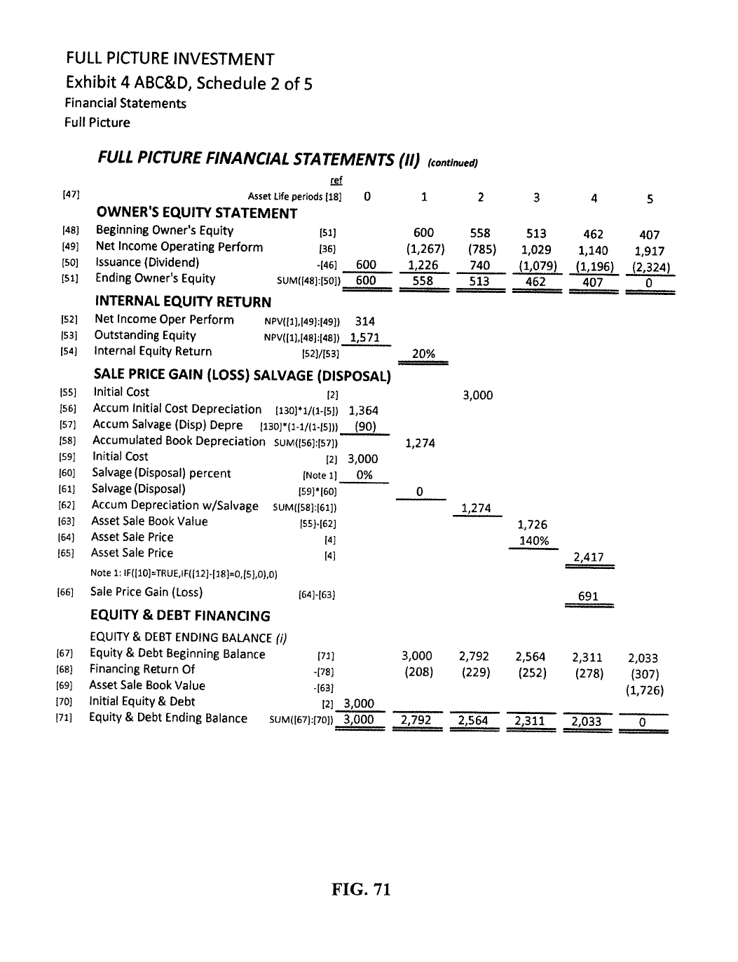

Exhibit 4's EQUITY & DEBT FINANCING pieces (i)-(iv) are found in Exhibit 4's financial statements, starting at the bottom of FIG. 71. Pieces one (i) and two (ii) work similar to Exhibit 3 pieces (i) and (ii). Exhibit 4's EQUITY & DEBT FINANCING piece (iii), FIG. 72 now details the Pretax Capital Cost calculation. Pretax capital cost's staircase detail is presented on Lines [79] through [93]. In Exhibit 4, DEBT ISSUANCE (REPURCHASE) is similar to Exhibit 3 and is moved to piece four (iv), Lines [94]-[100].

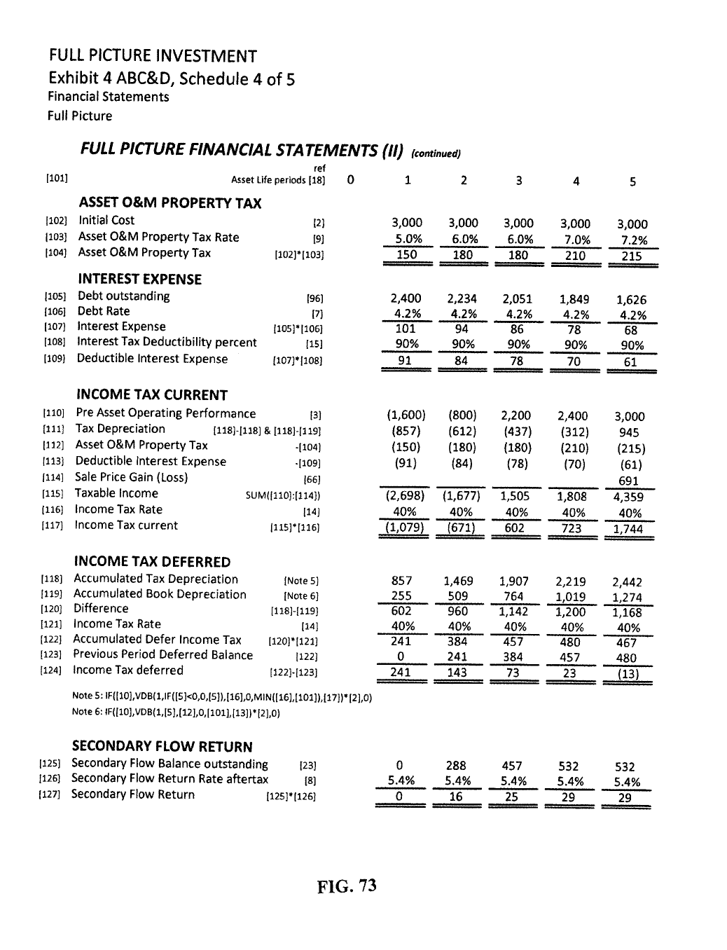

Interest expense detail is extended to consider the income tax deductibility assumption. See Exhibit 4's, FIG. 73, Lines [108] and [109].

In Exhibit 4, the income tax calculation is differentiated between current and deferred. The current income tax calculation is modified by replacing book depreciation with tax depreciation, Line [111] to form current taxable income, Line [115]. The deferred income tax calculation detail is shown on Exhibit 4, FIG. 73, Lines [118] through [124].

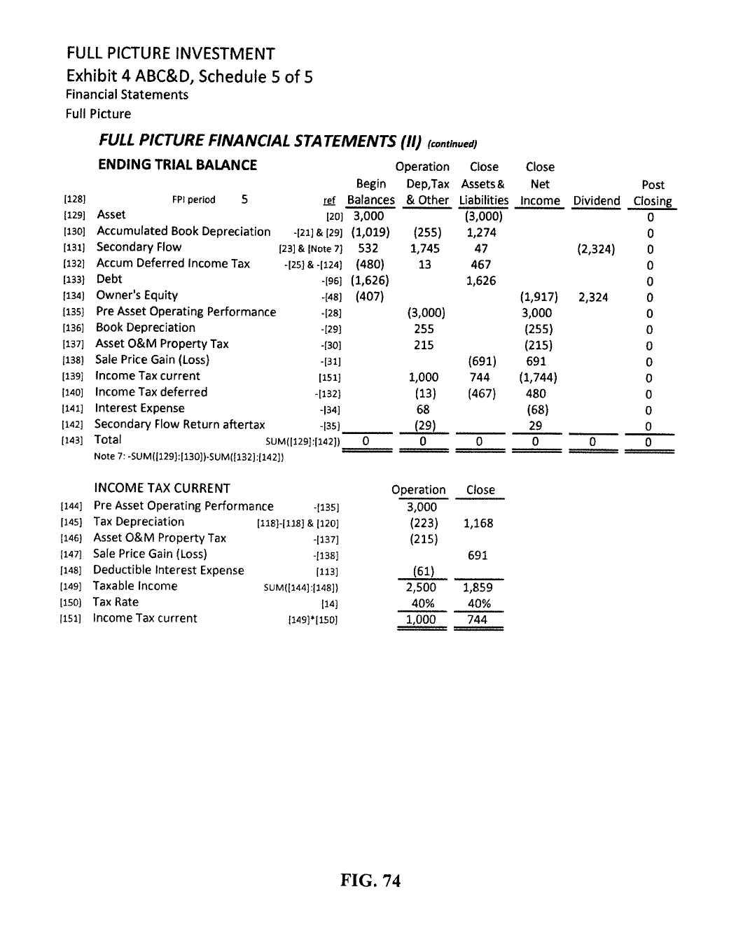

FIG. 74's ending trial balance contains the new Exhibit 4 assumptions. See Lines [129] through [151].

Although Exhibit 4's financial statements do not change significantly from Exhibits 2 and 3, in Exhibit 4's third (III) section there is significant additional activity going on relative to FPI's methodology.

### Exhibit 4, VISUALIZE FULL PICTURE INVESTMENT (III), Third Section:

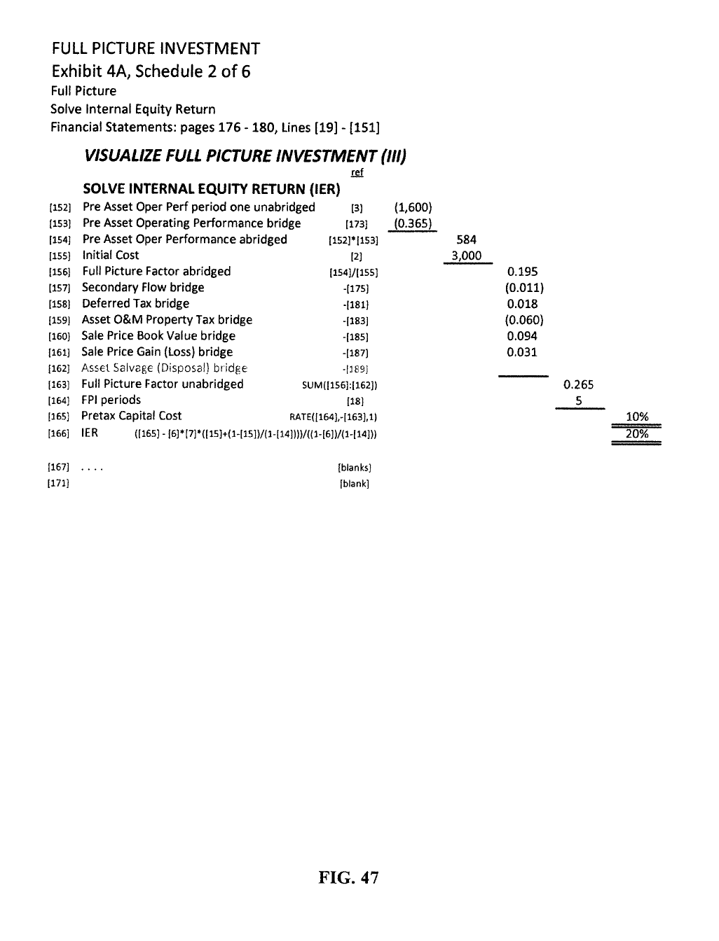

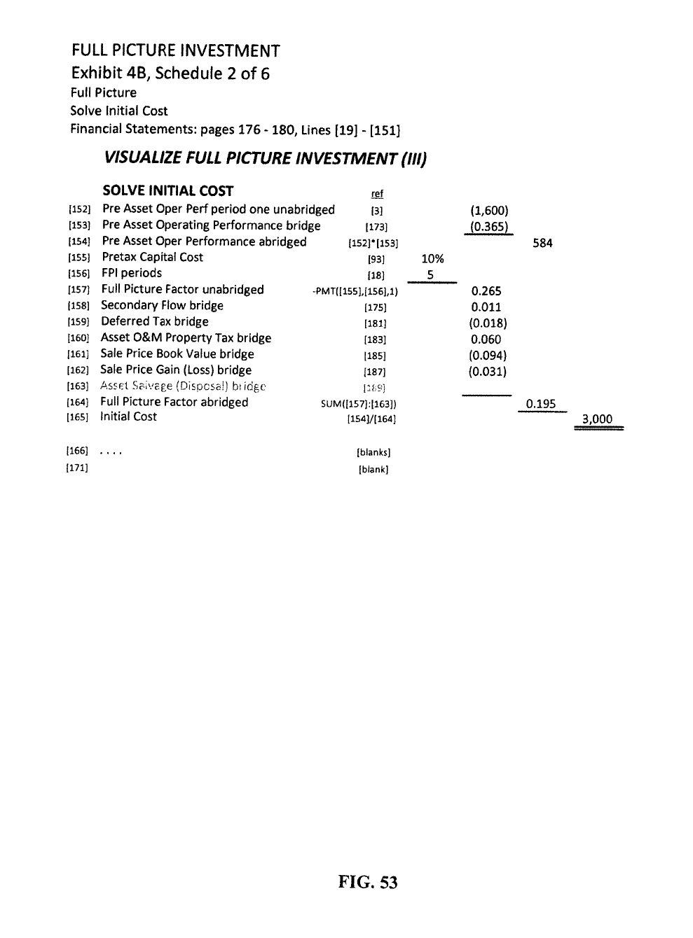

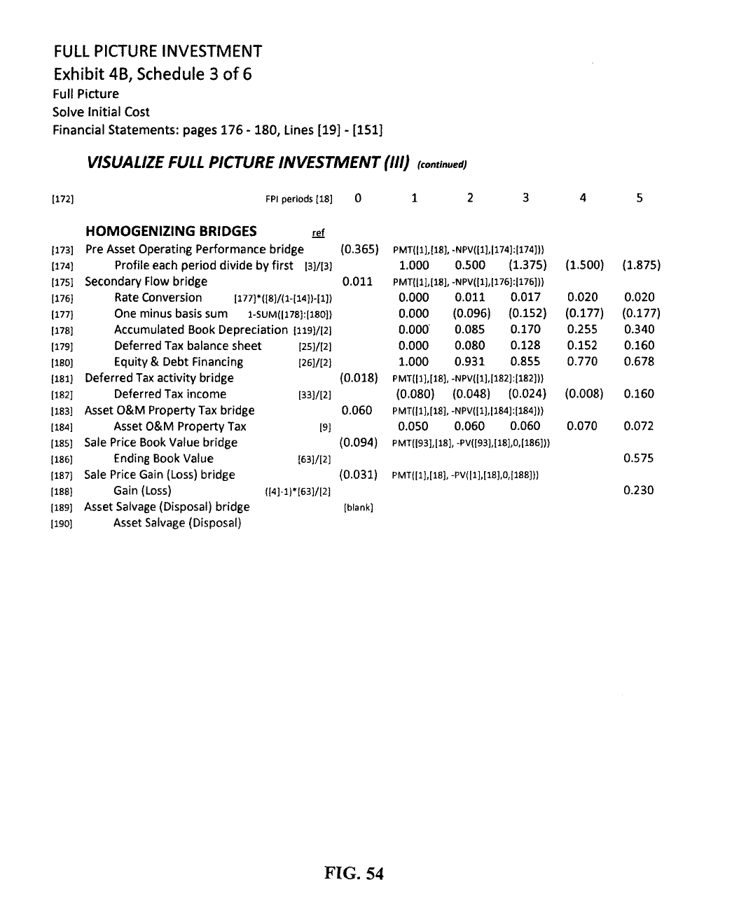

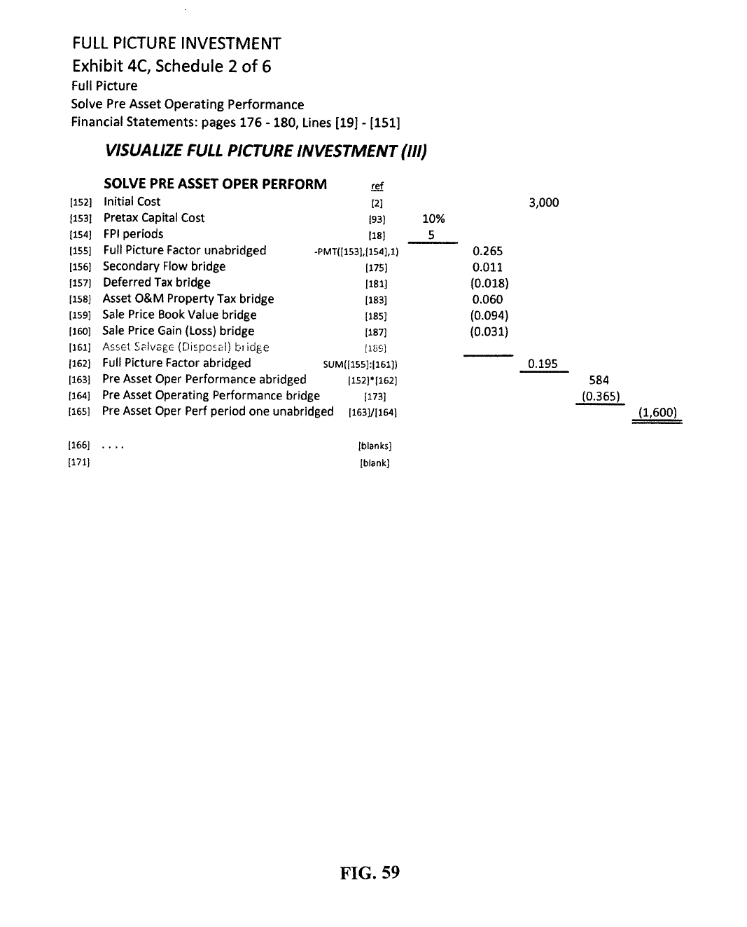

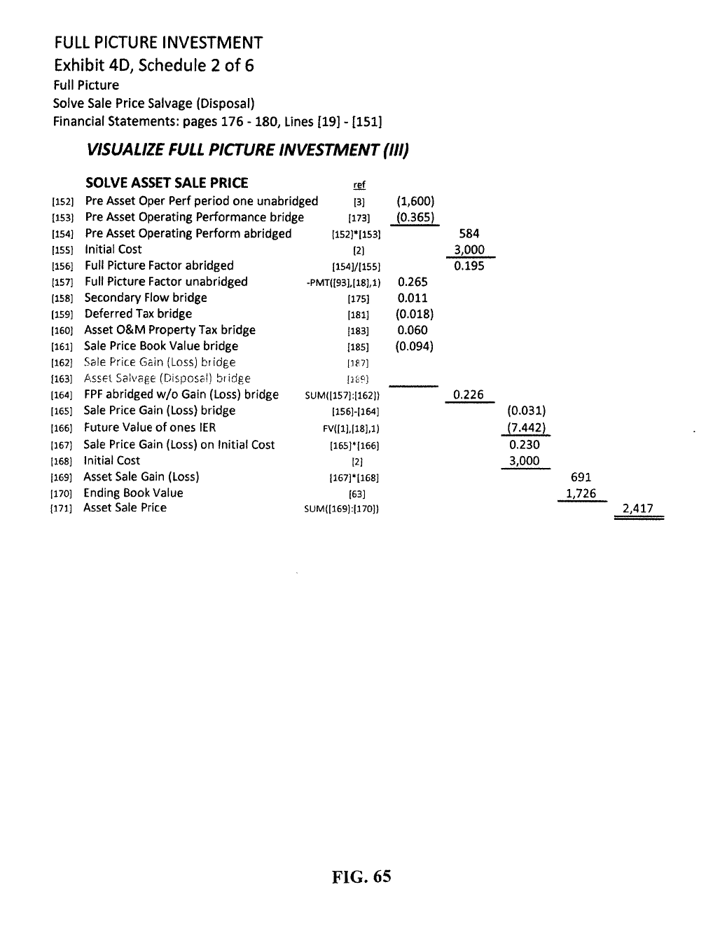

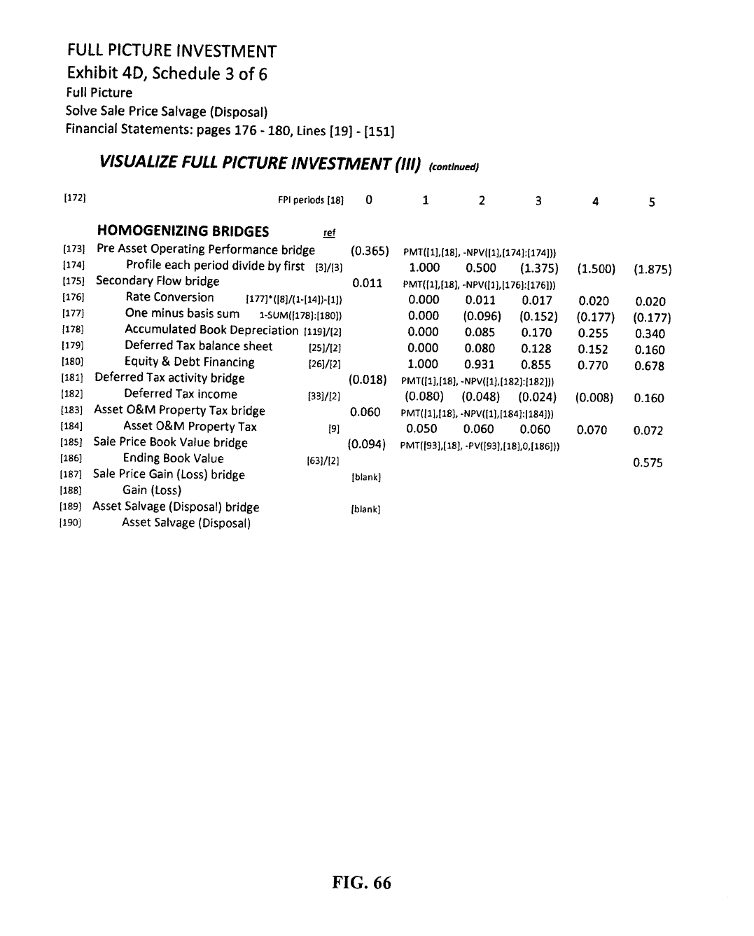

Exhibit 4A's third (III) section starts on FIG. 47, Exhibit 4B, FIG. 53, Exhibit 4C, FIG. 59 and Exhibit 4D, FIG. 65.

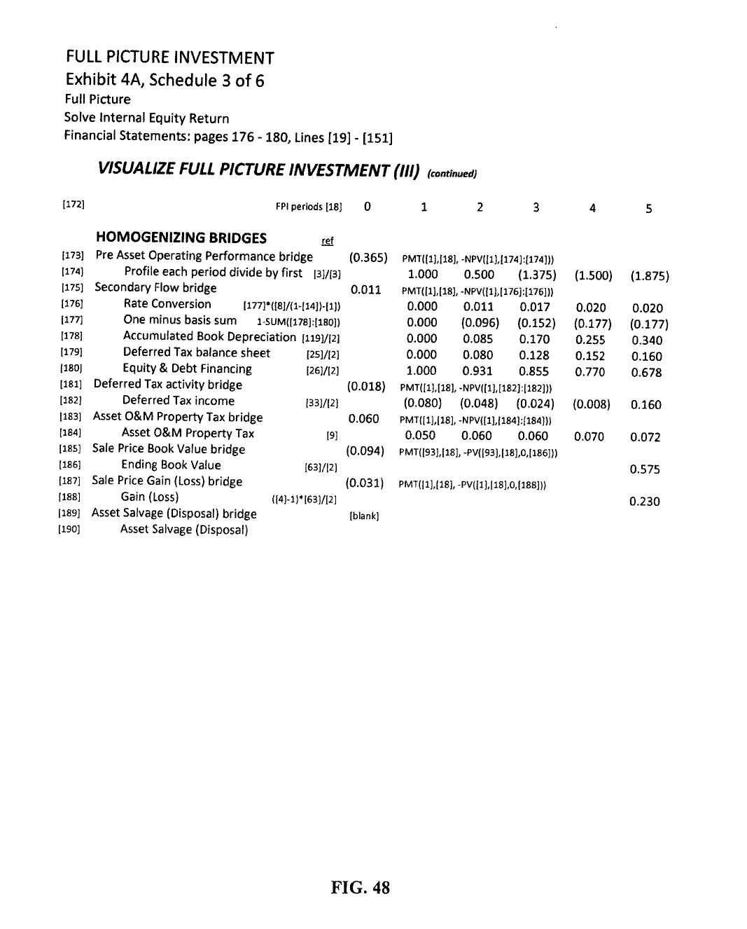

Exhibit 4 introduces a new bridge to coincide with Exhibit 4's new assumptions. The new Deferred Tax activity bridge, FIG. 48, Schedule 3, Line [181] is homogenized to (0.018). The bridge amount represents the income statement's deferred tax activity and has an IER homogenizing rate.

Exhibit 4A's Pre Asset Operating Performance bridge (0.365), Schedule 2, FIG. 47, Line [153], Secondary Flow bridge 0.011, Line [157], the new Deferred Tax bridge (0.018), Line [158], Asset O&M Property Tax bridge 0.060, Line [159], Sale Price Book Value bridge (0.094), Line [160] and Sale Price Gain (Loss) bridge (0.031), Line [161] are adjustments to the FPI's basic Table 8 structure to maintain investment structure synchronicity. In category A all bridges but the pre asset operating performance bridge are deducted from the abridged full picture factor to form the 0.265 abridged full picture factor, Line [163]. The Salvage (Disposal) bridge, Lines

is not used in Exhibit 4 due to an ending net book value driving an asset sale.

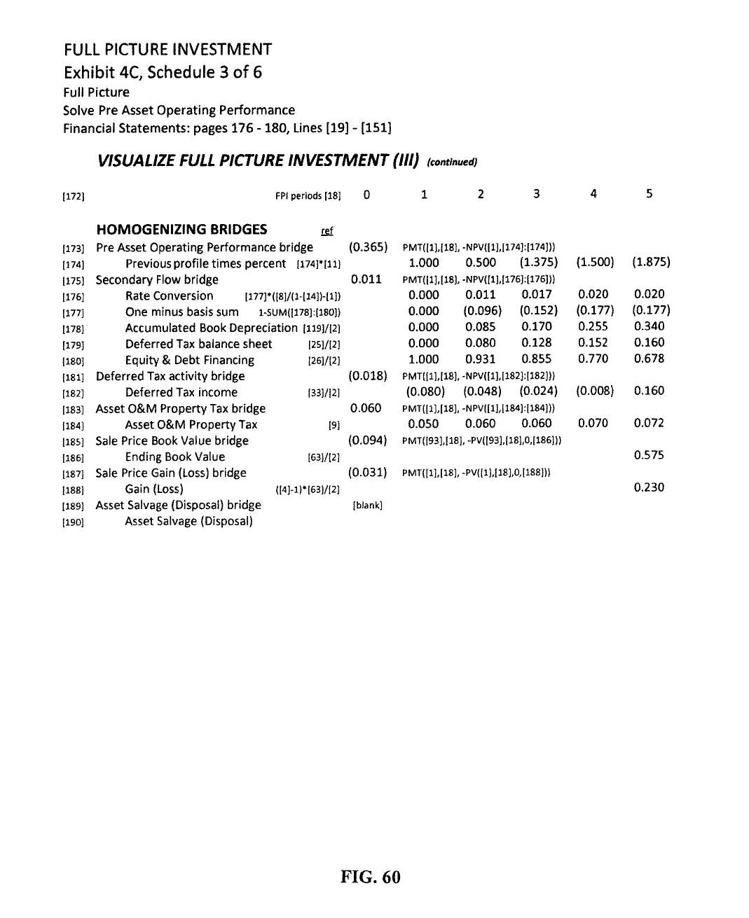

The pre asset operating performance bridge starts with the pre asset operating performance profile, Line [174]. Investment question categories A, B and D pre asset operating performance profiles are individual amounts divided by the first period's amount. The profile for investment category C, Exhibit 4C, FIG. 60, Line [174], is the previous period profile times the period's next period percent, FIG. 58, Line [11]. The profile is then homogenized into the (0.365) bridge, Line [173].

For question categories A, B and D period one's pre asset operating performance (unabridged), Line [152] and the bridge, Line [153] produces an abridged $584 pre asset operating performance, Line [154]. For investment question category C, FIG. 59, the abridged pre asset operating performance $584, Line [163] and the (0.365) bridge, Line [164] are used to produce the unabridged FPI answer ($1,600)—period one's pre asset operating performance Line [165].

Exhibit 4's secondary flow bridge compensates for variances generated by the secondary flow rate being user-defined. The key to the 0.011 secondary flow's bridge is the basis 1 balance sheet representations. The bridge's calculation takes one less the balance sheet basis sum, Line [177], converting from an IER to the user-defined rate, Line [176] and homogenizing it over five periods, Line [175]. Deferred Tax, Line [179] is a new Exhibit 4 ABC&D balance sheet item and is therefore necessitated as an inclusion in the secondary flow bridge calculation.

The Income Statement Deferred Tax amounts, Line [25] are reduced to a relative amount to initial cost on Line [182]. The individual deferred tax amounts are homogenized into the (0.018) Deferred Tax bridge, Line [181].

The Asset O&M Property Tax bridge homogenizes the period over period increasing O&M property tax assumption. The assumption starts at 0.050 in period one and ends at 0.072 in period five, Line [184]. The 0.060 bridge, Line [183] represents a non-varying proxy for all five periods.

The Sale Price Book Value bridge, Line [185] homogenizes the single period five 0.575, Line [186] ending book value. The 0.094 Sale Price Book Value bridge is a representative non-varying five period proxy.

The investment categories A, B and C (0.031) Sale Price Gain (Loss) bridge homogenizes a single fifth period 0.230 amount associated with the sale price level above ending book value. However, rather than calculate a bridge, Exhibit 4D, third (III) section, FIG. 65, solves for the (0.031) Sale Price Gain (Loss) bridge, Line [165], discussed later in this section.

For Exhibit 4A, FIG. 47, Line [154], the $584 abridged pre asset operating performance divided by the $3,000 initial cost forms a 0.195 abridged full picture factor. The abridged full picture factor less the secondary flow bridge, deferred tax bridge, O&M property tax bridge, sale price book value bridge and sale price gain (loss) bridge equals the 0.265 unabridged full picture factor, Line [163]. The unabridged full picture factor combined with five periods generates the 10% pretax capital cost, Line [165]. Line [165]'s 10% pretax capital cost converted to IER, Line [166] matches the 20% FPI answer on Line [1].

For Exhibit 4B, FIG. 53, the 0.265 unabridged full picture factor, Line [157] plus the secondary flow bridge, deferred tax bridge, O&M property tax bridge, sale price book value bridge and sale price gain (loss) bridge equals the 0.195 abridged full picture factor. Line [154]'s $584 abridged pre asset operating performance divided by the 0.195 abridged full picture factor forms the $3,000 initial cost. Line [165]'s $3,000 initial cost matches the FPI answer on Line [2].

For Exhibit 4C, FIG. 59, the 0.265 unabridged full picture factor, Line [155] plus the secondary flow bridge, deferred tax bridge, O&M property tax bridge, sale price book value bridge and sale price gain (loss) bridge equals the 0.195 abridged full picture factor, Line [162]. The $3,000 initial cost, Line [152] multiplied by the 0.195 abridged full picture factor forms the $584 abridged pre asset operating performance. The abridged pre asset operating performance divided by the (0.365) pre asset operating performance bridge forms the period one's pre asset operating performance. Line [165]'s ($1,600) unabridged pre asset operating performance equals the FPI answer on Line [3].

For Exhibit 4D, FIG. 65, the 0.195 abridged full picture factor, Line [156] less the 0.226 abridged full picture factor without sale price gain (loss) bridge equals the (0.031) sale price gain (loss) bridge, Line [165]. The (0.031) sale price gain (loss) bridge, Line [165] multiplied by (7.442) future value of ones forms the 0.230 sale price gain (loss) on initial cost. The sale price gain (loss) on initial cost, Line [167] times the $3,000 initial cost forms the $691 asset sale gain loss), Line [169]. The asset sale gain (loss) plus $1,726 ending book value equals the $2,417 asset sale price, Line [171].

Exhibit 4, FULL PICTURE INVESTMENT vs. TRADITIONAL TOOLS (IO, Fourth Section:

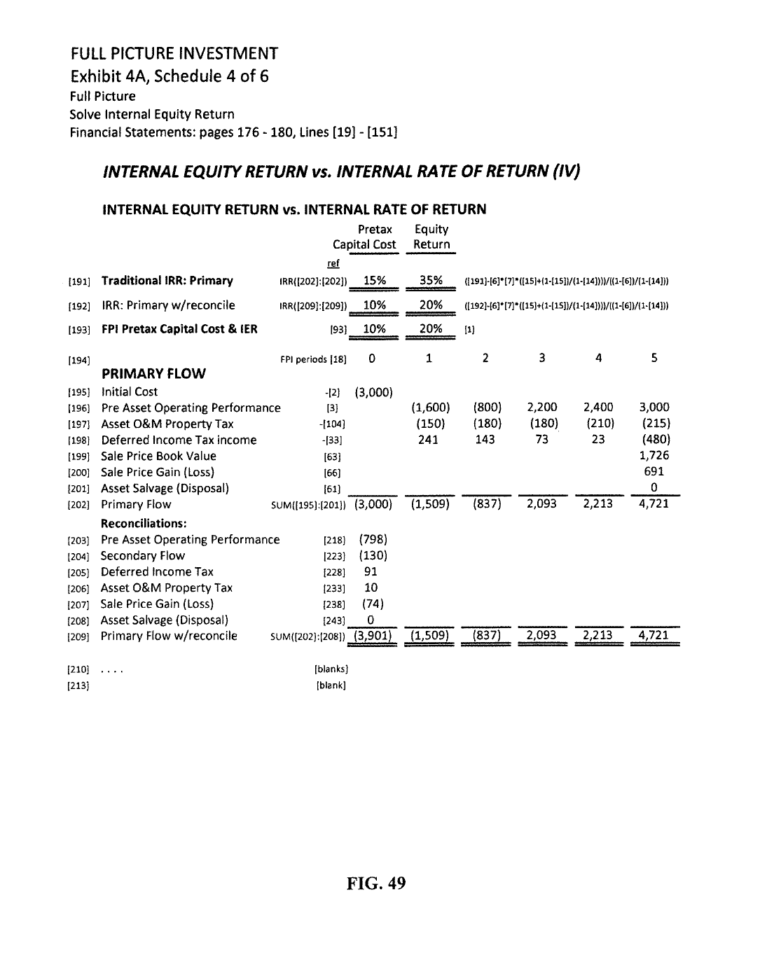

Exhibit 4A's, fourth section, FIG. 49, shows a 15% traditional IRR, Line [191], the 10% pretax capital cost with reconciliations, Line [192] and FPI's 10% pretax capital cost, Line [193]. The equity alone traditional IRR return is 35%, Line [191] and FPI is 20% IER, Lines [192] and [193]. The significant difference between the traditional tool's IRR and FPI remains primarily due to the varying pre asset operating performance, $798 Line [203].

Exhibit 4A's, FIG. 49, primary flow contains the $3,000 initial cost, Line [195]. FPI's periods one through five primary flow not only contain pre asset operating performances but also O&M property tax, deferred income tax, sale price book value and sale price gain (loss), Lines [196] through [201]. The primary flow total Line [202] drives the traditional tool IRR and equity return calculation on Line [191].

FPI's methodology is used to define the reconciling items between the traditional tools and FPI, Lines [203] through [208]. The reconciling items recognize the differences between the traditional tool's singular rate and FPI's individually assigned rates.

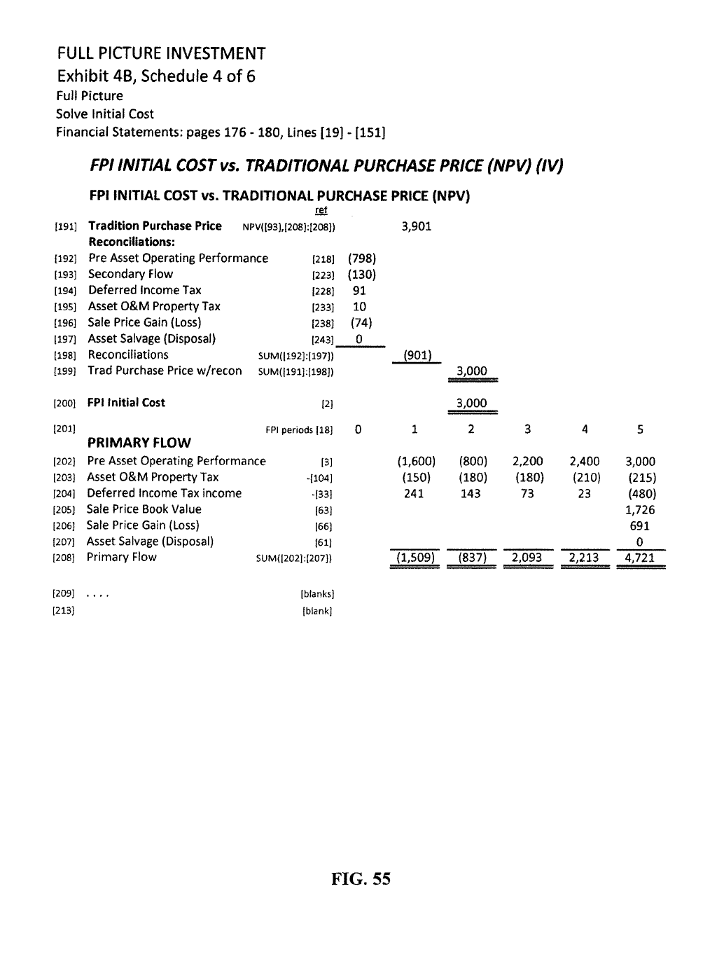

Exhibit 4B's, FIG. 55, shows a $3,901 Traditional NPV Purchase Price, Line [191] and the $3,000 Traditional Purchase Price NPV with reconciliations, Line [199].

The significant difference between the traditional tool's NPV purchase price and FPI's asset book value is again primarily due to the $798, Line [192] varying pre asset operating performance.

Exhibit 4B's, FIG. 55, FPI's periods one through five primary flow not only contain pre asset operating performances but also O&M property tax, deferred income tax, sale price book value and sale price gain (loss), Lines [202] through [207]. The primary flow total Line [208] drives the traditional tool $3,901 NPV purchase price on Line [191].

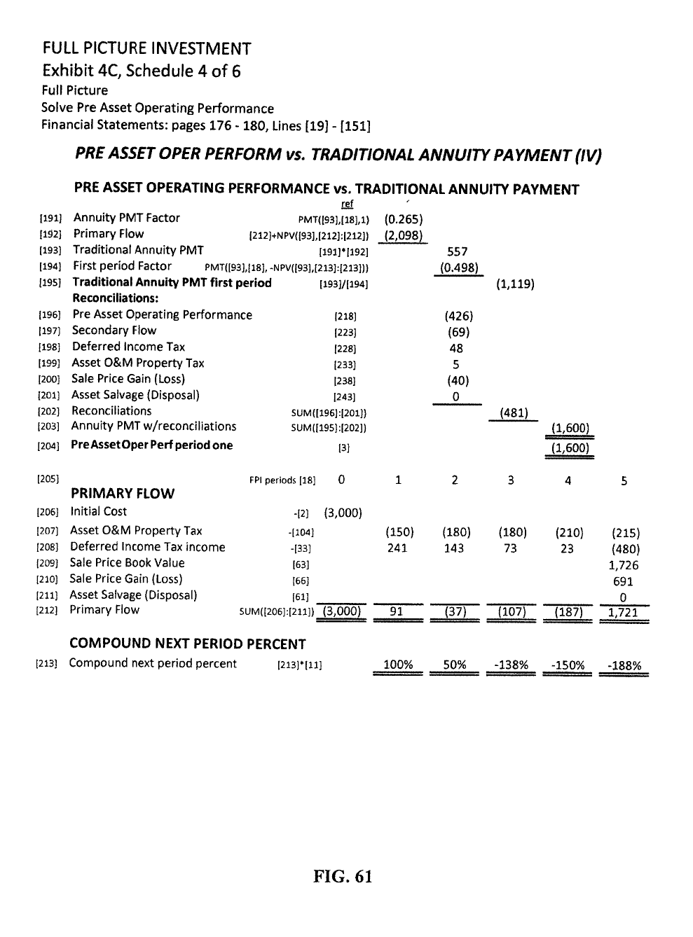

Exhibit 4C's, FIG. 61, shows a ($1,119) traditional annuity first period operating performance, Line [195] and FPI's ($1,600) pre asset operating performance at FPI period one, Lines [203] and [204]. FPI's ability to solve for operating performance's first period is also adapted to the traditional tools in Exhibit 4C. Solving for operating performance's first period is accomplished through recognizing the first period's relationship to other operating performance periods.

Multiplying the (0.265) Annuity PMT Factor, Line [191] by the ($2,098) Primary Flow, Line [192] forms the Traditional Annuity PMT, Line [193]. The $557 traditional annuity PMT amount is converted into the traditional period one's ($1,119), Line [195] by dividing the $557 traditional annuity PMT by the (0.498) first period factor, Line [194].

The significant difference between the traditional tool's NPV purchase price and FPI's asset book value is again primarily due to the $426, Line [196] varying pre asset operating performance.

Exhibit 4C's, FIG. 61, FPI's periods one through five primary flow contains initial cost, O&M property tax, deferred income tax, sale price book value and sale price gain (loss), Lines [206] through [211]. The primary flow total Line [212] drives the NPV primary flow, Line [192].

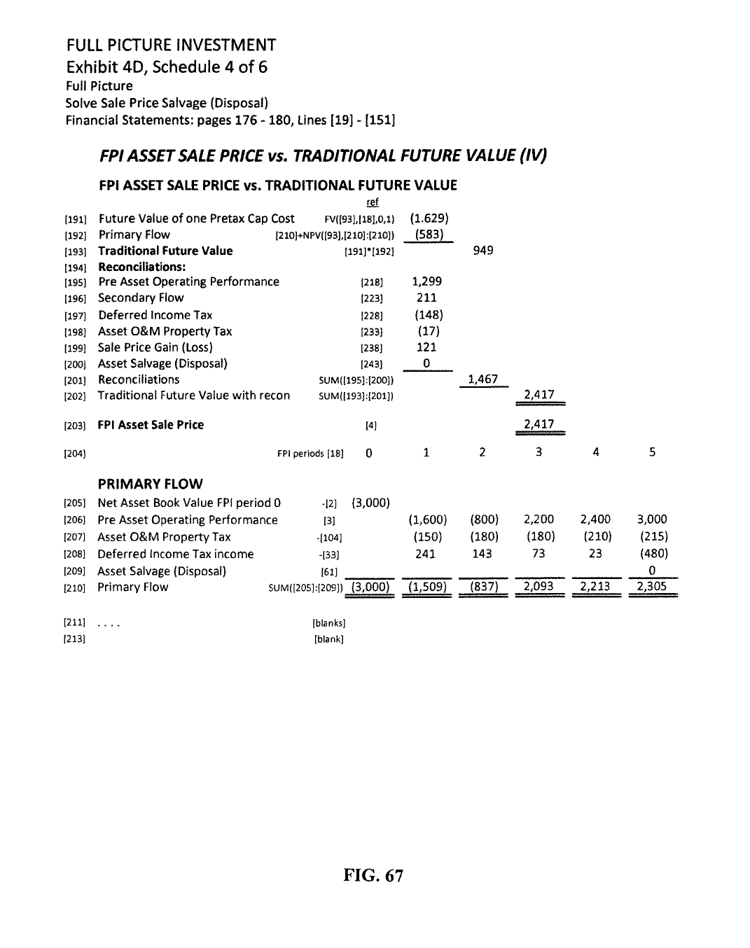

Exhibit 4's Asset Sale Price investment question category D, FIG. 67 creates a need to calculate a traditional asset sale price. Like other traditional tools, traditional future value (FV) calculations have similar shortcomings as other traditional tools. Future Value FV( )applies the pretax capital cost to all investment question primary flows.

TABLE 16
FUTURE VALUE CALCULATION - EXHIBIT 4D, FIG. 67
Traditional method (Primary Flow)

| | | | | | | | | | Future |
|---|---|---|---|---|---|---|---|---|---|
| | | ref | 0 | 1 | 2 | 3 | 4 | 5 | Value |
| (a) | One plus Pretax | Note 1 | 1.10\hat{ }5 | 1.10\hat{ }4 | 1.10\hat{ }3 | 1.10\hat{ }2 | 1.10\hat{ }1 | 1.10\hat{ }0 | |
| | Capital Cost raised | | | | | | | | |
| | to a future value | | | | | | | | |
| (b) | Future Value Factor | (a) | 1.629 | 1.477 | 1.340 | 1.216 | 1.103 | 1.000 | |
| (c) | Primary Flow | [210] | ($3,000) | ($1,509) | ($837) | $2,093 | $2,213 | $2,305 | |
| (d) | FV Sum Across | (b) × (c) | ($4,887) | ($2,230) | ($1,122) | $2,544 | $2,440 | $2,305 | $949 |

Note 1:
The actual number is 1.1025066667 (One plus Exhibit 4 ABC&D, FIG. 72, Line [93])

Table 16 illustrates the typical traditional future value calculation. Each period's unique Future Value Factor (Line b) is multiplied by the period's Primary Flow (Line c). The total future value is the $949 period zero through five summation. Exhibit 4D, FIG. 67 Line [193] takes an alternate approach to arrive at the same Table 16 traditional tool $949 future value.

TABLE 17
FPI VS. TRADITIONAL TOOL
RECONCILIATIONS - EXHIBIT 4

| | Pre Grossed Up | Exhibits A, B, C |
|---|---|---|
| Description | Reconciliation | and D Line # |
| Pre Asset Oper Perform | $212 | [216] |
| Secondary Flow | $34 | [221] |
| Deferred Income Tax | ($24) | [226] |
| Asset O&M Property Tax | ($3) | [231] |
| Sale Price Gain (Loss) | $20 | [236] |
| Salvage (Disposal) | $0 | [241] |

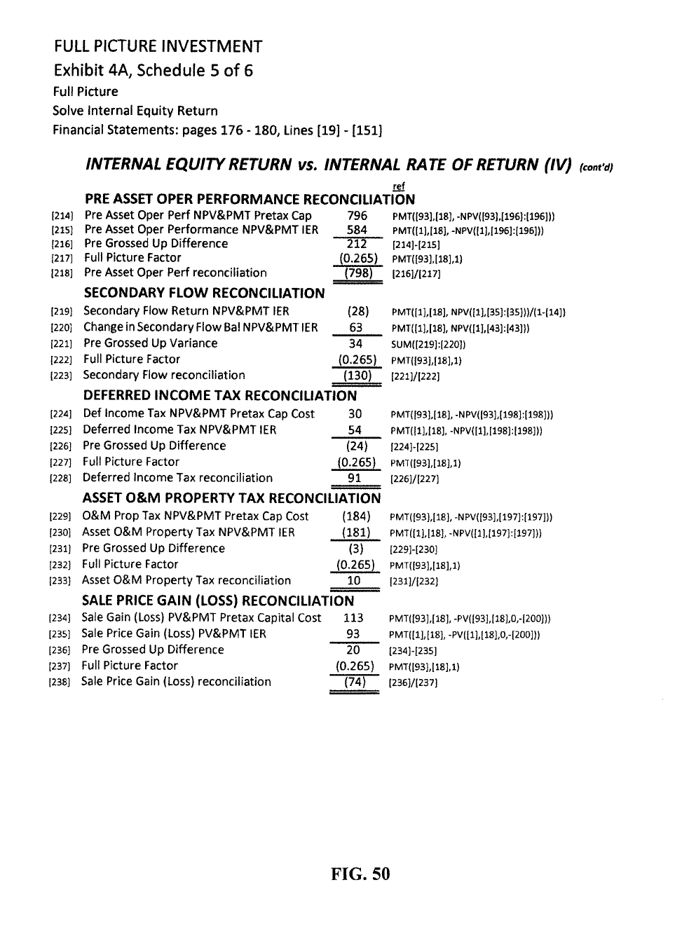

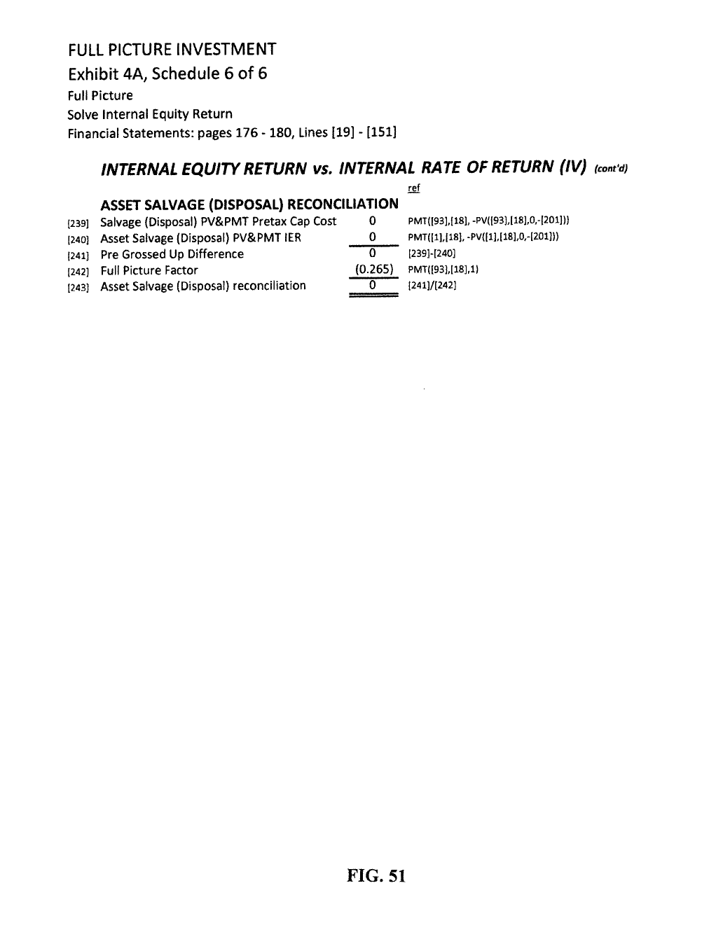

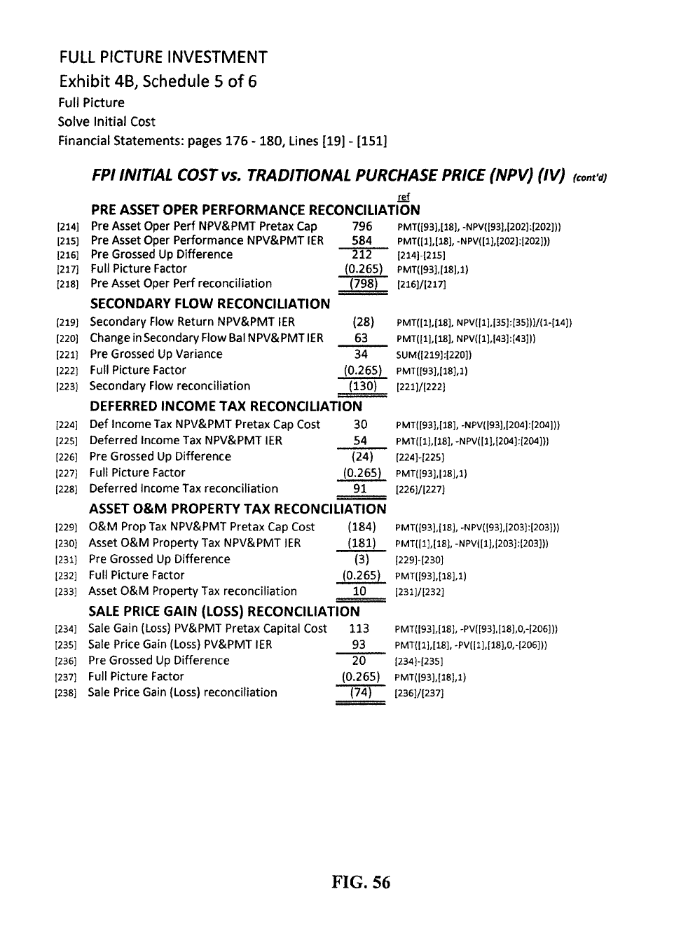

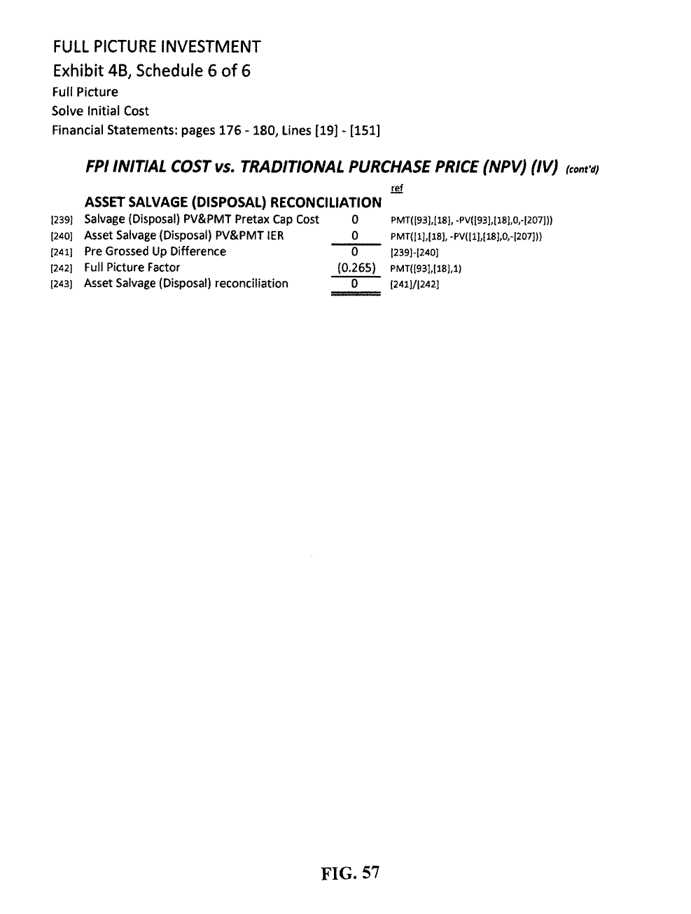

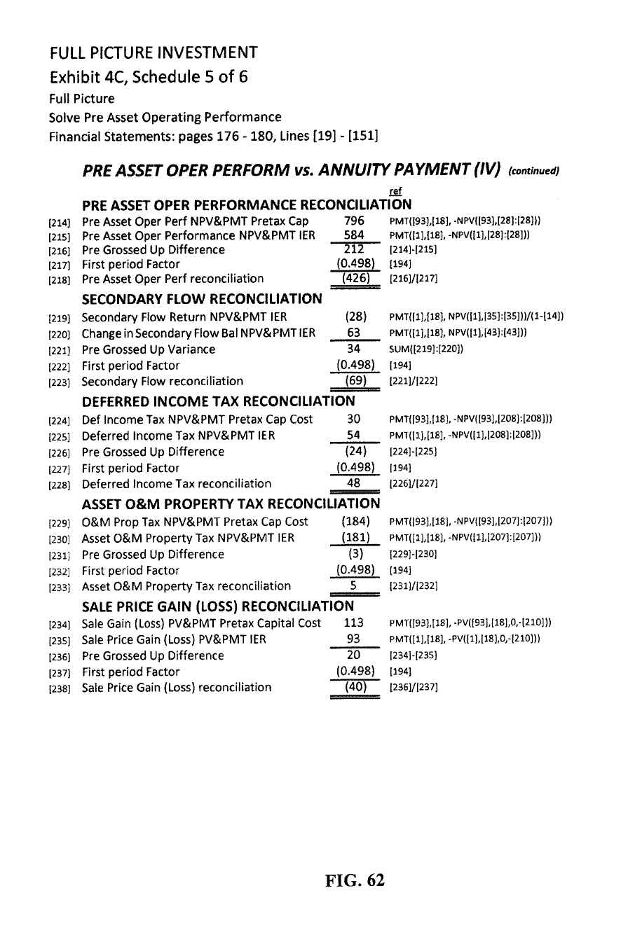

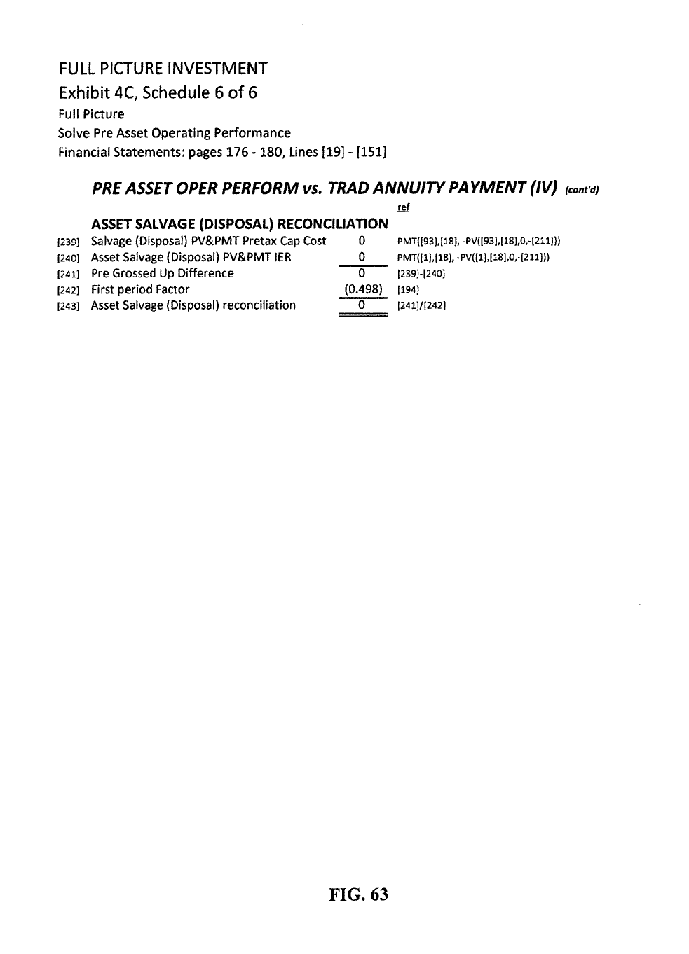

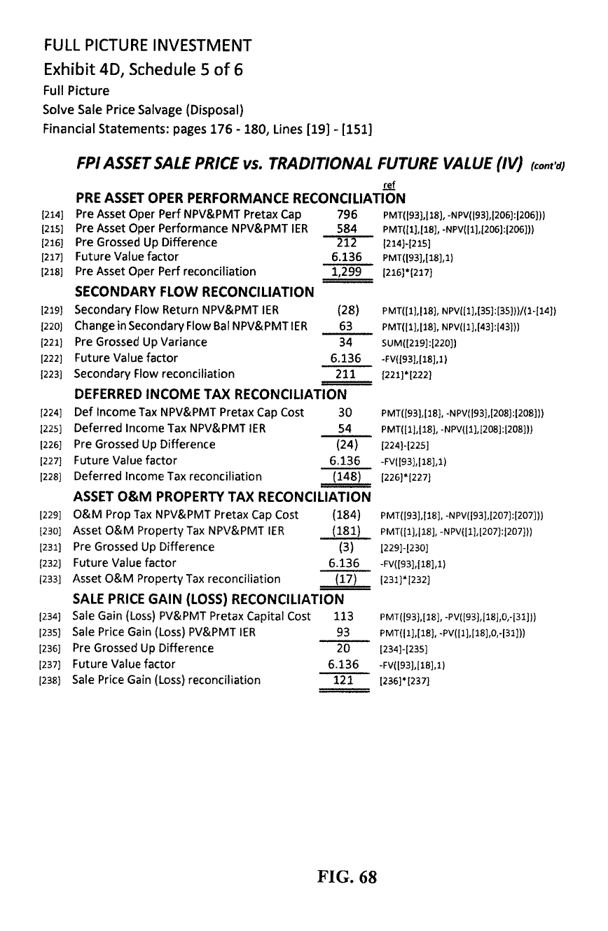

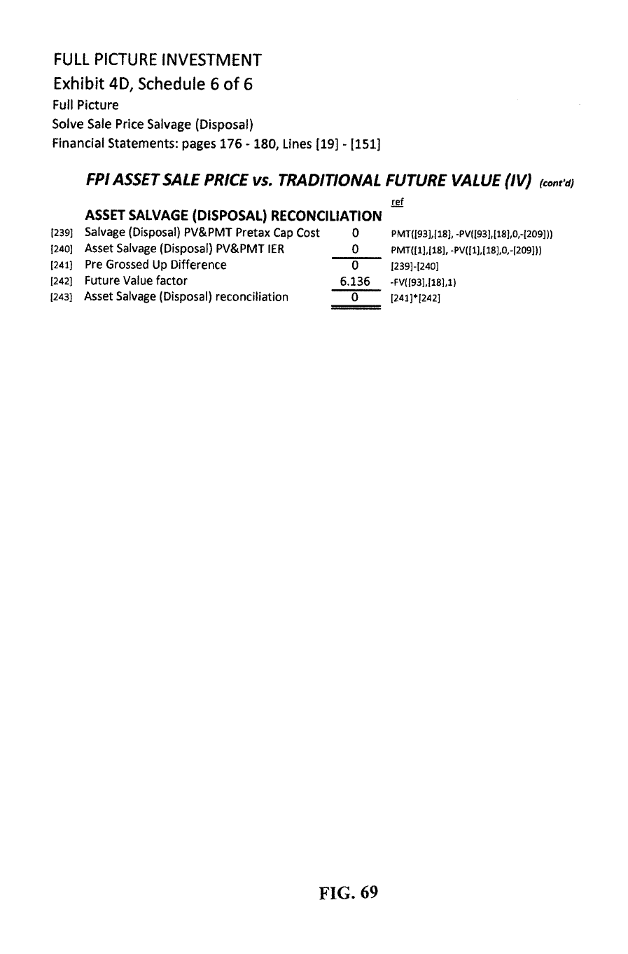

Starting Pages: Exhibit A, FIG. 50, Exhibit B, FIG. 56, Exhibit C, FIG. 62, Exhibit D, FIG. 68

It should be noted again the pre grossed-up differences are the same among the question A, B, C and D investment categories. See Table 17. The only difference in the individual category reconciliation amounts is the category type. The category type determines how the similar pre grossed differences are subsequently grossed-up by different factors. Identical pre grossed-up reconciliations show even in Exhibit 4 there remains a fundamental similarity between FPI's methodology and the traditional tool's familiar techniques.

Table 18 demonstrates Exhibit 4's continued FPI solve/assumption synchronicity. FPI's columns (a), (c), (e) and (g) are identical. None of the traditional tool's columns (b), (d), (f) and (h) match.

TABLE 18
SOLVE/ASSUMPTION SYNCHRONICITY - EXHIBIT 4

| | Question Category | | | | | | | |
|---|---|---|---|---|---|---|---|---|
| | A - Equity Return | | B - Initial Cost | | C - Oper Perform | | D - Sale Price | |
| | FPI | IRR | FPI | NPV | FPI | PMT | FPI | FV |
| | (a) | (b) | (c) | (d) | (e) | (f) | (g) | (h) |
| Equity Return | 20%* | 35%* | 20% | 20% | 20% | 20% | 20% | 20% |
| Initial Cost | $3,000 | $3,000 | $3,000* | $3,901* | $3,000 | $3,000 | $3,000 | $3,000 |
| Pre Asset Oper | ($1,600) | ($1,600) | ($1,600) | ($1,600) | ($1,600)* | ($1,119)* | ($1,600) | ($1,600) |
| Performance | | | | | | | | |
| Asset Sale Price | $2,417 | $2,417 | $2,417 | $2,417 | $2,417 | $2,417 | $2,417* | $949* |

*Indicates a solve for item

### Beginning Balances

Chapter 11's Exhibit 5 discussion introduces new investment question assumptions. Exhibit 5's assumptions further build upon the assumptions in Exhibits 2, 3 and 4. The following is Exhibit 5's new assumption list:

Asset Life periods Previous to FPI Beginning period

Other Assets (Liabilities) Beginning Balance at FPI period 0

Change in Other Assets (Liabilities)

Secondary Flow Beginning Balance at FPI period 0

Income Tax Rate (Deferred Tax) at FPI period 0

Return Rate Initial Parameter—IER category A only

Depreciation Calculation Replacement

Exhibits 5 differs from previous exhibits. Exhibit 5 presents only the Sale Price Salvage (Disposal), investment category D and not the other three investment categories, A, B or C. The first four Exhibits 1, 2, 3 and 4 have successfully demonstrated FPI's solve/assumption synchronicity among the investment categories. With FPI's solve/assumption synchronicity fully defined, Exhibits 5 does not need to present all four categories. Exhibit 5 will instead focus on additional FPI bridges associated with beginning an investment question after the start of the asset's life. In addition, at Chapter 11's end FPI's overall structure is summarized.

The new items introduced in Exhibit 5 moves answering investment questions to a framework for depicting even more realistic investment questions. Exhibit 5 also furthers the distinction between the traditional tools and FPI.

### Exhibit 5, FULL PICTURE INVESTMENT (I), First Section:

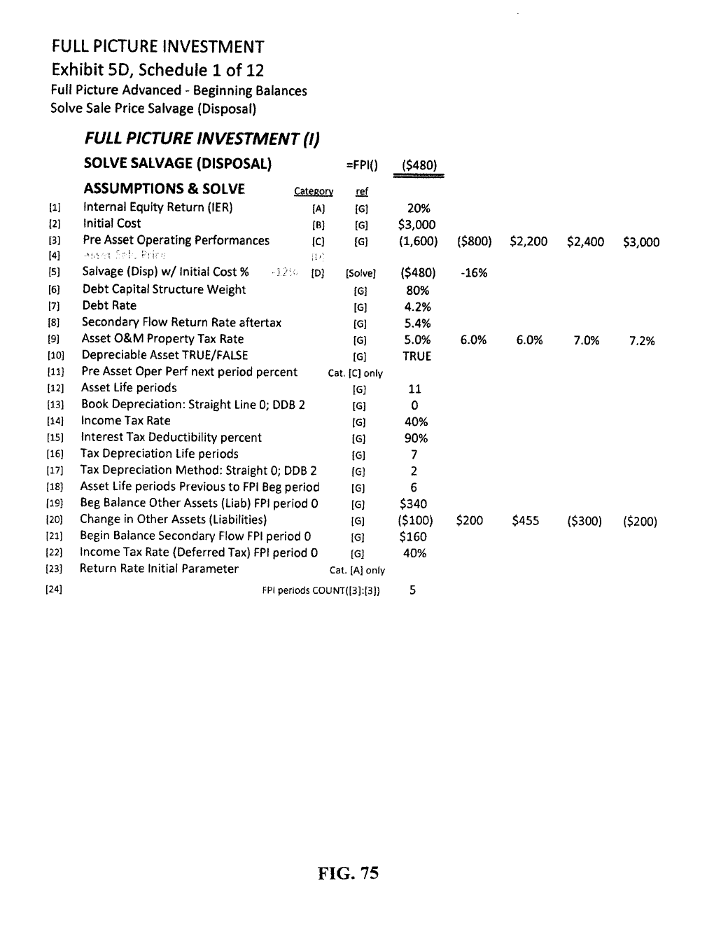

When an investment question's asset life exceeds the investment question life, the Asset Life periods Previous to FPI Beginning period assumption, FIG. 75, Line [18] is used to position the investment question life relative to the asset life. Exhibit 5 has an eleven period asset life. Exhibit 5's investment question begins in the seventh period after six asset life periods have elapsed, Line [18]. An eleven period asset life, a five period investment question starting after six previous periods places both the end of the investment question and the end of the asset's useful life at the same point in time. The end of the investment question and the end of the asset's useful life occurring at the same point in time dictates a salvage (disposal) zero book value scenario and precludes a sale price gain (loss).

Ending book value status at the end of an investment question creates a mutually exclusive situation between sale price gain (loss) and salvage (disposal). Salvage (disposal) only occur when investment question ending book value is zero and sale price gain (loss) occur only when investment question ending book value is not zero.

The illustrative $340 beginning balance other assets (liabilities) assumption, Line [19] represents net cash items paid prior to the investment question's start but appropriately not yet expensed through the income statement or revenue earned but not yet received (placing an asset on the balance sheet). Conversely, a negative other assets (liabilities) beginning balance assumption would represent net materials or services used prior to the investment question's beginning period but not yet paid or revenue received but not yet earned (placing a liability on the balance sheet). Subsequent periods change in other asset (liabilities) assumption, Line [20] adjusts other assets (liabilities) for similar cash and non-cash events impacts during the investment question's life time. Both other assets (liabilities) assumptions provide business professionals the ability to craft cash and non-cash flows as investment questions require.

The $160 beginning balance secondary flow assumption, Line [21] is also for investment questions where the investment question's initial FPI period starts after the asset's life starts.

Separately distinguishing an organization's major assets and the asset's related secondary flows and other assets (liabilities) balances is initially a monumental task. However, once completed an organization could be viewed historically and prospectively as a compilation of asked and answered investment questions. Consolidating multiple FPI historical and prospective financial statements would give an organization a powerful tool to understand their current financial situation and indicators surrounding where they are headed in the future. Other assets (liabilities) and secondary flow beginning balance assumptions are additional enabling FPI features to accomplish historical and prospective financial statement compilation.

The Income Tax Rate (Deferred Tax) FPI period 0, Line [22] is used in the possible event income tax rates change between the asset's beginning life period and the investment questions beginning period. FPI recalculates the Accumulated Deferred Tax at the investment question's beginning FPI period zero with Line [22]'s tax rate. Line [22]'s tax rate assumption can be left blank if the desired period zero income tax rate is the same as the initial tax rate assumption on Line [14].

The Return Rate Initial Parameter, Line [23] is an initial estimate for pretax capital cost. The return rate initial parameter assumption is used only in the iteratively solved category A investment questions. The return rate initial parameter assumption gives business professionals the option to start the iterative category A process at a rate other than a spreadsheet's 10% default value. The 10% default spreadsheet rate is used when FPI's return rate initial parameter assumption, Line [23] is left blank (recommended).

In the next chapter, Chapter 12's Exhibit 6 is the last exhibit and introduces no new assumptions but has varying financing rates during an investment question's FPI periods.

### Exhibit 5, FULL PICTURE FINANCIAL STATEMENTS (II), Second Section:

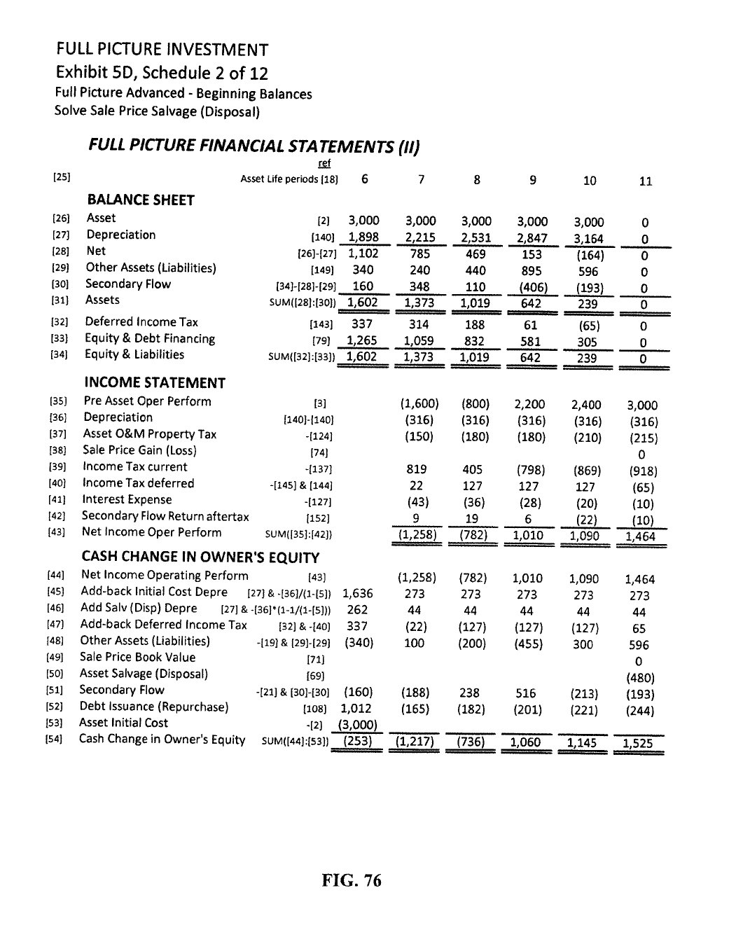

Exhibit 5 has two new line additions to the four basic financial statements. The new Other Assets (Liabilities) assumptions create an Exhibit 5, Other Assets (Liabilities), FIG. 76,

Line [29] balance sheet item and an Other Assets (Liabilities), Line [48] cash change in owner's equity item.

The $1,898 accumulated depreciation, FIG. 76, Line [27], the $340 beginning balance other assets (liabilities), Line [29], the $160 secondary flow, Line [30] and the $337 deferred income tax, Line [32] beginning balances assumptions create four new beginning balance sheet amounts at FPI time period zero.

The four new beginning balance sheet amounts are also present in cash change in owner's equity, Lines [45]-[51] at FPI time period zero. The $1,636 book, Line [45] and $262 disposal deprecation, Line [46] add-backs total a combined $1,898.

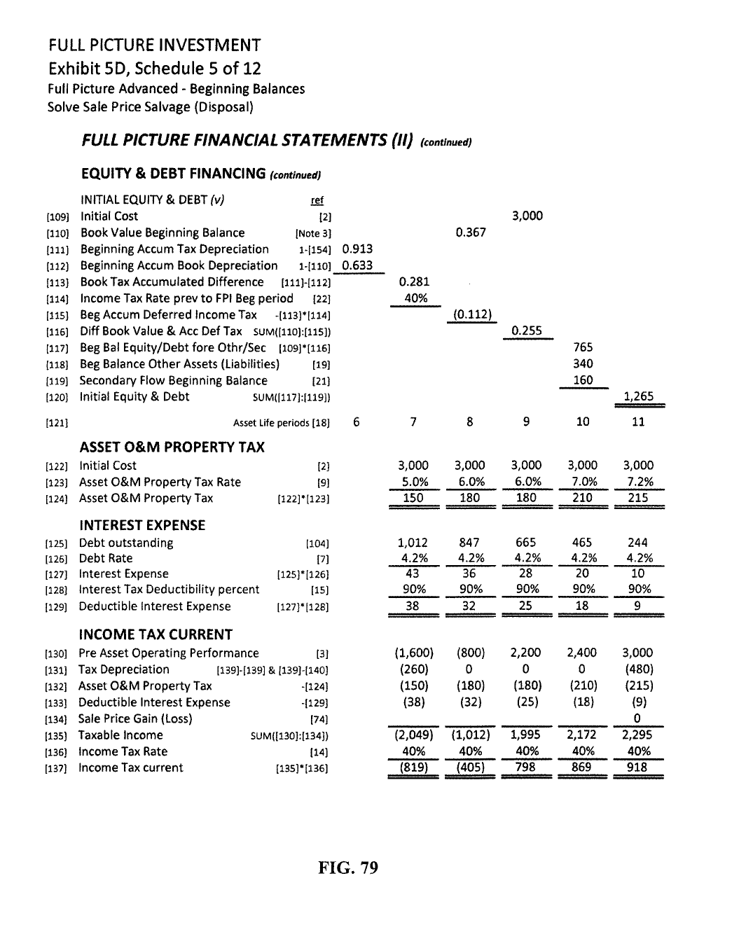

Exhibit 5's EQUITY & DEBT FINANCING adds a fifth (v) piece to Exhibit 4's four pieces. INITIAL EQUITY & DEBT (v), FIG. 79 takes the various new beginning balance assumptions and amounts and formulates an initial equity and debt $1,265 amount, Lines [109] through [120].

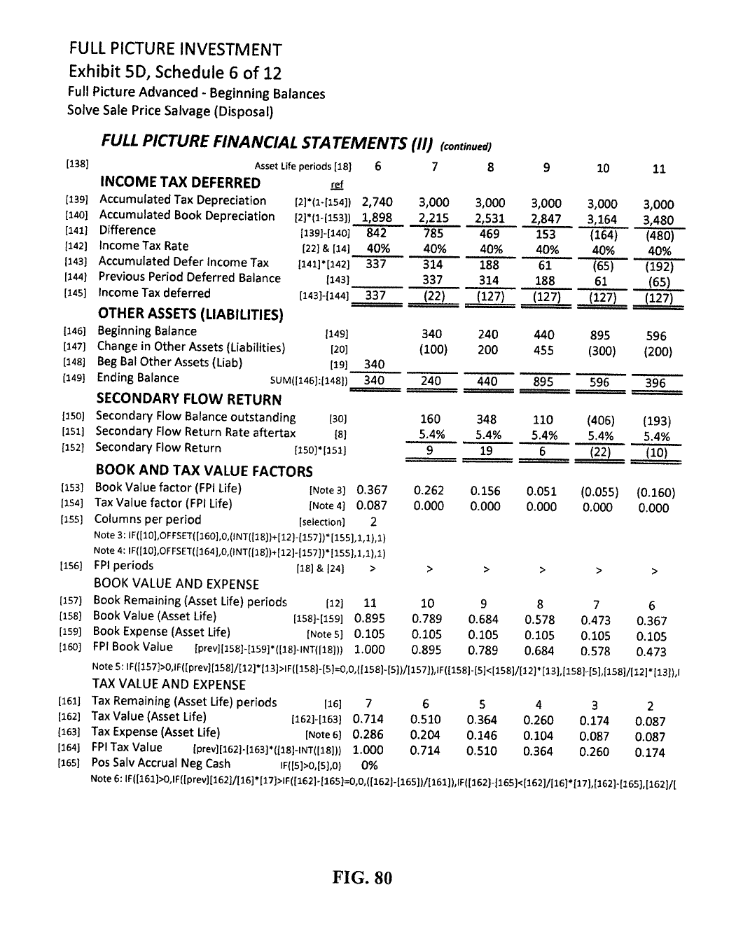

Other assets (liabilities) detail activity and balances are shown on FIG. 80, Lines [146] through [149].

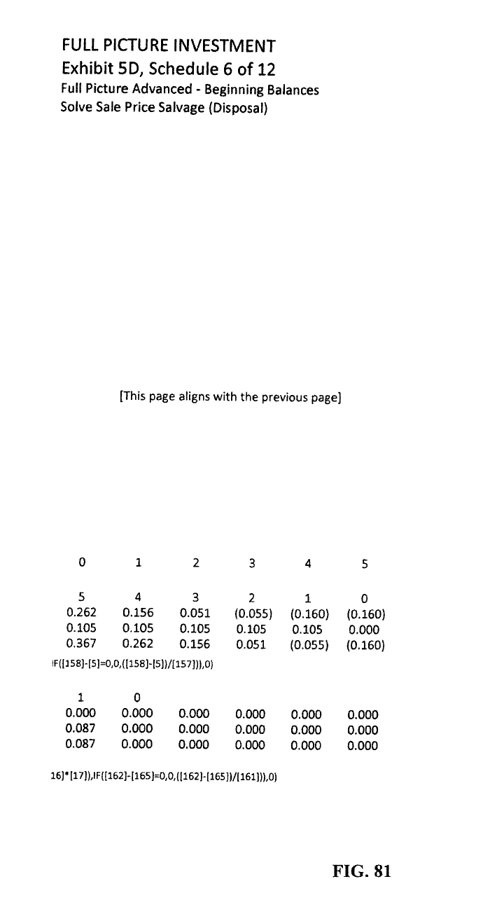

In the first four Exhibits FPI has utilized the native spreadsheet VDB( )function to calculate both book and tax depreciation. Exhibit 5D's illustrative example solves for a disposal cost—a negative salvage value. However, the VDB( )function does not accommodate negative salvage values. The VDB( )function does have the ability to handle a full range of investment questions. Therefore, FPI must now calculate its own book and tax depreciation, FIGS. 80 and 81, Lines [153] through [165]. FPI's depreciation calculations parallel the native VDB( ) function for calculations non inclusive of disposal costs. In addition, FPI's depreciation calculations expand beyond native VDB( )capabilities for those with disposal costs.

FPI's depreciation approach centers around the two by two matrix in Table 19.

TABLE 19
DEPRECIATION APPROACH MATRIX

| | Salvage | Disposal |
|---|---|---|
| Book | Accrual | Accrual |
| Tax | Accrual | Cash |

Depreciation approaches are accrual except for tax disposal cost. Disposal cost is only tax deductible in the period it is paid. If its desirable to take asset retirement obligations to the exact extent of promulgated regulations FPI assumptions [9] Asset O&M Property Tax Rate (income statement impact) and assumption [20] Change in Other Assets (Liabilities) (neutralize non cash flow impact) can be recruited in conjunction with assumption [13] Book Depreciation method to craft and accomplish the effects of this task.

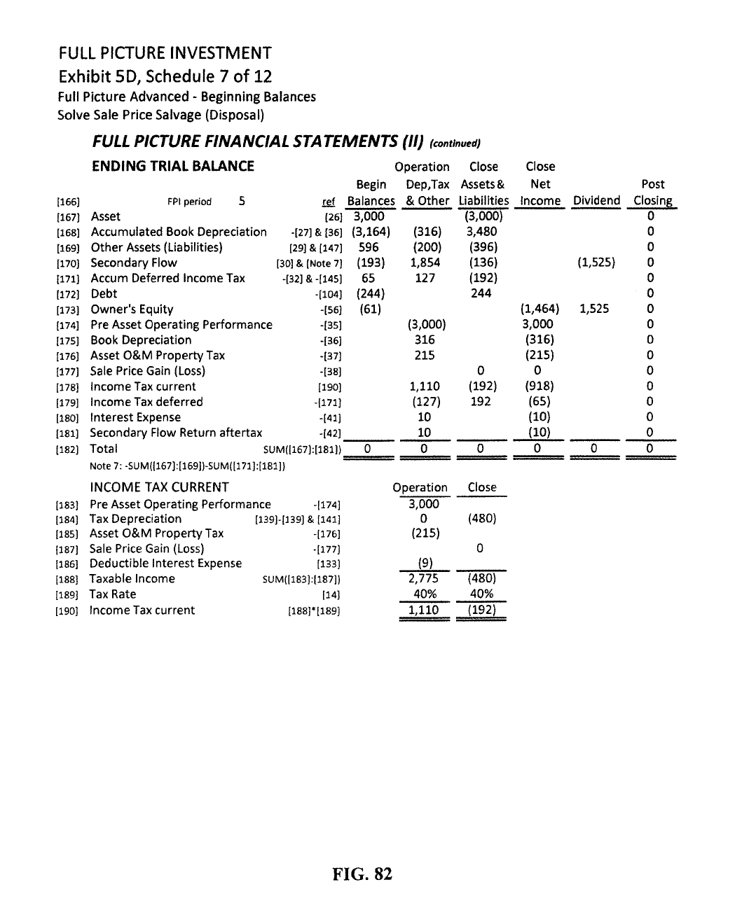

Exhibit 5D, Schedule 7's ending trial balance, FIG. 82 displays closing entries, Line [166] through [190].

### Exhibit 5, VISUALIZE FULL PICTURE INVESTMENT (HI), Third Section:

Exhibit 5's third (III) section has five new bridges, a bridge for each of the four new beginning balances and a new bridge for the new Other Assets (Liabilities) activity.

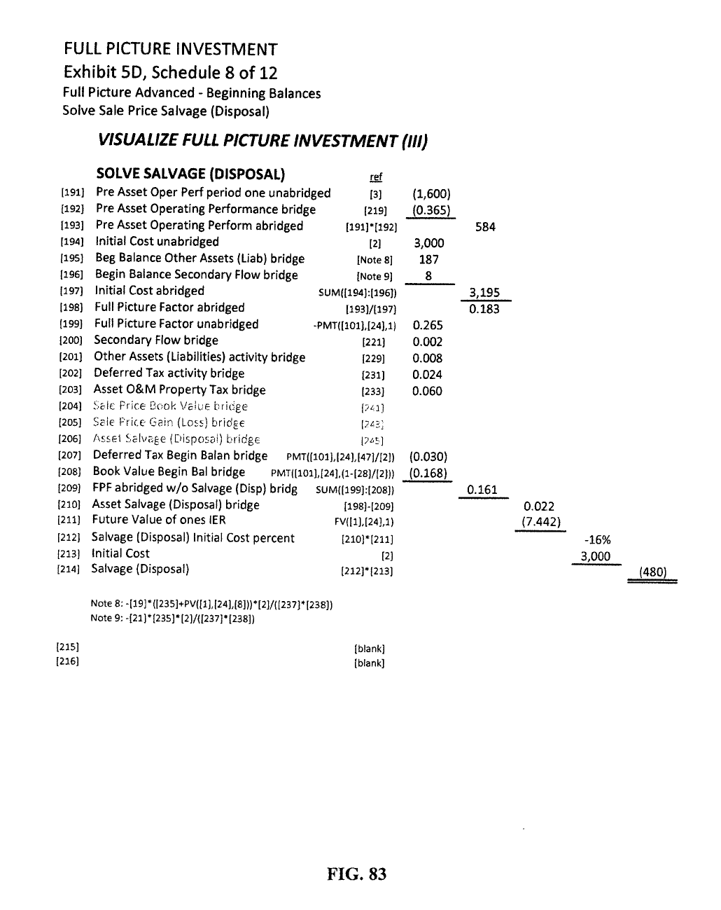

The new 0.008 Other Assets (Liabilities) activity bridge, FIG. 83, Schedule 8, Line [201], the (0.030) Deferred Tax Beginning Balance bridge, Exhibit 5, Line [207] and the (0.168) Book Value Beginning Balance bridge, Line [208] adjust the full picture factor. To maintain investment structure's synchronicity these impacts need reflected in the abridged full picture factor.

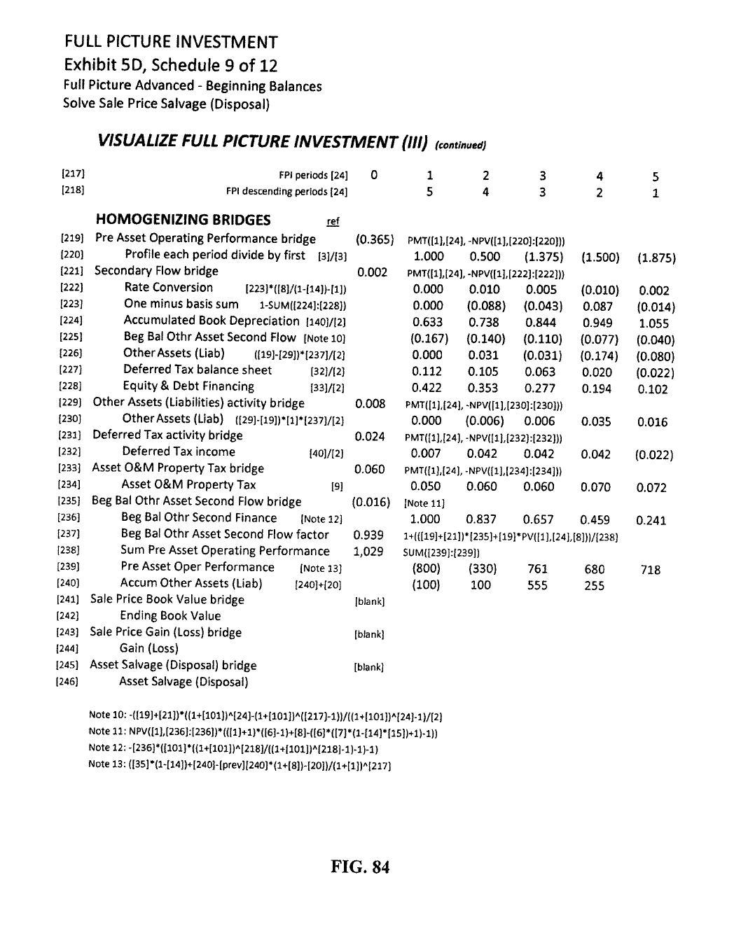

The Other Assets (Liabilities) five assumption amounts ($100), $200, $455, ($300) and ($200) create individual cumulative balances of other assets and liabilities on Line [29]. IER returns on those balances are reduced to a relative amount to initial cost, FIG. 84, Line [230]. The individual other asset (liabilities) amounts are homogenized into the 0.008 Other Assets (Liabilities) activity bridge, Line [229]. Although other assets (liabilities) is not directly an income statement item the IER return on its outstanding balance warrants an IER homogenizing rate. The Deferred Tax Beginning Balance, Line [207] and Book Value Beginning Balance, Line [208] bridges differ from other full picture factor bridges because they are already in a period zero status, being a beginning balance. Therefore, they do not need to be fully homogenized. They only need to be placed in an equal amount proxy. The PMT function facilitates the equal amount proxy. Their balance sheet focus requires using pretax capital cost for the proxy.

The other two new bridges are beginning balance sheet non initial cost based. Beginning Balance Other Assets (Liabilities) and Beginning Balance Secondary Flow bridges are not relative percentages to initial cost. Being beginning balance fixed dollar amounts and not percentages to initial cost they specifically adjust initial cost and not the full picture factor. The bridges for Other Assets (Liabilities) and Secondary Flow beginning balance sheet amounts come with additional complexity. They require a multi-part bridge calculation and an impact to the secondary flow bridge, Line [225]. Three preparatory calculations, FIG. 84, Lines [235] through [240] comprise the multi parts. The resultant beginning balance sheet non initial cost based bridges are an additive bridge to create an abridged initial cost, FIG. 83, Lines [195] and [196]. The permutations in the bridge's calculations are extensive without a direct relationship to initial cost, as shown in Notes eight through thirteen.

For investment categories A, C and D (only category D is shown in Exhibit 5, FIG. 83) the two new non initial cost based bridges are added to an unabridged initial cost to form an abridged initial cost. The abridged initial cost is further used to derive FPI answers in A, C and D investment categories. For investment category B (not shown as a category in this Exhibit 5) the two bridges are subtracted from a previously calculated abridged initial cost to form an unabridged initial cost FPI answer.

Table 20 lists all of Exhibit 5's twelve bridges. Bridges 9, 10, 11 and 12 are new Exhibit 5 bridges. The rate to homogenize depends on whether the item is operating or income flow based (IER) or balance sheet based (pre tax capital cost).

TABLE 20
TWELVE BRIDGE SUMMARY - EXHIBIT 5

| Bridge Description: | | Bridge | FIG. 83 Line |
|---|---|---|---|
| 1. | Pre Asset Operating | (0.365) | [192] |
| | Performance | | |
| 2. | Secondary Flow | 0.002 | [200] |
| 3. | Other Assets (Liabilities) | 0.008 | [201] |
| | Activity | | |
| 4. | Deferred Income Tax - on | 0.024 | [202] |
| | going | | |
| 5. | Asset O&M and Property Tax | 0.060 | [203] |
| 6. | Sale Price Book Value | 0.000 | [204] |
| 7. | Sale Price Gain (Loss) | 0.000 | [205] |
| 8. | Salvage (Disposal) [Solved] | 0.022 | [210] |
| 9. | Deferred Tax Begin Balance | (0.030) | [207] |
| | Sheet Initial Cost based | | |
| 10. | Book Value Begin Balance | (0.168) | [208] |
| | Sheet Initial Cost based | | |
| 11. | Begin Balance Other Assets | 187 | [195] |
| | (Liabilities) Non Initial Cost | | |
| 12. | Beginning Balance Secondary | 8 | [196] |
| | Flow Non Initial Cost Based | | |

So now, at a holistic level, FPI's investment structure fully demonstrates its versatility outside of Table 8's three basic investment elements. A calculated salvage (disposal) bridge can not only be included as a homogenized assumption germane to an investment question the former assumption can also be turned around into a solved for homogenized bridge and converted into an investment question's answer. In Exhibit 5, the investment question's start period can be a time frame after the asset was created—through applying FPI's synchronicity methodology to the corresponding beginning balances.

In summary, moving further to more real world investment situations requires new investment question assumptions. New assumptions require adjustments utilizing FPI's core methodology to maintain synchronicity around the investment structure. FPI's homogenizing bridges continue to be the mechanisms to facilitate needed synchronicity adjustments.

Now is a good time to summarize and further discuss matters surrounding answering investment questions with a synchronized investment structure. As a comprehensive framework, FPI's methodology consists of several structure areas.

Investment structure areas are listed in the Investment Structure's Seven Areas Table 21.

Exhibit 1 introduces the first investment structure area. The first investment structure area is IER's multi period ROE nature (and later pretax capital cost) within Table 7's full picture factor. This initial pivotal relationship makes the investment structure work. It enables solve/assumption synchronicity, it enables direct linkage between investment questions and financial goals, it enables auto generating and auto balancing affirming financial statements and it unifies the traditional IRR, NPV, PMT and FV comparative investment and wealth measures. The remaining six investment structure areas are adjustments to IER's multi period ROE structure to accommodate real-world assumptions.

It is important to point out FPI's nature in conjunction with the traditional tools. Exhibit 1's lack of differences between FPI and the traditional tools illustrates FPI's discounted cash flow fundamentals as being initially aligned with the traditional tools.

The second investment structure area is the financing transformation from IER to pretax capital cost by including debt, interest deductibility and income tax in the full picture factor. Pretax capital cost isolates debt's asset financing aspect and equity's taxable features. Isolating and enveloping debt and income tax in pretax capital cost makes them easier to represent in an investment structure.

TABLE 21
FPI INVESTMENT STRUCTURE'S SEVEN AREAS:

| Investment Structure | | | | | Exhibit |
|---|---|---|---|---|---|
| Area | | Element | Action | Rate | Intro |
| 1. | Equity Return | Net income and | Multi Period | IER | 1 |
| | | equity outstanding | ROE | | |
| 2. | Introduce debt and | Full picture factor | Transform | Pretax | 2, 3 |
| | income tax | via pretax cap cost | | capital cost | |
| 3. | Level pre asset operating | Adjust pre asset | Multiplicative | IER | 2 |
| | performance | operating perform | bridge | | |
| 4. | Change secondary flow | Adjust full picture | Additive | User- | 2, 3 |
| | rate to user-defined rate | factor | bridge | defined | |
| 5. | Operating flows outside | Adjust full picture | Additive | Pretax cap | 2, 3 |
| | pretax cap cost items | factor | bridge | & IER | & 4 |
| 6. | Beginning balances | Adjust full picture | Additive | Pretax | 5 |
| | initial cost based | factor | bridge | capital cost | |
| 7. | Beginning balances non | Adjust Initial Cost | Multiplicative | Pretax cap | 5 |
| | initial cost based | | & Additive | & IER | |

The third investment structure area is leveling pre asset operating performance through a bridge's proxy. In Exhibit 1, the investment structure operates with level operating performance from period to period. Many pre asset operating performance assumptions are not going to be equal period to period. Pre asset operating performance bridges are a means to homogenize fluctuating amounts into a non-varying proxy. Pre asset operating performance's lack of involvement with the asset and the asset's debt directs the proxy's bridge to use IER for homogenizing.

The fourth investment structure area is a bridge allowing a user-defined secondary flow rate. From an economic definition standpoint, secondary flows require a user-defined fourth rate apart from equity, debt or their combination.

The fifth investment structure allows an investment question's operating and income flows to be incorporated as an assumption with a corresponding FPI bridge. The fifth investment structure includes Other Assets (Liabilities) activity, on-going Deferred Income Taxes, Operation & Maintenance Expenses (O&M), Property Taxes, Sale Price Book Value, Sale Price Gain (Loss) and Asset Salvage or Disposal Cost.

The sixth investment structure allows an investment question's initial cost based beginning balances to be incorporated as an assumption with a corresponding FPI bridge. The sixth investment structure includes Deferred Tax and Book Value beginning balances.

The seventh investment structure allows an investment question's non initial cost based beginning balances to be incorporated as an assumption with a corresponding FPI bridge. The seventh investment structure includes beginning balance other assets and (liabilities) and secondary flow. Chapter 12's Exhibit 6 will show the importance of these beginning balances when varying an investment question's IER.

Exhibit 5, FULL PICTURE INVESTMENT vs. TRADITIONAL TOOLS (IV), Fourth Section:

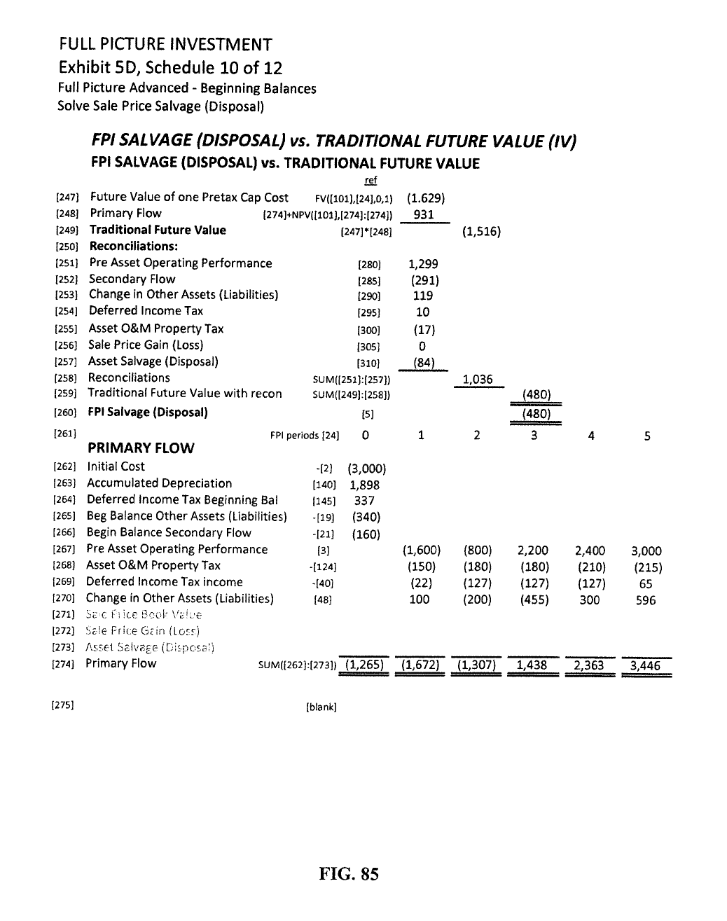

The four new beginning balances (Accumulated Depreciation, Deferred Income Tax, Other Assets (Liabilities) and Secondary Flows) are added to the fourth (IV) section's investment questions primary flow, FIG. 85, Lines [263] through [266]. The five change in other assets (liabilities) ,Line [270] amounts are included with the other primary flow amounts from Exhibit 4.

Although now twelve bridge components are in Exhibit 5 (Table 20 and FIG. 83), still only Exhibit 4's seven components are needed to reconcile FPI answers to the traditional tool answers. Exhibit 5's four new bridges are all balance sheet focused. Being balance sheet focused, both FPI and the traditional tools use pretax capital cost as their homogenizing rate. Those investment question components sharing the same pretax capital cost as the singular traditional tool rate do not invoke differences between FPI and the traditional tools.

Exhibit 5's investment question category D creates a need to calculate a traditional salvage (disposal). Table 22 illustrates the typical traditional future value calculation. Each period's unique Future Value Factor (Line b) is multiplied by the period's Primary Flow (Line c). The total future value is the ($1,516) period zero through five summation. Exhibit 5, FIG. 85 Line [249] takes an alternate approach to arrive at the same Table 22 traditional tool ($1,516) future value.

TABLE 22
FUTURE VALUE CALCULATION - EXHIBIT 5D, FIG. 85
Traditional method (Primary Flow)

| | | | | | | | | | Future |
|---|---|---|---|---|---|---|---|---|---|
| | | ref | 0 | 1 | 2 | 3 | 4 | 5 | Value |
| (a) | One plus Pretax | Note 1 | 1.10\hat{ }5 | 1.10\hat{ }4 | 1.10\hat{ }3 | 1.10\hat{ }2 | 1.10\hat{ }1 | 1.10\hat{ }0 | |
| | Capital Cost raised | | | | | | | | |
| | to a future value | | | | | | | | |
| (b) | Future Value Factor | (a) | 1.629 | 1.477 | 1.340 | 1.216 | 1.103 | 1.000 | |
| (c) | Primary Flow | [274] | ($1,265) | ($1,672) | ($1,307) | $1,438 | $2,363 | $3,446 | |
| (d) | FV Sum Across | (b) × (c) | ($2,061) | ($2,471) | ($1,751) | $1,748 | $2,605 | $3,446 | $(1,516) |

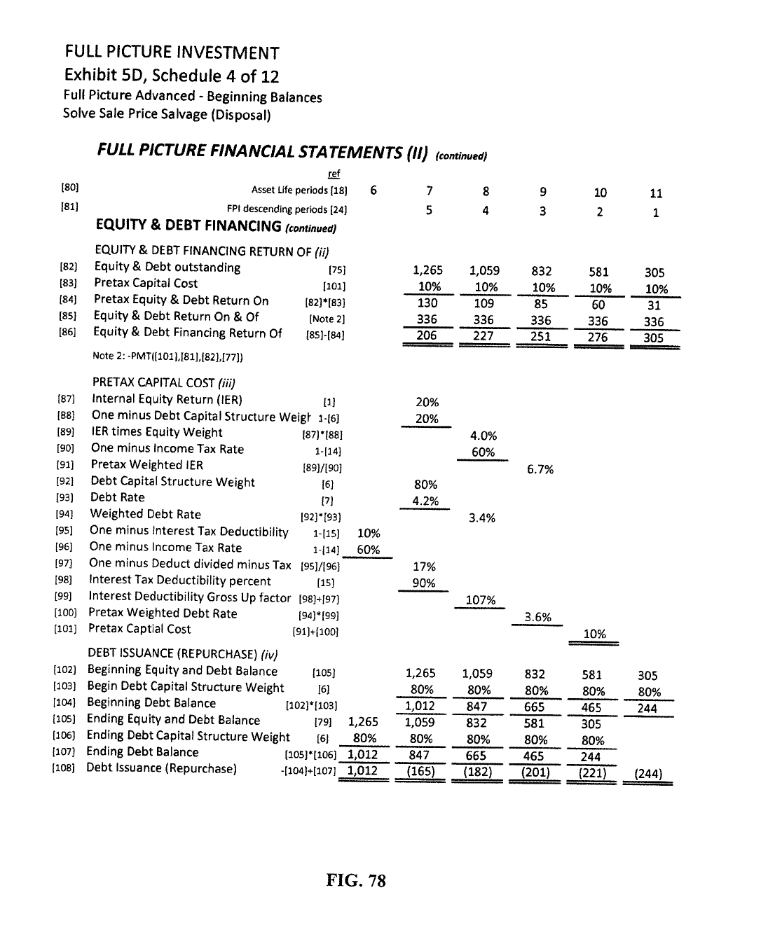

Note 1:
The actual number is 1.1025066667 (One plus Exhibit 5D, FIG. 78, Line [101])

Exhibit 5's, fourth section, FIG. 85, Line [249] shows a ($1,516) traditional disposal cost calculation. However, FPI calculates only a ($480) disposal cost to appropriately ensure the investment opportunity earns the given IER. The significant difference between the traditional tool's future value and FPI's disposal cost remains primarily due to the varying pre asset operating performance's $1,299 reconciliation, Line [251].

### Varying Financing Rates

Chapter 12's Exhibit 6 discussion introduces no new investment question assumptions. However, Exhibit 6 does demonstrate FPI's ability to varying financing assumptions throughout the course of an investment question.

Varying Financing Assumptions (other than IER)

Sequencing Multiple FPI Calculations to Accommodate an IER Change

Chapter 12's Exhibit 6 is similar to Chapter 11's Exhibit 5. Exhibit 6 presents only the Initial Cost investment category B. A single category was presented in Exhibit 6 for brevity reasons. The other three category financial statements are identical to category B's financial statements.

Exhibit 6, FULL PICTURE INVESTMENT (I), First Section:

Prior to Chapter 12, only pre asset operating performance, asset O&M property tax and change in other assets (liabilities) assumptions vary from period to period. Other assumptions remain constant during their FPI life time. Minimizing the number of varying assumptions allows the discussion to focus on visualizing FPI calculations in an Exhibit's third (III) section and to explain differences between FPI and the traditional tools in the fourth (IV) sections. Sections three and four are very adept at visually communicating FPI's concepts and methodology.

Business professional may want to vary additional assumptions during the investment question's FPI life time. Varying investment assumptions allow business professional to look at multiple what-if scenarios. Often a base case is prepared as a benchmark. Subsequent scenarios vary key assumptions to determine their sensitivity to the base case assumptions. Table 23 lists financing assumptions FPI's methodology can directly vary from period to period.

TABLE 23
FINANCING ASSUMPTIONS TO
VARY PERIOD-TO-PERIOD:

| No. | =FPI( ) Assumption: |
|---|---|
| [6] | Debt Capital Structure Weight |
| [7] | Debt Rate |
| [8] | Secondary Flow Return Rate |
| [14] | Income Tax Rate |
| [15] | Interest Tax Deductibility percent |

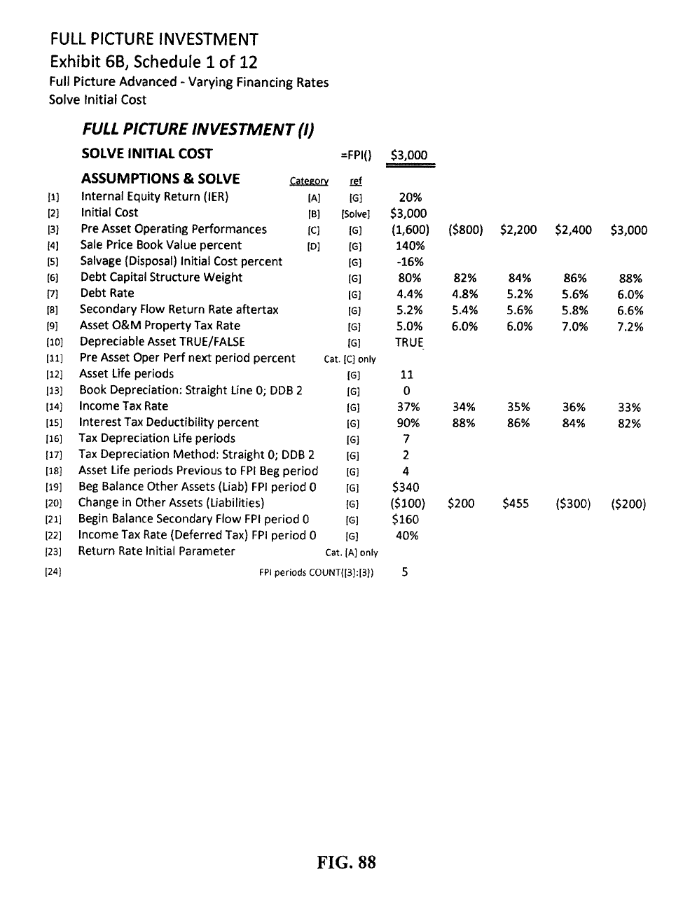

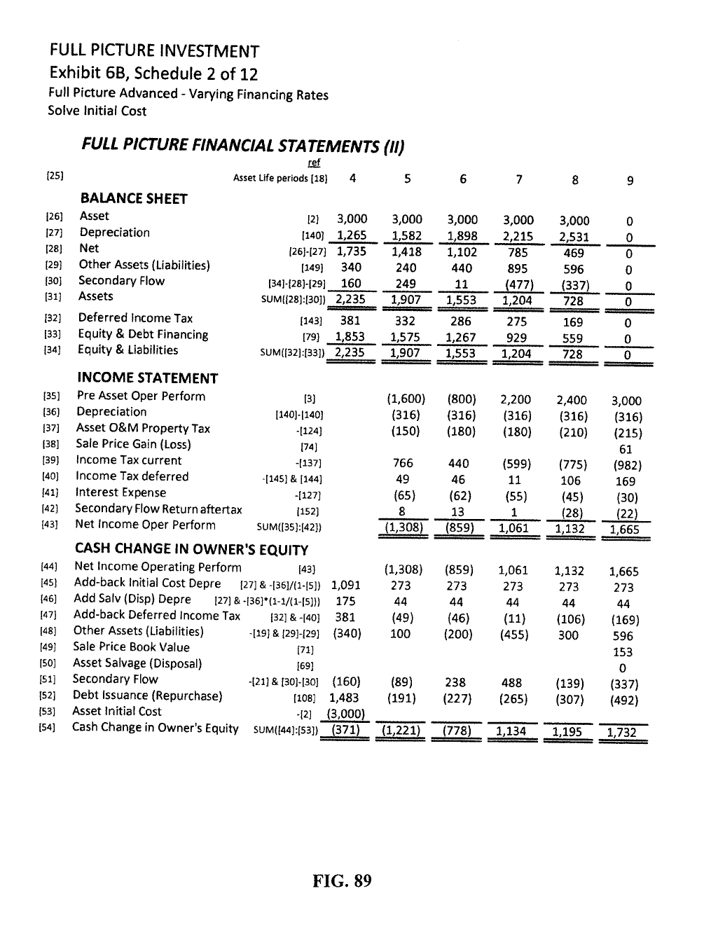

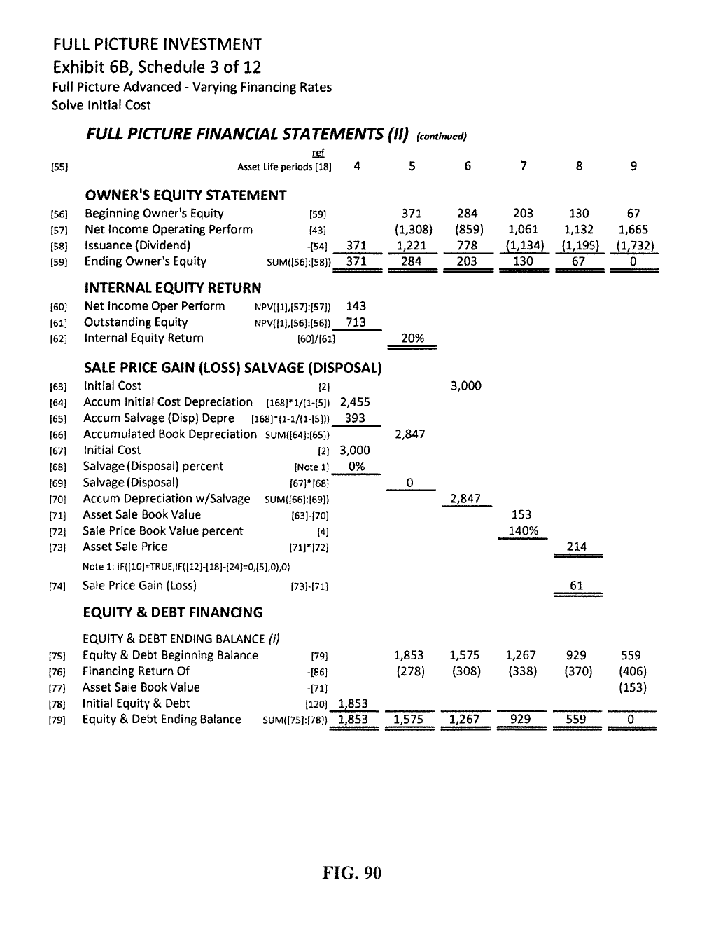

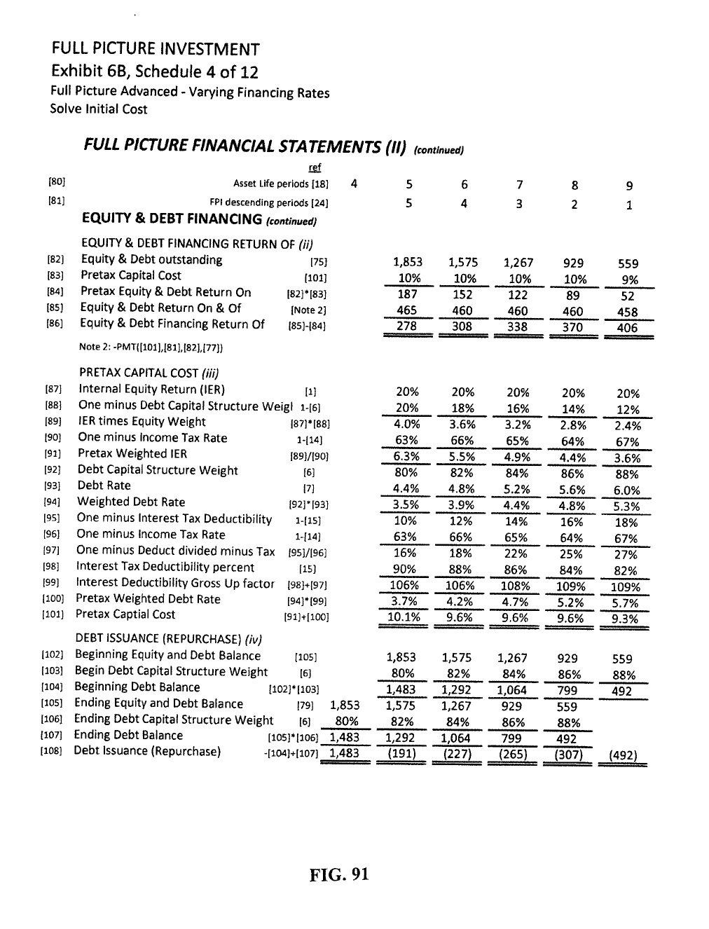

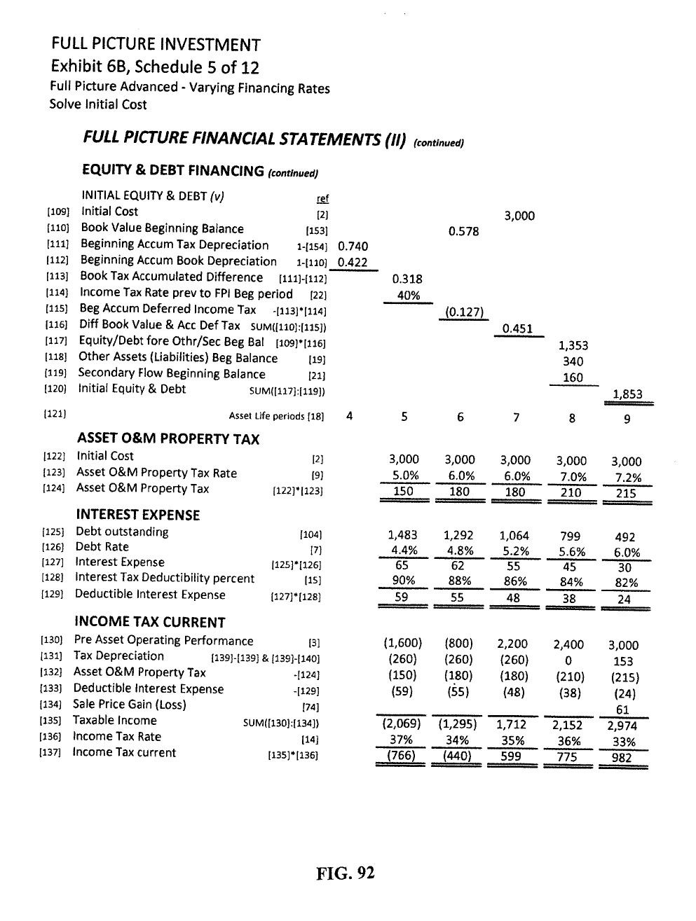

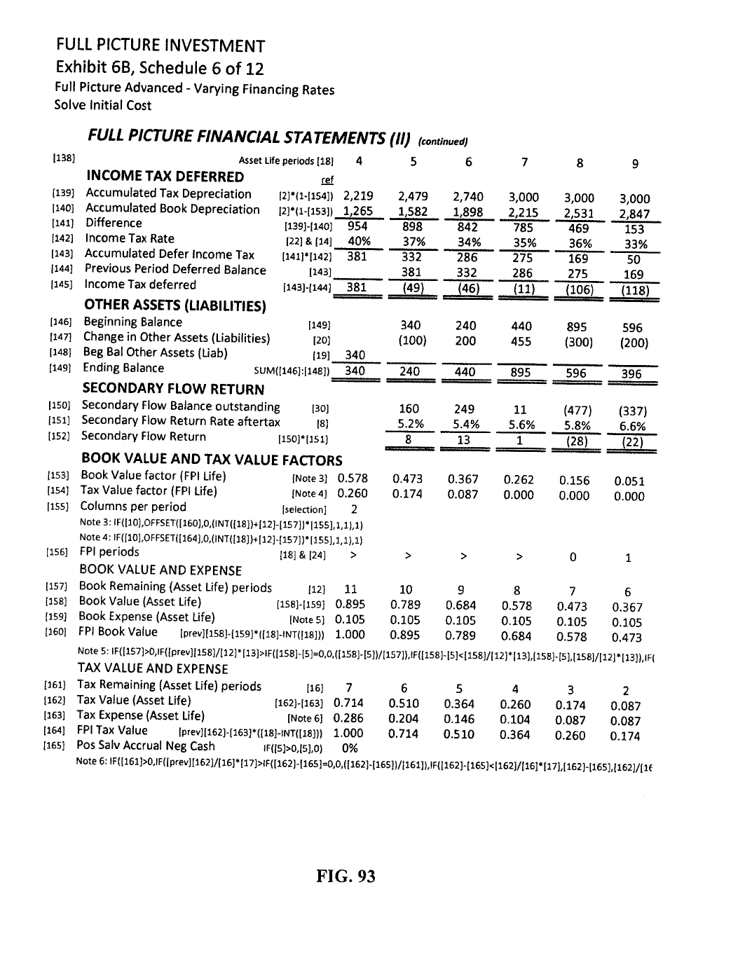

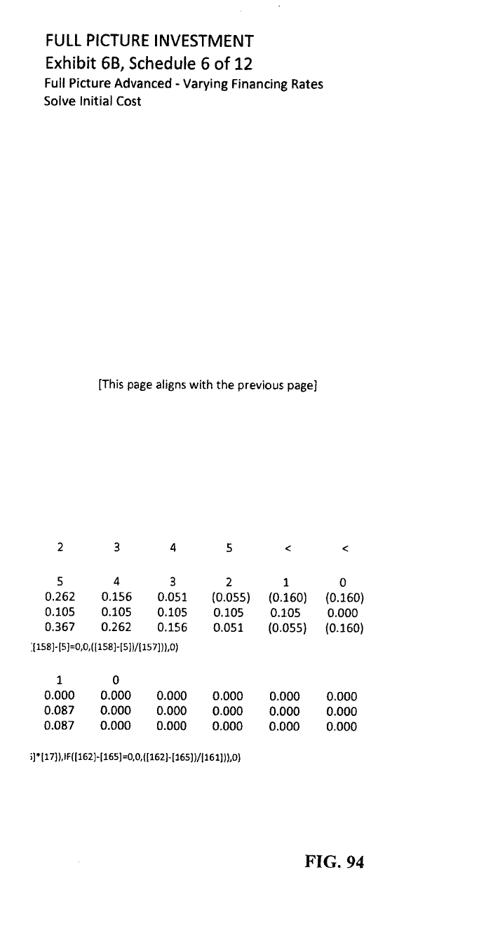

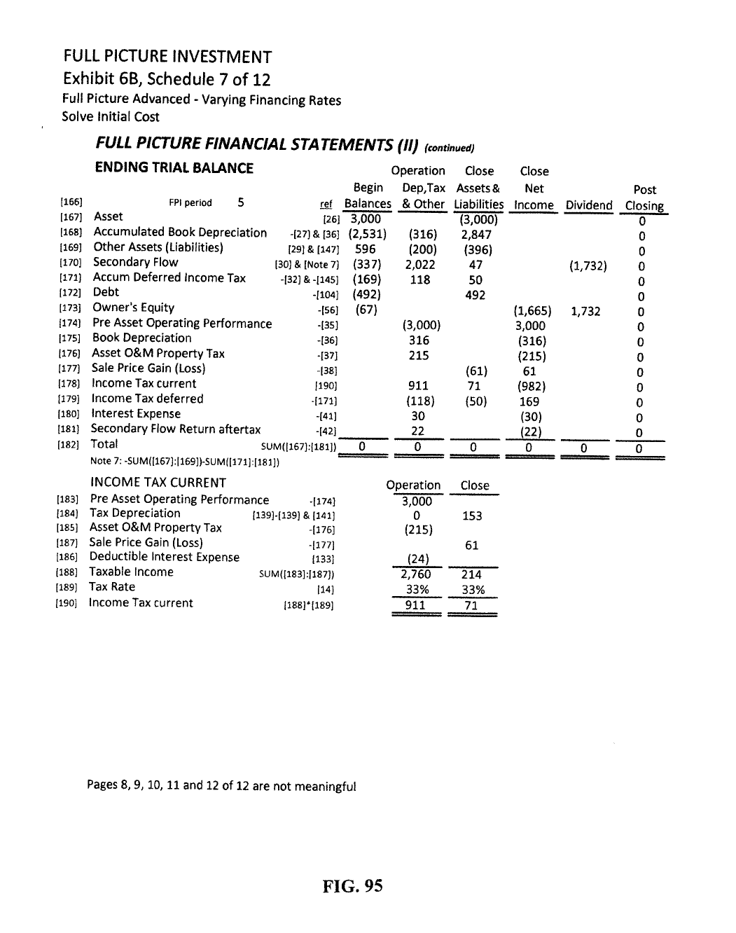

The Debt Capital Structure Weight assumption, FIG. 88, Line [6] now increases 2% each year. The detail calculations are found in DEBT ISSUANCE (REPURCHASE) (iv), FIG. 91, Lines [102] through [108]. Varying the debt capital structure weight assumption also impacts pretax capital cost calculations. Pretax capital cost must now be calculated for each period. The pretax capital cost impacts from the varying debt capital structure weight are found in PRETAX CAPITAL COST (iii), FIG. 91, Lines [88] and [92].

Varying Debt Rates, Lines [7], [93] and [126], Income Tax Rate, Lines [14], [90], [97], [136] and [142] and Interest Tax Deductibility, Lines [15], [95], [98] and [128] also impacts pretax capital cost calculations.

The varying Secondary Flow Return Rate appears on Lines [8] and [151].

### Exhibit 6, FULL PICTURE FINANCIAL STATEMENTS (II), Second Section:

Exhibit 6 has no new financial statement items from the ones existing in Exhibit 5. The pretax capital cost has no new lines but as stated previously, there is a unique pretax capital cost calculation for each period, FIG. 91, Lines [87] through [101].

Exhibit 6, VISUALIZE FULL PICTURE INVESTMENT (III), third section and

Exhibit 6, FULL PICTURE INVESTMENT vs. TRADITIONAL TOOLS (IV), fourth section.

Table 23's varying assumptions disestablishes the visual mechanics in an Exhibit's third section Visualize Full Picture Investment (III) and fourth section Full Picture Investment vs. Traditional Tools (IV). An Exhibit's third (III) section Visualize Full Picture Investment and fourth (IV) section Full Picture Investment vs. Traditional Tools cannot be adjusted or expanded to accommodate varying Table 23 financing assumptions. The third (III) and fourth (IV) section's explanatory nature are excellent vehicles to communicate FPI's concepts. They are very succinct at doing so but, sections three and four mechanics are not sufficient to work with the attending function of varying Table 23's assumptions and thus are not included in Exhibit 6.

Varying an investment question's IER during the investments question's lifetime requires multiple FPI calculations. The ending initial FPI calculations from the ending trial balance become the beginning balances for a subsequent FPI calculation, while varying IER.

Adding the ability to periodically change key financial assumptions, including IER, throughout the investment question's time frame further enhances FPI's attractiveness to replace IRR and NPV.

### Hurdle Rates, Modified Internal Rate of Return (MIRR), EBITDA and EVA

Today, hurdle rates are used to transform traditional tool IRR results into investment decisions that drive desired financial results. As shown in Exhibit 2A, Schedule 3, FIG. 8, a 15% hurdle rate, Line [150] is needed if the goal is to generate a desired financial statement 7% pretax capital cost or 20% IER, Line [151] for this set of assumptions. Investment hurdle rates attempt to compensate for IRR shortcomings discussed previously.

Hurdle rates are set on a trial and error basis. The trial and error process is used to find a hurdle rate to drive financial results toward a financial goal. A single hurdle rate is usually applicable for an organization. However, a single hurdle rate is not flexible to accommodate varying types of investment opportunities.

FPI directly links the return measures used in investment decision making into the same return measure in financial results. Eliminated is the hurdle rate's trial and error process attempting to correlate investment decision making return measures with financial goals. The lag time between investment decisions and financial results necessary to determine if an organization's hurdle rate needs adjustment is eliminated. FPI eliminates hurdle rate's historical nature to a prospective one.

Previous discussion has shown individual investment question's variation in pre asset operating performance can impact the differences between a FPI investment question's answer and a traditional tool answer. Investment choices with differing pre asset operating performance profiles can cause hurdle rate (traditional IRR) investment decisions to be falsely accepted or rejected. See Chapter 1's Illustration 1 and 2. Replacing hurdle rates with FPI's investment structure provide business professionals with a superior investment decision making tool.

MIRR

The Modified Internal Rate of Return has taken a step to recognize differing investment components require different rates. However, the MIRR differentiates only between positive and negative primary flows. The MIRR stops short of recognizing individual component flows comprising an investment question.

As was shown in Chapter 1, a traditional tool's first decision sequence step is to combine cash flows. MIRR acts identical to the traditional tools in this regard and ignores the time-value axiom in Chapter 1.

As a result, the MIRR cannot attain FPI's solve/assumption synchronicity, produce auto balancing affirming financial statements and instantaneously correlate decision making measures with financial goals.

The similarities between EBITDA and FPI's pre asset operating performance should not go unmentioned. Both numbers are rooted in segregating out asset related interest, taxes, depreciation and amortization. Pre asset operating performance goes one step further by removing any other remaining asset related operating performance. Segregating pre asset operating performance from the asset's impact creates one of FPI's three basic elements displayed in Table 8. FPI's methodology combines pre asset operating performance with a return measure (pre tax capital cost and full picture factor) and initial cost to form a complete investment picture and methodology. EBITDA alone leaves business professionals answering investment question with the consequences of an incomplete investment structure methodology.

Economic Value Added (EVA) is a snapshot for a single period. EVA focuses on the difference between a project's return and an organization's stated capital cost. EVA is only suited for ranking an organization's projects when the individual risk profiles among the projects are closely grouped and the projects' life cycle positions are similar. Expanding EVA outside its narrow scope to answer investment questions with varying risk profiles and differing life cycles becomes problematic. To further expand EVA to multiple investment periods necessitates adoption of NPV attributes. Along with the EVA NPV attributes comes NPV's earlier discussed short-comings.

Answering investment questions with today's tools entails Table 1's step sequence and its ignored time-value axiom. Table 1's focus is incorrectly first vertical and then horizontal. Initiating an investment question by combining deferred up-side cash flows without using a vertical based time-value denominator invalidates investment decisions. Discovering FPI's investment structure entailed finding a methodology to apply the appropriate return rate to an investment question's various components—bringing the structure focus first horizontal then vertical, as demonstrated in Chapter 1, Illustration 2.

### An Investment Question Standard Financing

Chapter 5 and Exhibit 1 first describes an investment question's systematic external financing extinguishment (SEFE). SEFE is not a product of FPI. SEFE is a Discounted Cash Flow (DCF) function utilized by FPI. In Exhibit 1 SEFE is evident in simple investment questions where today's traditional tool answers exhibit solve/assumption synchronicity.

SEFE's definition states the cash stream associated with a financing source's return ‘of’ has a systematic reduction scheme driven by the rate of return associated with the financing source. The traditional tool's ignored time-value denominator axiom (Chapter 1) and application of its single rate to all of an investment question's components has prevented SEFE from being recognized until now.

In the real-world, actual external financing extinguishment may not match an investment question's SEFE. A FPI based financing overlay can compensate for differences between FPI's SEFE and a desired external financing extinguishment. Consolidating the investment decision FPI calculation with a FPI based financing overlay can create a full investment picture a business professional feels is appropriate.

### IER—Comparative and Quantitative: Unifying IRR, NPV, PMT, FV & ROE and Maximizing Wealth Formation

DCF's simple premise drives traditional tool's mechanics. However, as shown in Chapter 1, the traditional tool's implementation results in an ignored time-value axiom. Investment questions ignoring the time-value denominator axiom negates the ability to structure a unifying investment methodology.

What is the essence of a unifying investment structure methodology?

Discussing a single investment question basic element by itself has no context. It takes a second basic element assumption to give an investment question substance. Like investment assumptions, investment answers should also have a dual perspective.

A unifying DCF based investment decision structure needs both comparative and quantitative outcomes. A return measure (IER) by itself exists in a vacuum. It is a quantitative aspect which gives the comparative piece context. An investment question's comparative and quantitative investment decision outcomes need to exist harmony.

IER's characterization as a multi-period ROE places it in the middle of the comparative and quantitative discussion. IER strictly as a comparative measure is void of any quantitative substance. Within the IER makeup are numerator and denominator quantitative elements, the net present value of net income operating performance and NPV outstanding equity.

Investment decisions to maximize wealth formation begins with a unifying investment structure to answer investment opportunity questions. The investment structure's first capability is to be able to place investment opportunities on an equal time frame. The investment structure's second capability is to be able to synchronize assumptions around a given or solved return measure (IER). Assumption probabilities and overall business risk associated with the investment opportunity coalesce in IER.

With the investment structure neutralizing the investment opportunity's time frames and business risks, the next step in wealth formation is quantitative. Table 24 lists the time frame periods, IER and net income operating performance net present values for Exhibits 2, 3, 4, 5 & 6.

TABLE 24
EXHIBITS 2, 3, 4, 5 & 6 QUANTITATIVE COMPARISON

| | Time | | Net Income Oper |
|---|---|---|---|
| | Frame | | Performance Net |
| Exhibit | Periods | IER | Present Value |
| 2 | 5 | 20% | $167 |
| 3 | 5 | 30% | $292 |
| 4 | 5 | 20% | $316 |
| 5 | 5 | 20% | $107 |
| 6 | 5 | 20% | $143 |

All else being equal, Exhibit 4's $316 maximizes wealth formation as the largest net income operating performance net present value. FPI's investment structure ensures “all else being equal” is actually equal in the form of time frames and the return measure's business risk as they allow the focus to shift to net income operating performance net present value.

### =FPI( ) Electronic Spreadsheet Function and Auto-generating Financial Statement Button

Prior to electronic spreadsheets traditional tool calculations were accomplished by hand, with calculators, within tables in the back of finance books or combinations of these approaches.

TABLE 25
=FPI( ) BLUEPRINT WITH DEFAULTS SETTINGS AND VARIABLE NAMES:

| | Input | | | =FPI( ) |
|---|---|---|---|---|
| FPI Level | Field | Solve/Assumptions | Solve is Blank: | Variable Name |
| Basic | [1] | Internal Equity Return (IER) | [A] | IER |
| | [2] | Initial Cost | [B] | InCost |
| | [3] | Pre Asset Operating Performance | [C] | PaOperPf( ) |
| | [4a] | Sale Price Salvage (Disposal) dollar amount | [D] | SalePrice |
| | | Other Assumptions | Default | |
| | [4b] | Sale Price Book Value percent | 100% | SalePrice |
| | [5] | Asset Salvage (Disposal) Initial Cost percent | 0% | Salv |
| | [6] | Debt Capital Structure Weight | 0% | DebtWght( ) |
| | [7] | Debt Rate | 0% | DebtRate( ) |
| | [8] | Secondary Flow Return Rate aftertax | 0% | SecFlowR( ) |
| | [9] | Asset O&M Property Tax Rate | 0% | OanMProp( ) |
| | [10] | Depreciable Asset True/False | TRUE | DepSw |
| | [11] | Pre Asset Oper Perf next period percent | Cat. [C] | PaOpNexPer( ) |
| Full Picture | [12] | Asset Life periods | Count of [3] or [11] | AssL |
| | [13] | Book Depreciation: Straight Line 0; DDB 2 | 0 | BkDep |
| | [14] | Income Tax Rate | 0% | TaxR( ) |
| | [15] | Interest Tax Deductibility percent | 100% | IntDeduct( ) |
| | [16] | Tax Life periods | [12] | TaxL |
| | [17] | Tax Depreciation Method: Straight 0; DDB 2 | [13] | TxDep |
| Advanced | [18] | Asset Life periods Previous to FPI Beg period | 0 | PrevPer |
| | [19] | Beg Balance Other Assets (Liab) FPI period 0 | $0 | OthrAsset |
| | [20] | Change in Other Assets (Liabilities) | $0 | ChangOthr( ) |
| | [21] | Begin Balance Secondary Flow FPI period 0 | $0 | SFBegBal |
| | [22] | Income Tax Rate (Deferred Tax) FPI period 0 | 0% | TaxR0 |
| | [23] | Return Rate Initial Parameter Category [A] | 10% | RRP |

Electronic spreadsheets running on software on computers have previously merely accelerated what was done previously. However, this discussion has shown the historic traditional tool's simplicity creates erroneous investment decisions. It is time to greater leverage electronic spreadsheets to improve investment decision making.

Like an individual traditional tool, FPI's methodology is also encapsulated in a single spreadsheet function. The =FPI( ) function works the same way as other native spreadsheet functions. Exhibit 6B, FIG. 88, Schedule 1, Lines [1] through [23] Assumption and Solve listing acts as a blueprint for the =FPI( )electronic spreadsheet function assumptions. The blueprint with default settings is shown in Table 25.

FPI calculations are easier to manage with electronic spreadsheets. The =FPI( )function acts as the process focal point as assumptions are captured at a single point. As with other spreadsheet functions, when =FPI( ) functions (as shown in Table 26) are activated, narrative descriptions guide the business professional throughout the input process. Cells referenced by the =FPI( )are brightly highlighted in contrasting colors as they are with other native spreadsheet functions.

The =FPI( ) function's first occurring blank assumption field drives the investment question category to be solved. Any subsequent blank inputs fields are populated with the representative default values in Table 25. A truncated =FPI( ) function without listing the entirety of the twenty-three assumptions also uses Table 25's default assumptions for those absent assumptions.

TABLE 27
REPLICA SPREADSHEET

| | A | B | C | D | E | F |
|---|---|---|---|---|---|---|
| 1 | Illustration Scenarios A & B | | | | | |
| 2 | [8] A Pre Asset Oper Perf next period | 100% | 100% | 100% | 100% | 100% |
| 3 | [3] B Pre Asset Oper Performance | ($400) | ($200) | $600 | $662 | $900 |
| 4 | | | | | | |
| 5 | Exhibit 1 | | | | | |
| 6 | [3] Pre Asset Oper Performance | $669 | $669 | $669 | $669 | $669 |
| 7 | | | | | | |
| 8 | Exhibit 2 | | | | | |
| 9 | [3] Pre Asset Oper Performance | ($1,600) | ($800) | $2,200 | $2,400 | $3,000 |
| 10 | [9] Asset O&M Property Tax Rate | 5.0% | 6.0% | 6.0% | 7.0% | 7.2% |
| 11 | [11] Pre Asset Oper Perf next period | 100% | 50% | −275% | 109% | 125% |
| 12 | | | | | | |
| 13 | Exhibit 3 | | | | | |
| 14 | [3] Pre Asset Oper Performance | $99 | $99 | $99 | $99 | $99 |
| 15 | | | | | | |
| 16 | Exhibit 4 | | | | | |
| 17 | [5] Salvage (Disposal) Initial Cost | 6.6% | | | | |
| 18 | | | | | | |
| 19 | Exhibit 5 | | | | | |
| 20 | [19] Beg Bal Other Assets (Liabilities) | $340 | | | | |
| 21 | [20] Other Assets (Liabilities) | ($100) | $200 | $455 | ($300) | ($200) |
| 22 | [21] Begin Balance Secondary Flow | $160 | | | | |
| 23 | | | | | | |
| 24 | Exhibit 6 | | | | | |
| 25 | [6] Debt Capital Structure Weight | 80% | 82% | 84% | 86% | 88% |
| 26 | [7] Debt Rate | 4.4% | 4.8% | 5.2% | 5.6% | 6.0% |
| 27 | [8] Secondary Flow Return Rate | 5.2% | 5.4% | 5.6% | 5.8% | 6.6% |
| 28 | [14] Income Tax Rate | 37% | 34% | 35% | 36% | 33% |
| 29 | [15] Interest Tax Deductibility percent | 90% | 88% | 86% | 84% | 82% |

### Auto-generating Financial Statements

A unifying investment structure evaluates all investment questions and every investment structure answered investment question creates an affirming set of financial statements.

In addition to the methodology's =FPI( ) function there is a spreadsheet button available to auto-generate the financial statements associated with the answered investment question.

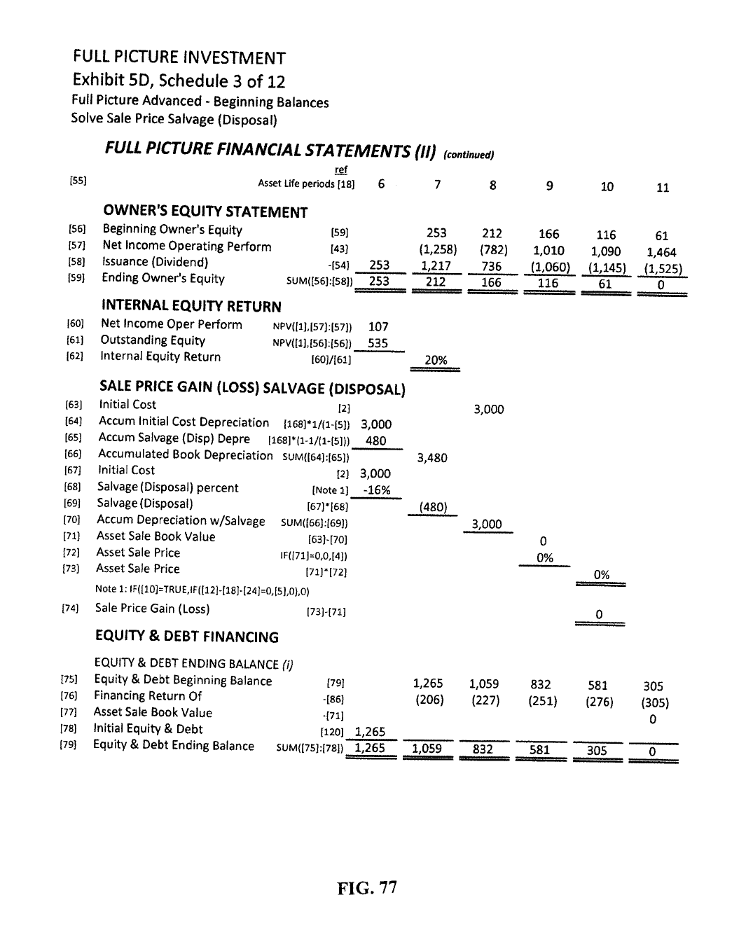

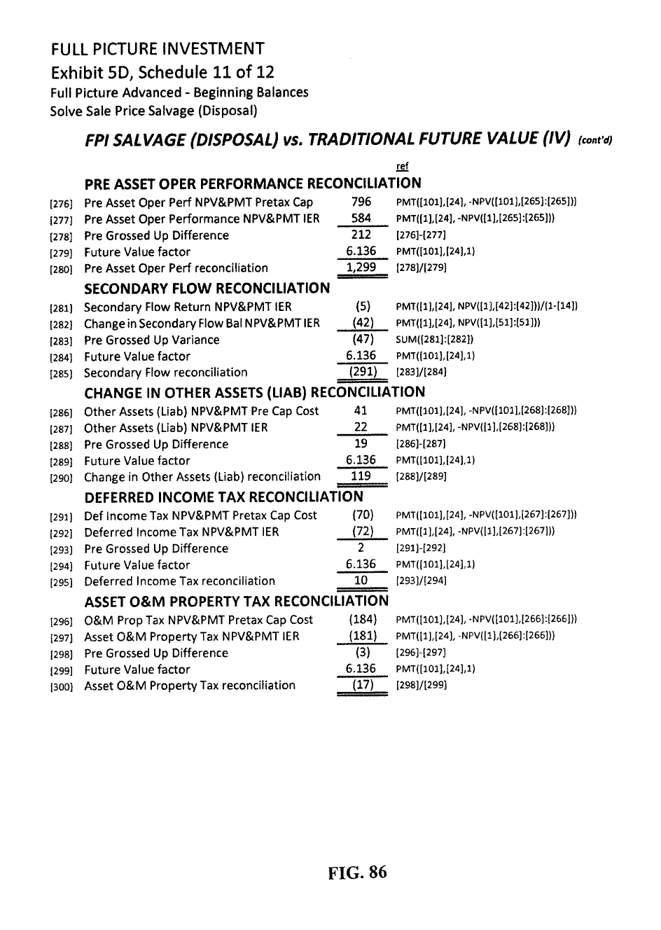

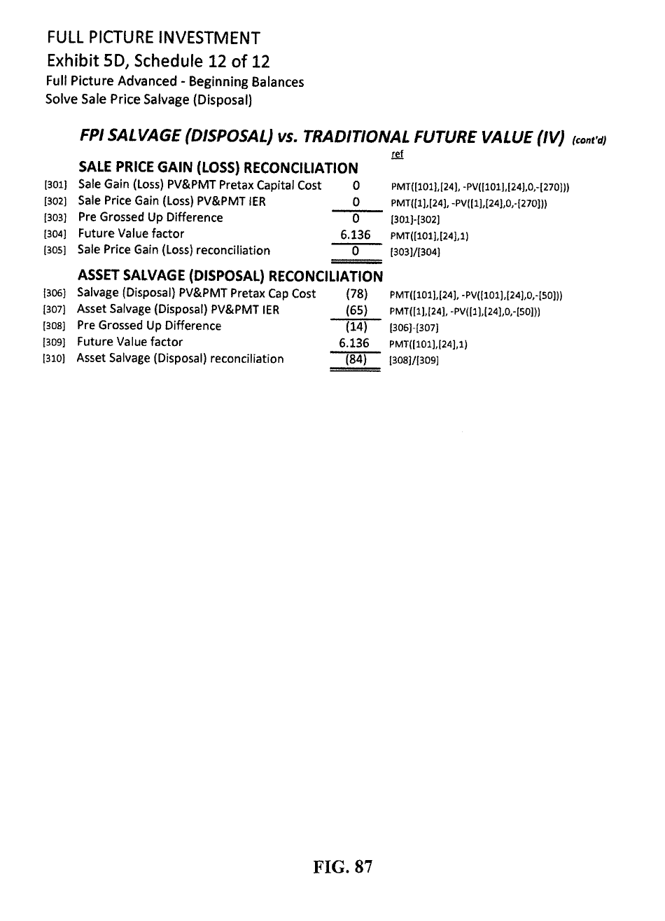

Investment questions without varying financing assumptions generates the four sections (I, II, III and IV) encompassing Exhibit 5's twelve pages of information, FIGS. 75 through 87. Investment questions with a varying financing assumption only generate sections (I and II).

Selecting the spreadsheet's cell containing the =FPI( ) function and pressing the FPI menu option creates a new spreadsheet worksheet tab.

The new worksheet is filled with the investment question's financial statements. No additional assumptions are necessary to create financial statements.

FPI's investment structure causes the financial statements to automatically balance to zero at the investment question's end. The auto balancing is evident in the trial balance and closing entries.

Quickly and consistently replicating FPI's uniform financial statement format aids in consolidating the financial statements of an organization's multiple asked and FPI answered investment questions, providing a unique window to peer into the future.

Making better investment decisions improves economic efficiency. Economic efficiency better ensures those who add value are the ones who receive value in return.

FPI's discussion began by identifying the four predominant investment question categories. The four categories are IER, initial cost, pre asset operating performance—the basic elements and a special investment question component—sale price salvage. FPI's investment structure allows for solve/assumption synchronicity among the categories.

A desirable multi period ROE is embodied in IER. Investment questions are only answered when an investment question's owner agrees the question's IER is commensurate with the investment question's risk.

FPI's methodology is flexible to accommodate components germane to the investment question under evaluation. The methodology can be addressed to solve for any investment component as a question. Homogenizing bridges create proxies for FPI. Proxies maintain basic element relationships to address realistic investment questions.

The seven investment structure areas allow for incorporating real world investment question implications including a user designated secondary flow return.

If desired, an investment question and its FPI answer can create an affirming set of financial statements through the imbedded FPI methodology. Financial statements are built upon systematic external financing extinguishment, auto balancing features utilizing only assumptions germane to the investment question and a visual secondary flow.

FPI creates the opportunity to better maximize wealth formation by introducing a new quantitative benchmark—Net Income Operating Performance's NPV (NINPV).

IRR and NPV have served the world well. However, it is now evident IRR and NPV's short-comings are restraining. IRR and NPV's replacement methodology investment structure creates a superior investment question answering methodology. FPI's capabilities compels IRR and NPV's replacement going forward. FPI will bring a focus to and then vanquish IRR and NPV's short-comings and usher in a new investment evaluation era to the world of commerce.

### Full Picture Investment

NARRATIVE & EXHIBIT ABBREVIATIONS

Accum & Acc Accumulated

Bal Balance

Begin & Beg Beginning

Cap Capital

DDB Double Declining Balance (depreciation)

Defer & Def Deferred

Depre Depreciation

Exp Expense

FPF Full Picture Factor

FPI Full Picture Investment

=FPI( ) Full Picture Investment (function)

FV Future Value (function)

IER Internal Equity Return

IRR Internal Rate of Return

NINPV Net Income Net Present Value

NPV Net Present Value (function)

O&M Operating and Maintenance Expense

Oper Operating

PaOp Pre Asset Operating Performance

Perform & Perf Performance

PCC Pretax Capital Cost

PMT Payment (function)

Pretax Cap Pretax Capital Cost

Prey Previous

Prop Property

PV Present Value (function)

Reconcile & Recon Reconciliation

Second & Sec Secondary

Tradition & Trad Traditional

VDB Variable Declining Balance (depreciation function)

w/ & w/o With and Without

While the invention has been disclosed in conjunction with a description of certain embodiments, including those that are currently believed to be preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for providing a value of an investment, the method comprising:
determining any two values from the group consisting of: the comparative return measure, the point-in-time initial cost, the operating performance of the investment over time;
determining one of the values from the group consisting of: the future sale price, and the future salvage value;
using the three determined values to solve for the missing value from the group consisting of: the comparative return measure, the point-in-time initial cost, the operating performance of the investment over time; and
using the four values to provide a valuation of an investment, where the four values all correctly match each other as both determined and valuation;
wherein the comparative return measure is computed when
$${Σ}_{0}^{n} \frac{Equity Cash {Flow}_{n}}{{( 1 + i )}^{n}} = 0 ;$$
wherein the initial cost is computed as
$$\frac{{Σ}_{0}^{n} \frac{After Tax Pre Asset Operating {Performance}_{n}}{{( 1 + i )}^{n}}}{{Σ}_{0}^{n} \frac{FPF Financing {Denominator}_{n}}{{( 1 + i )}^{n}}} ;$$
wherein the pre asset operating performance is computed as
$$\frac{{Σ}_{0}^{n} \frac{FPF Financing Rate * Initial {Cost}_{n}}{{( 1 + i )}^{n}}}{{Σ}_{0}^{n} \frac{\begin{matrix}After Tax Pre Asset Operating \\ Performance Compound {Factor}_{n}\end{matrix}}{{( 1 + i )}^{n}}} ;$$
wherein the sale price book value is computed as
$$\frac{{Σ}_{0}^{n} \frac{\begin{matrix}FPF Financing Rate * Intital Cost + \\ After Tax Pre Asset Operating {Performance}_{n}\end{matrix}}{{( 1 + i )}^{n}}}{Present Value After Tax Ending Book Value} * Ending Book Value ;$$
wherein the salvage value is computed as
$$\frac{{Σ}_{0}^{n} \frac{\begin{matrix}FPF Financing Rate * Intital Cost + \\ After Tax Pre Asset Operating {Performance}_{n}\end{matrix}}{{( 1 + i )}^{n}}}{After Tax {( 1 + i )}^{n}} ;$$
and
wherein i is the internal equity return as the comparative return measure and n is the number of periods measured over.

2. A method for providing a value of an investment, the method comprising:
determining any three values from the group consisting of: the comparative return measure, the point-in-time initial cost, the operating performance of the investment over time, and the future sale price;
using the three determined values to solve for the fourth value; and
using the four values to provide a valuation of an investment, where the four values all correctly match each other as both determined and valuation;
wherein the comparative return measure is computed when
$${Σ}_{0}^{n} \frac{Equity Cash {Flow}_{n}}{{( 1 + i )}^{n}} = 0 ;$$
wherein the initial cost is computed as
$$\frac{{Σ}_{0}^{n} \frac{After Tax Pre Asset Operating {Performance}_{n}}{{( 1 + i )}^{n}}}{{Σ}_{0}^{n} \frac{FPF Financing {Denominator}_{n}}{{( 1 + i )}^{n}}} ;$$
wherein the pre asset operating performance is computed as
$$\frac{{Σ}_{0}^{n} \frac{FPF Financing Rate * Intital {Cost}_{n}}{{( 1 + i )}^{n}}}{{Σ}_{0}^{n} \frac{\begin{matrix}After Tax Pre Asset Operating \\ Performance Compound {Factor}_{n}\end{matrix}}{{( 1 + i )}^{n}}} ;$$
wherein the sale price book value is computed as
$$\frac{{Σ}_{0}^{n} \frac{\begin{matrix}FPF Financing Rate * Intital Cost + \\ After Tax Pre Asset Operating {Performance}_{n}\end{matrix}}{{( 1 + i )}^{n}}}{Present Value After Tax Ending Book Value} * Ending Book Value ;$$
and
wherein i is the internal equity return as the comparative return measure and n is the number of periods measured over.

3. A method for providing a value of an investment, the method comprising:
determining any three values from the group consisting of: the comparative return measure, the point-in-time initial cost, the operating performance of the investment over time, and the future salvage value;
using the three determined values to solve for the fourth value; and
using the four values to provide a valuation of an investment, where the four values all correctly match each other as both determined and valuation;
wherein the comparative return measure is computed when
$${Σ}_{0}^{n} \frac{Equity Cash {Flow}_{n}}{{( 1 + i )}^{n}} = 0 ;$$
wherein the initial cost is computed as
$$\frac{{Σ}_{0}^{n} \frac{After Tax Pre Asset Operating {Performance}_{n}}{{( 1 + i )}^{n}}}{{Σ}_{0}^{n} \frac{FPF Financing {Denominator}_{n}}{{( 1 + i )}^{n}}} ;$$
wherein the pre asset operating performance is computed as
$$\frac{{Σ}_{0}^{n} \frac{FPF Financing Rate * Intital {Cost}_{n}}{{( 1 + i )}^{n}}}{{Σ}_{0}^{n} \frac{\begin{matrix}After Tax Pre Asset Operating \\ Performance Compound {Factor}_{n}\end{matrix}}{{( 1 + i )}^{n}}} ;$$
wherein the salvage value is computed as
$$\frac{{Σ}_{0}^{n} \frac{\begin{matrix}FPF Financing Rate * Intital Cost + \\ After Tax Pre Asset Operating {Performance}_{n}\end{matrix}}{{( 1 + i )}^{n}}}{After Tax {( 1 + i )}^{n}} ;$$
and
wherein i is the internal equity return as the comparative return measure and n is the number of periods measured over.
